(19) United States
(12) Patent Application Publication
(10) Pub. No.: US 2025/0121965 A1
(43) Pub. Date: Apr. 17, 2025

(54) Hopping Robot with Bidirectional Thrusters

(71) Applicant: City University of Hong Kong, Kowloon (HK)

(72) Inventors: Song Li, Kowloon (HK); Pakpong Chirarattananon, Hung Hom (HK); Songnan Bai, Kowloon (HK); Runze Ding, Kowloon (HK)

(21) Appl. No.: 19/002,977

(22) Filed: Dec. 27, 2024

Related U.S. Application Data
(63) Continuation-in-part of application No. 18/465,403, filed on Sep. 12, 2023.

(51) Int. Cl. B64U 60/55; B64U 10/14

(52) U.S. Cl. CPC B64U 60/55; B64U 10/14; B64U 2201/10

(57) ABSTRACT

A robot which includes an aerial unit having a thruster module; a passive leg mechanism operably coupled with the aerial unit; and a controller module configured to control operation of the aerial unit such that the robot is operable in at least a hopping mode. The thruster module is adapted to provide bidirectional thrusts. The bidirectional thrusters enable the robot to handle increased energy losses from ground impacts and the leg mechanism, accommodating heavier payloads.

### FIELD OF INVENTION

The present invention relates to a robotic hoppers, and in particular to structures of such robotic hoppers and their control methods.

### BACKGROUND OF INVENTION

Many organisms in nature achieve hybrid locomotion through the integration of jumping and flying behaviors. Arboreal foraging birds such as parrotlets and sparrows exhibit high agility by combining jumps between branches with intermittent flights [1] Insects such as locusts, froghoppers, and fleas integrate jumping and flying behaviors to navigate complex environments and evade predators [2]-[4]. Flying squirrels [5] and Draco lizards [6] perform hybrid jumping and gliding to achieve long jump distances. These examples demonstrate the potential benefits of hybrid jumping-flying locomotion for improving mobility, agility, efficiency and versatility.

Developing a hybrid hopping-flying robot that can achieve continuous jumping and flying is challenging, particularly when considering the limitations and complexity of conventional jumping mechanisms. While a few combustion-driven robotic jumpers have been reported [7]-[10], existing robots capable of jumping are primarily based on either latched [11]-[29] or unlatched [30]-[36] actuation mechanisms.

Jumpers with latched actuation mechanisms employ a catch mechanism to enable rapid energy release from mounted elastomer, making varying jump height and continuous hopping difficult. If the explosive energy release is passively triggered (via cam escapement or pawl-and-ratchet mechanisms, for instance) [11]-[15], [19], [22]-[24], [26]-[29], the jump height is fixed according to the pre-determined tension, thereby limiting the robot's capability. On the other hand, if the explosive energy release is actively triggered, the jump height is variable but continuous hopping remains difficult as the release must be precisely timed when the robot lands [17], [18], [20], [25], thereby impacting the robot's jumping agility.

Jumpers with unlatched actuation mechanisms can directly drive their legs with actuators [30], [37]-[39], enabling continuous hopping with variable height. However, without energy storage, they cannot generate sufficient instantaneous power for high jumps. To address this limitation, elastomers are used in parallel [34], [36] or series-elastic [31]-[33] jumping mechanisms are used to temporarily store the energy produced by the actuator and amplify the output power during the stance phase. With carefully designed linkages and nonlinear spring stiffness, these robots may benefit from variable mechanical advantage, demonstrating agile continuous hopping with superior vertical jumping agility [21], [31]-[33]. However, they necessitate a relatively complex mechanical structure, higher actuator power, and non-negligible stance time. These somewhat restrict hopping agility as the robot must spend a certain amount of time in stance for the actuator to inject.

Existing attempts to create robots capable of both jumping and flight have directly combined jumping mechanisms with aerial platforms [15]-[18], [40]-[42]. This allows the robots to rapidly gain altitude through jumping-assisted takeoff. However, these existing robots cannot achieve continuous hopping, fine-tune jump height, and/or sustained flight.

In addition, mobile robots have emerged as versatile platforms for a wide range of applications, making impacts on various fields including manipulation [70], [71], environmental monitoring [72]-[74], subterranean [75] and space [76] exploration, and disaster response [77]. Their ability to navigate and operate in environments that are dangerous or inaccessible to humans makes them invaluable tools across various domains.

Among the most widely adopted mobile robot platforms for real-world applications are legged robots and aerial robots, each offering distinct advantages and limitations. Legged robots, such as quadrupeds [75], [76] and humanoids [78], excel in their ability to navigate uneven terrain [78]-[80] and carry substantial payloads [81], [82]. Their multi-jointed limbs allow for precise foot placement and force control, enabling them to climb stairs, step over obstacles, and maintain stability in challenging environments [83]. However, they typically exhibit slower speeds and may struggle in extremely cluttered environments. Conversely, aerial robots offer rapid movement and the ability to bypass obstacles by flying over them [84]-[86]. Nevertheless, they are often constrained by limited payload capacity [87], endurance [88], and reduced manipulation capabilities [71], [89].

To harness the strengths of both legged and aerial platforms, researchers have proposed hybrid robotic platforms that augment humanoid robots with thrusters or flight components, enabling them to overcome large obstacles or traverse gaps through short-duration flights [53], [90]. An alternative strategy, which forms the basis of this work, involves equipping a quadrotor with a passive, springy leg [43], [91]. This design leverages the quadrotor's existing actuators for both flight and terrestrial locomotion. It maintains a compact form factor and retains flight efficiency, as the passive leg adds minimal weight.

Incorporating a passive leg transforms a quadcopter into a thrust-based hopper, facilitating continuous jumping akin to leg-actuated hopping robots [24], [31], [92]-[95], [35], [21], [96]. The stance dynamics of this hybrid system can be approximated using a spring-mass model, drawing parallels to the well-studied Spring-Loaded Inverted Pendulum (SLIP) model [97], [59], [34], albeit with notable differences in actuation and control strategies.

### REFERENCES

Each of the following references (and associated appendices and/or supplements) is expressly incorporated herein by reference in its entirety:
1. Chin, D. D. and Lentink, D., How birds direct impulse to minimize the energetic cost of foraging flight. Science Advances, 2017, 3, e1603041.
2. Bennet-Clark, H. and Lucey, E., The jump of the flea: A study of the energetics and a model of the mechanism. Journal of Experimental Biology, 1967, 47, 59-76.
3. Burrows, M., Jumping performance of froghopper insects. Journal of Experimental Biology, 2006, 209, 4607-4621.
4. Simmons, P. J., Rind, F. C., and Santer, R. D., Escapes with and without preparation: The neuroethology of visual startle in locusts. Journal of insect physiology, 2010, 56, 876-883.
5. Zhao, F., Wang, W., Wyrwa, J., Zhang, J., Du, W., and Zhong, P., Design and demonstration of a flying-squirrel-inspired jumping robot with two modes. Applied Sciences, 2021, 11, 3362.
6. Lau, A. S. H., Ma, Z., and Huang, X., The aerodynamic effects of forelimb pose on the gliding flight of draco lizards. Physics of Fluids, 2023, 35
7. Bartlett, N. W., Tolley, M. T., Overvelde, J. T., et al., A 3D-printed, functionally graded soft robot powered by combustion. Science, 2015, 349, 161-165.
8. Loepfe, M., Schumacher, C. M., Lustenberger, U. B., and Stark, W. J., An untethered, jumping roly-poly soft robot driven by combustion. Soft Robotics, 2015, 2, 33-41.
9. Chen, Y., Wang, H., Helbling, E. F., et al., A biologically inspired, flapping-wing, hybrid aerial-aquatic microrobot. Science robotics, 2017, 2, eaao5619.
10. Zufferey, R., Ancel, A. O., Farinha, A., et al., Consecutive aquatic jump-gliding with water-reactive fuel. Science Robotics, 2019, 4, eaax7330.
11. Scarfogliero, U., Stefanini, C., and Dario, P., Design and development of the long-jumping“grillo” mini robot. In Proceedings 2007 IEEE international conference on robotics and automation IEEE, 2007, pp. 467-472.
12. Armour, R., Paskins, K., Bowyer, A., Vincent, J., and Megill, W., Jumping robots: A biomimetic solution to locomotion across rough terrain. Bioinspiration & biomimetics, 2007, 2, S65.
13. Kovac, M., Fuchs, M., Guignard, A., Zufferey, J.-C., and Floreano, D., A miniature 7 g jumping robot. In 2008 IEEE international conference on robotics and automation IEEE, 2008, pp. 373-378.
14. Kovac, M., Schlegel, M., Zufferey, J.-C., and Floreano, D., A miniature jumping robot with self-recovery capabilities. In 2009 IEEE/RSJ international conference on intelligent robots and systems IEEE, 2009, pp. 583-588.
15. Kovac, M., Fauria, O., Zufferey, J.-C., Floreano, D., et al., The EPFL jumpglider: A hybrid jumping and gliding robot with rigid or folding wings. In 2011 IEEE international conference on robotics and biomimetics IEEE, 2011, pp. 1503-1508.
16. Woodward, M. A. and Sitti, M., Design of a miniature integrated multi-modal jumping and gliding robot. In 2011 IEEE/RSJ international conference on intelligent robots and systems IEEE, 2011, pp. 556-561.
17. Woodward, M. A. and Sitti, M., Multimo-bat: A biologically inspired integrated jumping-gliding robot. The International Journal of Robotics Research, 2014, 33, 1511-1529.
18. Truong, N. T., Phan, H. V., and Park, H. C., Design and demonstration of a bio-inspired flapping-wing-assisted jumping robot. Bioinspiration & biomimetics, 2019, 14, 036010.
19. Hawkes, E. W., Xiao, C., Peloquin, R.-A., et al., Engineered jumpers overcome biological limits via work multiplication. Nature, 2022, 604, 657-661.
20. Chae, S.-H., Baek, S.-M., Lee, J., and Cho, K.-J., Agile and energy-efficient jumping-crawling robot through rapid transition of locomotion and enhanced jumping height adjustment. IEEE/ASME Transactions on Mechatronics, 2022, 27, 5890-5901.
21. Shin, W. D., Stewart, W., Estrada, M. A., Ijspeert, A. J., and Floreano, D., Elastic-actuation mechanism for repetitive hopping based on power modulation and cyclic trajectory generation. IEEE Transactions on Robotics, 2022, 39, 558-571.
22. Zaitsev, V., Gvirsman, O., Hanan, U. B., Weiss, A., Ayali, A., and Kosa, G., A locust-inspired miniature jumping robot. Bioinspiration & biomimetics, 2015, 10, 066012.
23. Zhao, J., Xu, J., Gao, B., et al., MSU jumper: A single-motor-actuated miniature steerable jumping robot. IEEE Transactions on Robotics, 2013, 29, 602-614.
24. Kovac, M., Schlegel, M., Zufferey, J.-C., and Floreano, D., Steerable miniature jumping robot. Autonomous Robots, 2010, 28, 295-306.
25. Jung, G.-P., Casarez, C. S., Jung, S.-P., Fearing, R. S., and Cho, K.-J., An integrated jumping-crawling robot using height-adjustable jumping module. In 2016 IEEE international conference on robotics and automation (ICRA) IEEE, 2016, pp. 4680-4685.
26. Noh, M., Kim, S.-W., An, S., Koh, J.-S., and Cho, K.-J., Flea-inspired catapult mechanism for miniature jumping robots. IEEE transactions on robotics, 2012, 28, 1007-1018.
27. Burdick, J. and Fiorini, P., Minimalist jumping robots for celestial exploration. The International Journal of Robotics Research, 2003, 22, 653-674.
28. Desbiens, A. L., Pope, M. T., Christensen, D. L., Hawkes, E. W., and Cutkosky, M. R., Design principles for efficient, repeated jumpgliding. Bioinspiration & biomimetics, 2014, 9, 025009.
29. Li, F., Liu, W., Fu, X., et al., Jumping like an insect: Design and dynamic optimization of a jumping mini robot based on bio-mimetic inspiration. Mechatronics, 2012, 22, 167-176.
30. Kenneally, G., De, A., and Koditschek, D. E., Design principles for a family of direct-drive legged robots. IEEE Robotics and Automation Letters, 2016, 1, 900-907.
31. Haldane, D. W., Plecnik, M. M., Yim, J. K., and Fearing, R. S., Robotic vertical jumping agility via series-elastic power modulation. Science Robotics, 2016, 1, eaag2048.
32. Haldane, D. W., Yim, J. K., and Fearing, R. S., Repetitive extreme-acceleration (14-g) spatial jumping with salto-1P. In 2017 IEEE/RSJ international conference on intelligent robots and systems (IROS) IEEE, 2017, pp. 3345-3351.
33. Yim, J. K., Singh, B. R. P., Wang, E. K., Featherstone, R., and Fearing, R. S., Precision robotic leaping and landing using stance-phase balance. IEEE Robotics and Automation Letters, 2020, 5, 3422-3429.
34. De, A. and Koditschek, D. E., Parallel composition of templates for tail-energized planar hopping. In 2015 IEEE international conference on robotics and automation (ICRA) IEEE, 2015, pp. 4562-4569.
35. Yim, J. K., Wang, E. K., and Fearing, R. S., Drift-free roll and pitch estimation for high-acceleration hopping. In 2019 international conference on robotics and automation (ICRA) IEEE, 2019, pp. 8986-8992.
36. Klemm, V., Morra, A., Salzmann, C., et al., Ascento: A two-wheeled jumping robot. In 2019 international conference on robotics and automation (ICRA) IEEE, 2019, pp. 7515-7521.
37. Johnson, A. M. and Koditschek, D. E., Toward a vocabulary of legged leaping. In 2013 IEEE international conference on robotics and automation IEEE, 2013, pp. 2568-2575.
38. Brill, A. L., De, A., Johnson, A. M., and Koditschek, D. E., Tail-assisted rigid and compliant legged leaping. In 2015 IEEE/RSJ international conference on intelligent robots and systems (IROS) IEEE, 2015, pp. 6304-6311.
39. Haynes, G. C., Pusey, J., Knopf, R., Johnson, A. M., and Koditschek, D. E., Laboratory on legs: An architecture for adjustable morphology with legged robots. In Unmanned systems technology XIV SPIE, 2012, pp. 349-362.
40. Vidyasagar, A., Zufferey, J.-C., Floreano, D., and Kovac, M., Performance analysis of jump-gliding locomotion for miniature robotics. Bioinspiration & biomimetics, 2015, 10, 025006.
41. Wei, D., Gao, T., Li, Z., Mo, X., Zheng, S., and Zhou, C., Hybrid inspired research on the flying-jumping locomotion of locusts using robot counterpart. Frontiers in neurorobotics, 2019, 13, 87.
42. Baek, S.-M., Yim, S., Chae, S.-H., Lee, D.-Y., and Cho, K.-J., Ladybird beetle-inspired compliant origami. Science Robotics, 2020, 5, eaaz6262.
43. Zhu, B., Xu, J., Charway, A., and Saldana, D., PogoDrone: Design, model, and control of a jumping quadrotor. In 2022 International Conference on Robotics and Automation (ICRA) IEEE, 2022, pp. 2031-2037
44. Boria, F. J., Bachmann, R. J., Ifju, P. G., et al., A sensor platform capable of aerial and terrestrial locomotion. In 2005 IEEE/RSJ international conference on intelligent robots and systems IEEE, 2005, pp. 3959-3964.
45. Kalantari, A. and Spenko, M., Modeling and performance assessment of the HyTAQ, a hybrid terrestrial/aerial quadrotor. IEEE Transactions on Robotics, 2014, 30, 1278-1285.
46. Page, J. R. and Pounds, P. E., The quadroller: Modeling of a UAV/UGV hybrid quadrotor. In 2014 IEEE/RSJ international conference on intelligent robots and systems IEEE, 2014, pp. 4834-4841.
47. Jia, H., Bai, S., Ding, R., et al., A quadrotor with a passively reconfigurable airframe for hybrid terrestrial locomotion. IEEE/ASME Transactions on Mechatronics, 2022, 27, 4741-4751.
48. Zhang, R., Wu, Y., Zhang, L., Xu, C., and Gao, F., Autonomous and adaptive navigation for terrestrial-aerial bimodal vehicles. IEEE Robotics and Automation Letters, 2022, 7, 3008-3015.
49. Fabris, A., Aucone, E., and Mintchev, S., Crash 2 squash: An autonomous drone for the traversal of narrow passageways. Advanced Intelligent Systems, 2022, 4, 2200113.
50. Jia, H., Ding, R., Dong, K., Bai, S., and Chirarattananon, P., Quadrolltor: A reconfigurable quadrotor with controlled rolling and turning. IEEE Robotics and Automation Letters, 2023 8, 4052-4059.
51. Daler, L., Lecoeur, J., Hahlen, P. B., and Floreano, D., A flying robot with adaptive morphology for multi-modal locomotion. In 2013 IEEE/RSJ international conference on intelligent robots and systems IEEE, 2013, pp. 1361-1366.
52. Daler, L., Mintchev, S., Stefanini, C., and Floreano, D., A bioinspired multi-modal flying and walking robot. Bioinspiration & biomimetics, 2015, 10, 016005.
53. Kim, K., Spieler, P., Lupu, E.-S., Ramezani, A., and Chung, S.-J., A bipedal walking robot that can fly, slackline, and skateboard. Science Robotics, 2021, 6, eabf8136.
54. Anzai, T., Kojio, Y., Makabe, T., Okada, K., and Inaba, M., Design and development of a flying humanoid robot platform with bi-copter flight unit. In 2020 IEEE-RAS 20th international conference on humanoid robots (humanoids) IEEE, 2021, pp. 69-75.
55. Mellinger, D., Michael, N., and Kumar, V., Trajectory generation and control for precise aggressive maneuvers with quadrotors. The International Journal of Robotics Research, 2012, 31, 664-674.
56. Faessler, M., Franchi, A., and Scaramuzza, D., Differential flatness of quadrotor dynamics subject to rotor drag for accurate tracking of high-speed trajectories. IEEE Robotics and Automation Letters, 2017, 3, 620-626.
57. Sun, S., Romero, A., Foehn, P., Kaufmann, E., and Scaramuzza, D., A comparative study of nonlinear mpc and differential-flatness-based control for quadrotor agile flight. IEEE Transactions on Robotics, 2022, 38, 3357-3373.
58. Wu, A. and Geyer, H., The 3-d spring-mass model reveals a time-based deadbeat control for highly robust running and steering in uncertain environments. IEEE Transactions on Robotics, 2013, 29, 1114-1124.
59. Saranli, U., Arslan, O., Ankarah, M. M., and Morgul, O., Approximate analytic solutions to non-symmetric stance trajectories of the passive spring-loaded inverted pendulum with damping. Nonlinear Dynamics, 2010, 62, 729-742.
60. Ankarah, M. M. and Saranli, U., Control of underactuated planar pronking through an embedded spring-mass hopper template. Autonomous Robots, 2011, 30, 217-231.
61. Sayyad, A., Seth, B., and Seshu, P., Single-legged hopping robotics researcha review. Robotica, 2007, 25, 587-613.
62. Bai, S. and Chirarattananon, P., SplitFlyer air: A modular quadcopter that disassembles into two bicopters mid-air. IEEE/ASME Transactions on Mechatronics, 2022, 27, 4729-4740.
63. Seipel, J. E. and Holmes, P., Running in three dimensions: Analysis of a point-mass sprung-leg model. The International Journal of Robotics Research, 2005, 24, 657-674.
64. Batts, Z., Kim, J., and Yamane, K., Untethered one-legged hopping in 3d using linear elastic actuator in parallel (leap). In 2016 international symposium on experimental robotics Springer, 2017, pp. 103-112.
65. Raibert, M. H., Brown Jr, H. B., and Chepponis, M., Experiments in balance with a 3D one-legged hopping machine. The International Journal of Robotics Research, 1984, 3, 75-92.
66. Terry, P., Piovan, G., and Byl, K., Towards precise control of hoppers: Using high order partial feedback linearization to control the hopping robot FRANK. In 2016 IEEE 55th conference on decision and control (CDC) IEEE, 2016, pp. 6669-6675.
67. Foehn, P., Romero, A., and Scaramuzza, D., Time-optimal planning for quadrotor waypoint flight. Science Robotics, 2021, 6, eabhl221.
68. Hong, C., Tang, D., Quan, Q., Cao, Z., and Deng, Z., A combined series-elastic actuator & parallel-elastic leg no-latch bio-inspired jumping robot. Mechanism and Machine Theory, 2020, 149, 103814.
69. Shi, J. et al., Good features to track. In 1994 proceedings of IEEE conference on computer vision and pattern recognition IEEE, 1994, pp. 593-600.
70. S. Jeon, M. Jung, S. Choi, B. Kim, and J. Hwangbo, “Learning whole-body manipulation for quadrupedal robot,” IEEE Robotics and Automation Letters, vol. 9, no. 1, pp. 699-706, 2023.
71. H. Jia, S. Bai, and P. Chirarattananon, “Aerial manipulation via modular quadrotors with passively foldable airframes,” IEEE/ASME Transactions on Mechatronics, 2023.
72. E. Aucone, C. Geckeler, D. Morra, L. Pallottino, and S. Mintchev, “Synergistic morphology and feedback control for traversal of unknown compliant obstacles with aerial robots,” Nature Communications, vol. 15, no. 1, p. 2646, 2024.
73. K. McGuire, C. De Wagter, K. Tuyls, H. Kappen, and G. C. de Croon, “Minimal navigation solution for a swarm of tiny flying robots to explore an unknown environment,” Science Robotics, vol. 4, no. 35, p. eaaw9710, 2019.
74. N. Chen, F. Kong, W. Xu, Y. Cai, H. Li, D. He, Y. Qin, and F. Zhang, “A self-rotating, single-actuated uav with extended sensor field of view for autonomous navigation,” Science Robotics, vol. 8, no. 76, p. eade4538, 2023.
75. M. Tranzatto, T. Miki, M. Dharmadhikari, L. Bernreiter, M. Kulkarni, F.

Mascarich, O. Andersson, S. Khattak, M. Hutter, R. Siegwart et al., “Cerberus in the darpa subterranean challenge,” Science Robotics, vol. 7, no. 66, p. eabp9742, 2022.
76. P. Arm, G. Waibel, J. Preisig, T. Tuna, R. Zhou, V. Bickel, G. Ligeza, T. Miki, F. Kehl, H. Kolvenbach et al., “Scientific exploration of challenging planetary analog environments with a team of legged robots,” Science robotics, vol. 8, no. 80, p. eade9548, 2023.
77. M. Chiou, G.-T. Epsimos, G. Nikolaou, P. Pappas, G. Petousakis, S. Mühl, and R. Stolkin, “Robot-assisted nuclear disaster response: Report and insights from a field exercise,” in 2022 IEEE/RSJ International Conference on Intelligent Robots and Systems (IROS). IEEE, 2022, pp. 4545-4552.
78. I. Radosavovic, T. Xiao, B. Zhang, T. Darrell, J. Malik, and K. Sreenath, “Real-world humanoid locomotion with reinforcement learning,” Science Robotics, vol. 9, no. 89, p. eadi9579, 2024.
79. J. Lee, J. Hwangbo, L. Wellhausen, V. Koltun, and M. Hutter, “Learning quadrupedal locomotion over challenging terrain,” Science robotics, vol. 5, no. 47, p. eabc5986, 2020.
80. M. Sombolestan and Q. Nguyen, “Adaptive-force-based control of dynamic legged locomotion over uneven terrain,” IEEE Transactions on Robotics, vol. 40, pp. 2462-2477, 2024.
81. G. Valsecchi, N. Rudin, L. Nachtigall, K. Mayer, F. Tischhauser, and M. Hutter, “Barry: a high-payload and agile quadruped robot,” IEEE Robotics and Automation Letters, 2023.
82. B. Jin, S. Ye, J. Su, and J. Luo, “Unknown payload adaptive control for quadruped locomotion with proprioceptive linear legs,” IEEE/ASME Transactions on Mechatronics, vol. 27, no. 4, pp. 1891-1899, 2022.
83. J.-P. Sleiman, F. Farshidian, and M. Hutter, “Versatile multicontact planning and control for legged loco-manipulation,” Science Robotics, vol. 8, no. 81, p. eadg5014, 2023.
84. F. Kong, W. Xu, Y. Cai, and F. Zhang, “Avoiding dynamic small obstacles with onboard sensing and computation on aerial robots,” IEEE Robotics and Automation Letters, vol. 6, no. 4, pp. 7869-7876, 2021.
85. P. Foehn, E. Kaufmann, A. Romero, R. Penicka, S. Sun, L. Bauersfeld, T.

Laengle, G. Cioffi, Y. Song, A. Loquercio et al., “Agilicious: Open-source and open-hardware agile quadrotor for vision-based flight,” [20] Science robotics, vol. 7, no. 67, p. eabl6259, 2022.
86. Z. Tu, F. Fei, and X. Deng, “Untethered flight of an at-scale dual-motor hummingbird robot with bio-inspired decoupled wings,” IEEE Robotics and Automation Letters, vol. 5, no. 3, pp. 4194-4201, 2020.
87. R. Zufferey, J. Tormo-Barbero, M. M. Guzm'an, F. J. Maldonado, E. Sanchez-Laulhe, P. Grau, M. P'erez, J. A. Acosta, and A. Ollero, “Design of the high-payload flapping wing robot e-flap,” IEEE Robotics and Automation Letters, vol. 6, no. 2, pp. 3097-3104, 2021.
88. S. Bai, Q. He, and P. Chirarattananon, “A bioinspired revolving-wingdrone with passive attitude stability and efficient hovering flight,” Science Robotics, vol. 7, no. 66, p. eabg5913, 2022.
89. T. Ching, J. Z. W. Lee, S. K. H. Win, L. S. T. Win, D. Sufiyan, C. P. X. Lim, N. Nagaraju, Y.-C. Toh, S. Foong, and M. Hashimoto, “Crawling, climbing, perching, and flying by fiba soft robots,” Science Robotics, vol. 9, no. 92, p. eadk4533, 2024.
90. Y. Li, Y. Zhou, J. Huang, Z. Wang, S. Zhu, K. Wu, L. Zheng, J. Luo, R. Cao, Y. Zhang et al., “Jet-hr2: A flying bipedal robot based on thrust vector control,” IEEE Robotics and Automation Letters, vol. 7, no. 2, pp. 4590-4597, 2022.
91. Y. Wang, J. Kang, Z. Chen, and X. Xiong, “Terrestrial locomotion of pogox: From hardware design to energy shaping and step-to-step dynamics based control,” in 2024 IEEE International Conference on Robotics and Automation (ICRA). IEEE, 2024, pp. 3419-3425.
92. M. Bolignari, A. Mo, M. Fontana, and A. Badri-Sprowitz, “Diaphragm ankle actuation for efficient series elastic legged robot hopping,” in 2022 IEEE/RSJ International Conference on Intelligent Robots and Systems (IROS), 2022, pp. 4279-4286.
93. J. An, T. Y. Chung, C. H. D. Lo, C. Ma, X. Chu, and K. W. Samuel Au, “Development of a bipedal hopping robot with morphable inertial tail for agile locomotion,” in 2020 8th IEEE RAS/EMBS International Conference for Biomedical Robotics and Biomechatronics (BioRob 2020, pp. 132-139.
94. C. Kim, D. J. Lee, S. P. Jung, and G. P. Jung, “Dipo: a miniaturized hopping robot via lightweight and compact actuator design for power amplification,” Bioinspiration & Biomimetics, vol. 18, no. 4, 2023.
95. J. K. Yim and R. S. Fearing, “Precision jumping limits from flight-phase control in salto-1p,” in 2018 IEEE/RSJ international conference on intelligent robots and systems (IROS). IEEE, 2018, pp. 2229-2236.
96. E. Ambrose and A. D. Ames, “Improved performance on moving-mass hopping robots with parallel elasticity,” in 2020 IEEE International Conference on Robotics and Automation (ICRA), 2020, pp. 2457-2463.
97. G. Wenger, A. De, and D. E. Koditschek, “Frontal plane stabilization and hopping with a 2dof tail,” in 2016 IEEE/RSJ International Conferenceon Intelligent Robots and Systems (IROS), 2016, pp. 567-573.
98. P. Yu, G. Chamitoff, and K. Wong, “Perching upside down with bi-directional thrust quadrotor,” in 2020 International Conference on Unmanned Aircraft Systems (ICUAS), 2020, pp. 1697-1703.
99. W. Jothiraj, C. Miles, E. Bulka, I. Sharf, and M. Nahon, “Enabling bidirectional thrust for aggressive and inverted quadrotor flight,” in 2019 International Conference on Unmanned Aircraft Systems (ICUAS), 2019, pp. 534-541.
100. K. Mao, J. Welde, M. A. Hsieh, and V. Kumar, “Trajectory planning for the bidirectional quadrotor as a differentially flat hybrid system,” in 2023 IEEE International Conference on Robotics and Automation (ICRA), 2023, pp. 1242-1248.
101. M. Maier, “Bidirectional thrust for multirotor mavs with fixed-pitch propellers,” in 2018 IEEE/RSJ International Conference on Intelligent Robots and Systems (IROS), 2018, pp. 1-8.
102. J. Wehbeh and I. Sharf, “An mpc formulation on so(3) for a quadrotor with bidirectional thrust and nonlinear thrust constraints,” IEEE Robotics and Automation Letters, vol. 7, no. 2, pp. 4945-4952, 2022.
103. A. Tagliabue, Y.-H. Hsiao, U. Fasel, J. N. Kutz, S. L. Brunton, Y. Chen, and J. P. How, “Robust, high-rate trajectory tracking on insect-scale soft-actuated aerial robots with deep-learned tube mpc,” in 2023 IEEE International Conference on Robotics and Automation (ICRA). IEEE, 2023, pp. 3383-3389.
104. Y. H. Hsiao and P. Chirarattananon, “Ceiling effects for hybrid aerial-surface locomotion of small rotorcraft,” IEEE/ASME Transactions on Mechatronics, vol. 24, no. 5, pp. 2316-2327, 2019.
105. N. Csomay-Shanklin, V. D. Dorobantu, and A. D. Ames, “Nonlinear model predictive control of a 3d hopping robot: Leveraging lie group in-tegrators for dynamically stable behaviors,” in 2023 IEEE International Conference on Robotics and Automation (ICRA), 2023, pp. 12 106-12 112.
106. M. Raibert, K. Blankespoor, G. Nelson, and R. Playter, “Bigdog, the rough-terrain quadruped robot,” IFAC Proceedings Volumes, vol. 41, no. 2, pp. 10 822-10 825, 2008.
107. J. Zhang, F. Gao, X. Han, X. Chen, and X. Han, “Trot gait design and cpg method for a quadruped robot,” Journal of Bionic Engineering, vol. 11, no. 1, pp. 18-25, 2014.
108. B. Katz, J. Di Carlo, and S. Kim, “Mini cheetah: A platform for pushing the limits of dynamic quadruped control,” in 2019 international conference on robotics and automation (ICRA). IEEE, 2019, pp. 6295-6301.
109. B. Goldberg, R. Zufferey, N. Doshi, E. F. Helbling, G. Whittredge, M. Kovac, and R. J. Wood, “Power and control autonomy for high-speed locomotion with an insect-scale legged robot,” IEEE Robotics and Automation Letters, vol. 3, no. 2, pp. 987-993, 2018.
110. Z. Liu, W. Zhan, X. Liu, Y. Zhu, M. Qi, J. Leng, L. Wei, S. Han, X. Wu, and X. Yan, “A wireless controlled robotic insect with ultrafast untethered running speeds,” Nature Communications, vol. 15, no. 1, p. 3815, 2024.
111. M. T. Tolley, R. F. Shepherd, B. Mosadegh, K. C. Galloway, M. Wehner, M. Karpelson, R. J. Wood, and G. M. Whitesides, “A resilient, untethered soft robot,” Soft robotics, vol. 1, no. 3, pp. 213-223, 2014.
112. J. Liang, Y. Wu, J. K. Yim, H. Chen, Z. Miao, H. Liu, Y. Liu, Y. Liu, D. Wang, W. Qiu et al., “Electrostatic footpads enable agile insect-scale soft robots with trajectory control,” Science Robotics, vol. 6, no. 55, p. eabe7906, 2021.
113. Z. Miao, J. Liang, H. Chen, J. Lu, X. Sun, Y. Liu, F. Tang, and M. Zhang, “Power autonomy and agility control of an untethered insect-scale soft robot,” Soft Robotics, vol. 10, no. 4, pp. 749-759, 2023.
114. X. Ji, X. Liu, V. Cacucciolo, M. Imboden, Y. Civet, A. El Haitami, S. Cantin, Y. Perriard, and H. Shea, “An autonomous untethered fast soft robotic insect driven by low-voltage dielectric elastomer actuators,” Science Robotics, vol. 4, no. 37, p. eaaz6451, 2019. 19
115. X. Dong, C. Tang, S. Jiang, Q. Shao, and H. Zhao, “Increasing the payload and terrain adaptivity of an untethered crawling robot via soft-rigid coupled linear actuators,” IEEE Robotics and Automation Letters, vol. 6, no. 2, pp. 2405-2412, 2021.
116. X. Yang, L. Chang, and N. O. P'erez-Arancibia, “An 88-milligram insect-scale autonomous crawling robot driven by a catalytic artificial muscle,” Science Robotics, vol. 5, no. 45, p. eaba0015, 2020.
117. H. H. Hariri, G. S. Soh, S. Foong, and K. L. Wood, “A highly manoeuvrable and untethered under-actuated legged piezoelectric miniature robot,” in International Design Engineering Technical Conferences and Computers and Information in Engineering Conference, vol. 59247. American Society of Mechanical Engineers, 2019, p. V05BT07A004.
118. Y. Zhu, M. Qi, Z. Liu, J. Huang, D. Huang, X. Yan, and L. Lin, “A 5-mm untethered crawling robot via self-excited electrostatic vibration,” IEEE Transactions on Robotics, vol. 38, no. 2, pp. 719-730, 2022.
119. L. Orr, B. Stephens, B. B. Kocer, and M. Kovac, “A high payload aerial platform for infrastructure repair and manufacturing,” in 2021 Aerial Robotic Systems Physically Interacting with the Environment (AIRPHARO). IEEE, 2021, pp. 1-6.
120. D. R. McArthur, A. B. Chowdhury, and D. J. Cappelleri, “Design of the i-boomcopter uav for environmental interaction,” in 2017 IEEE International Conference on Robotics and Automation (ICRA), 2017, pp. 5209-5214.
121. Dji matrice 600. [Online]. Available: https://www.dji.com/hk/support/product/matrice600
122. Y. Qin, W. Xu, A. Lee, and F. Zhang, “Gemini: A compact yet efficient bi-copter uav for indoor applications,” IEEE Robotics and Automation Letters, vol. 5, no. 2, pp. 3213-3220, 2020.
123. Datasheet crazyflie 2.1. [Online]. Available: https://www.bitcraze.io/documentation/hardware/crazyflie21/crazyflie21-datasheet.pdf
124. Z. Zhakypov, K. Mori, K. Hosoda, and J. Paik, “Designing minimal and scalable insect-inspired multi-locomotion millirobots,” Nature, vol. 571, no. 7765, pp. 381-386, 2019.
125. E. Kaufmann, L. Bauersfeld, A. Loquercio, M. Müller, V. Koltun, and D. Scaramuzza, “Champion-level drone racing using deep reinforcement learning,” Nature, vol. 620, no. 7976, pp. 982-987, 2023.
126. Y. Song, A. Romero, M. Müller, V. Koltun, and D. Scaramuzza, “Reaching the limit in autonomous racing: Optimal control versus reinforcement learning,” Science Robotics, vol. 8, no. 82, p. eadgl462, 2023.
127. D. Mellinger and V. Kumar, “Minimum snap trajectory generation and control for quadrotors,” in 2011 IEEE international conference on robotics and automation. IEEE, 2011, pp. 2520-2525.
128. F. Zhu, Y. Ren, and F. Zhang, “Robust real-time lidar-inertial initialization,” in 2022 IEEE/RSJ International Conference on Intelligent Robots and Systems (IROS).

IEEE, 2022, pp. 3948-3955.
129. W. Xu and F. Zhang, “Fast-lio: A fast, robust lidar-inertial odometry package by tightly-coupled iterated kalman filter,” IEEE Robotics and Automation Letters, vol. 6, no. 2, pp. 3317-3324, 2021.
130. W. Xu, Y. Cai, D. He, J. Lin, and F. Zhang, “Fast-lio2: Fast direct lidar-inertial odometry,” IEEE Transactions on Robotics, vol. 38, no. 4, pp 2053-2073, 2022.
131. B. Zhou, F. Gao, L. Wang, C. Liu, and S. Shen, “Robust and efficient quadrotor trajectory generation for fast autonomous flight,” IEEE Robotics and Automation Letters, vol. 4, no. 4, pp. 3529-3536, 2019.
132. B. T. Lopez and J. P. How, “Aggressive 3-d collision avoidance for high-speed navigation.” in ICRA, 2017, pp. 5759-5765.
133. S. B. Fuller, “Four wings: An insect-sized aerial robot with steering ability and payload capacity for autonomy,” IEEE Robotics and Automation Letters, vol. 4, no. 2, pp. 570-577, 2019.
134. K. Y. Ma, P. Chirarattananon, S. B. Fuller, and R. J. Wood, “Controlled flight of a biologically inspired, insect-scale robot,” Science, vol. 340, no. 6132, pp. 603-607, 2013.
135. Y. Chen, H. Zhao, J. Mao, P. Chirarattananon, E. F. Helbling, N.-s. P. Hyun, D. R. Clarke, and R. J. Wood, “Controlled flight of a microrobot powered by soft artificial muscles,” Nature, vol. 575, no. 7782, pp. 324-329, 2019.
136. N. T. Jafferis, E. F. Helbling, M. Karpelson, and R. J. Wood, “Untethered flight of an insect-sized flapping-wing microscale aerial vehicle,” Nature, vol. 570, no. 7762, pp. 491-495, 2019.
137. S. J. Wang, D. Kuang, S. D. Lee, R. J. Full, and H. S. Stuart, “Squirrel-inspired tendon-driven passive gripper for agile landing,” in 2024 IEEE International Conference on Robotics and Automation (ICRA). IEEE, 2024, pp. 4184-4190.

### SUMMARY OF INVENTION

According to an aspect of the invention, there is provided a robot which includes an aerial unit, a passive leg mechanism operably coupled with the aerial unit, and a controller configured to control operation of the aerial unit such that the robot is operable in, at least, a flight mode and a hopping mode.

In some embodiments, the controller may be configured to control operation of the aerial unit such that the robot alternates between the flight mode and the hopping mode during operation.

In some embodiments, the passive leg mechanism may consist only of a single telescopic leg arrangement.

In some embodiments, the single telescopic leg arrangement may include an upper leg section fixed to the aerial unit, a lower leg section movably connected with the upper leg section via one or more connectors, and an elastic mechanism operably coupled between the upper leg section and the lower leg section.

In some embodiments, the controller may be configured to predict a landing location of the robot in the hopping mode.

In some embodiments, the controller may be configured to determine a landing location of the robot for a next hopping cycle based on a landing attitude of the robot for a current hopping cycle.

In some embodiments, the aerial unit may include a mini unmanned aerial vehicle or a micro unmanned aerial vehicle.

In some embodiments, the aerial unit may include a micro quadcopter.

In some embodiments, the telescopic leg arrangement may further include one or more guide wheel sets, each of the one or more guide wheel sets being operably coupled between a respective one of the one or more connectors and the lower leg section to restrict motion of the lower leg section to translation only and to reduce the friction. The guide wheel sets may include, e.g., bearings.

In some embodiments, the lower leg section may include a foot for contacting ground or environment.

In some embodiments, the lower leg section may include a first hook for supporting part of the elastic mechanism, and at least one of the connectors may include a second hook for supporting another part of the elastic mechanism.

In some embodiments, the elastic mechanism may include one or more elastic elements.

In some embodiments, the one or more elastic elements may be mounted between the upper leg section and the lower leg section such that the one or more elastic elements are tensioned to provide an elastic force operable to overpower weight of the robot.

In some embodiments, a length measured from a lowest end of the lower leg section to a center of mass (CoM) of the robot is at least twice the length of a wheelbase of the aerial unit.

In some embodiments, the robot may further include a stabilizer operable to interact with airflow to stabilize the robot.

In some embodiments, the stabilizer may be configured to control a landing attitude and to stabilize hopping speed and attitude without external feedback or vision.

In some embodiments, the stabilizer may include one or more horizontally hinged surfaces.

In some embodiments, the one or more horizontally hinged surfaces may be actuated by a cable arrangement connected to a drive unit.

In some embodiments, the one or more horizontally hinged surfaces may be arranged to be made rigid when the cable arrangement is actuated and swing freely in response to airflow when the cable arrangement is de-actuated.

In some embodiments, the controller may be configured to predict a landing location and velocity of the robot for a current hopping cycle (k), determine a takeoff attitude and a takeoff velocity of the robot for the current hopping cycle (k) based on: the predicted landing location and velocity, a pre-specified landing location, and a hopping altitude setpoint for a next hopping cycle (k+1), determine a desired landing attitude for the current hopping cycle (k) to realize the determined takeoff attitude and takeoff velocity of the robot for the current hopping cycle (k), and control a landing location for the next hopping cycle (k+1) and stabilize the robot by regulating the landing attitude of the current hopping cycle (k).

In some embodiments, the controller may be configured to determine the landing location for the next hopping cycle (k+1) based on a lateral component of the takeoff velocity and an amount of time the robot spends in an aerial phase, and the takeoff velocity is influenced by the landing attitude.

According to another aspect of the invention, there is provided a robot which includes an aerial unit having a thruster module; a passive leg mechanism operably coupled with the aerial unit; and a controller module configured to control operation of the aerial unit such that the robot is operable in at least a hopping mode. The thruster module is adapted to provide bidirectional thrusts.

In some embodiments, the aerial unit includes a quadrotor which contains the thruster module. The thruster module further includes a plurality of rotors, each of the rotors adapted to provide independently the bidirectional thrusts.

In some embodiments, the quadrotor contains a plurality of bidirectional motor controllers each connected to and adapted to control a corresponding one of the rotors.

In some embodiments, each of the rotors has a ratio of thrust coefficients in a reverse direction to a forward direction respectively, which is in the range of −0.36 to −0.56.

In some embodiments, the hopping mode includes a descending phase, a stance phase, and an ascending phase of the robot. The thruster module is adapted to provide a substantially downward thrust during at least part of the descending phase, and a substantially upward thrust during at least part of the ascending phase.

In some embodiments, during a hopping cycle, the thruster module is adapted to change its thrust direction twice.

In some embodiments, the descending phase comprises an unpowered descending sub-phase and a powered descending sub-phase. The ascending phase includes an unpowered ascending sub-phase and a powered ascending sub-phase. The thruster module is adapted to provide the substantially downward thrust during the powered descending sub-phase, and the substantially upward thrust during the powered ascending phase.

In some embodiments, the passive leg mechanism contains a telescopic leg arrangement which is spring-loaded with an elastomer module.

In some embodiments, the telescopic leg arrangement includes an upper leg section fixed to the aerial unit; and a lower leg section movably connected with the upper leg section via a connection module. An elastomer module is operably coupled between the upper leg section and the lower leg section.

In some embodiments, the upper leg section contains two upper legs that are separated apart and extending in parallel. The lower leg section includes a single lower leg located substantially equidistantly to the two upper legs and adapted to move relative to the upper legs.

In some embodiments, the connection module contains an upper bearing module and a lower bearing module which are fixed to the upper legs. The upper bearing module and the lower bearing module are coupled to the lower leg such that the lower leg is adapted to move relative to the upper legs in a single direction.

In some embodiments, the elastomer module contains a lower mounting hook, an upper mounting hook, and one or more elastomers connected between the lower mounting hook and the upper mounting hook. The lower mounting hook is fixedly connected to the lower bearing module, and the upper mounting hook is fixedly connected to the lower leg.

In some embodiments, the controller module is configured to predict a landing location of the robot in the hopping mode.

In some embodiments, the controller module is configured to determine a landing location of the robot for a next hopping cycle based on a landing attitude of the robot for a current hopping cycle.

In some embodiments, the controller module is adapted to use a trained neural network to calculate the landing attitude based on a predicted landing location and a desired landing location.

In some embodiments, the controller module comprises a height controller, a high-level position controller, thrust and attitude management, and a low-level attitude controller.

Exemplary embodiments of the invention therefore provide various hybrid hopping and flying robot named Hopcopter. The Hopcopter seamlessly integrates a nano quadcopter with a passive telescopic leg, overcoming the limitations of traditional jumping mechanisms that rely on stance phase leg actuation, which largely simplified the complexity of mechanical structure. By analyzing the dynamics, a propeller-based jumping control method has been developed to stabilize and control the position of the robot during a continuous jump. This unique design and actuation strategy allow for adjustable jump height, short stance phase duration and position controllability. Compared to conventional jumping mechanisms or jumping robots, the hybrid jumping-flying robot achieves a highly reliable controllability and jumping agility with a simple mechanism.

In some embodiments, a thrust-based hopper is introduced which significantly enhances its payload capacity as achieved through the integration of bi-directional thrusters and a refined stance phase model that accounts for gravitational effects during the stance phase. The bidirectional thrusters enable the robot to handle increased energy losses from ground impacts and the leg mechanism, accommodating heavier payloads. By considering gravitational forces, the robot achieves greater accuracy in hopping, especially during larger jumps with substantial payloads.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF DRAWINGS

The foregoing and further features of the present invention will be apparent from the following description of preferred embodiments which are provided by way of example only in connection with the accompanying Figs, of which:

FIG. 1A shows a hybrid hopping and flying robot according to an embodiment of the invention.

FIG. 1B is an enlarged diagram of part A of the hybrid hopping and flying robot of FIG. 1A, illustrating a retractable leg mechanism.

FIG. 2A is a schematic diagram illustrating dynamics of the hybrid hopping and flying robot and two phases of a complete jumping cycle.

FIG. 2B is an illustration of stance phase dynamics from landing (t_{LD}) to takeoff (t_{TO}).

FIG. 2C shows takeoff state prediction using the identified stance phase dynamics.

FIG. 3A is a schematic diagram illustrating an example hopping trajectory in different phases from control perspective.

FIG. 3B is a block diagram showing hierarchical structure of a controller according to an embodiment of the invention.

FIG. 4 shows trajectory tracking experiments under a hopping mode: FIG. 4, in A, shows reference and realized circular trajectories; FIG. 4, in B, shows reference and realized step trajectories; and FIG. 4, in C, shows a diagram showing the robot tracking step trajectory.

FIG. 5A is a graph showing hopping period against hopping height, predicted according to a model according to an embodiment of the invention.

FIG. 5B is a graph showing hopping agilities against hopping height of the robot according to an embodiment of the invention and existing jumping robots.

FIG. 6A and FIG. 6B show demonstration of hybrid jumping and flying locomotion of a hybrid hopping and flying robot according to an embodiment of the invention to show the robot utilizing the ground to decelerate from lateral translation.

FIG. 6C and FIG. 6D show a composite image and time course of position of a hybrid hopping and flying robot according to an embodiment of the invention to show the robot utilizing the ground to perform a 90° tight turn.

FIG. 6E and FIG. 6F show two sequential composite images and data to show the robot utilizing a wall and a tilted plane to reverse it flight direction (U-turn) and brake.

FIG. 7A shows a hybrid hopping and flying robot including a detachable active aerodynamic stabilizer according to an embodiment of the invention.

FIG. 7B is an enlarged diagram of part C of the hybrid hopping and flying robot of FIG. 7A, illustrating the stabilizer according to an embodiment of the invention.

FIG. 7C is a diagram displaying relationships between landing velocity, landing attitude and takeoff velocity.

FIG. 7D shows Poincaré maps depicting the evolution of landing velocity angle θ_{z} in terms of θ_{z}|ₖ₊₁/θ_{z}|ₖ, as a function of θ_{z}|ₖ and ϕ|ₖ.

FIG. 8A is a schematic diagram of an example setup of drop tests of the robot for parameter identification.

FIG. 8B shows altitude of the robot in the free-drop experiments where dark and light curves represent falling and ascending (downstroke and upstroke) phases.

FIG. 8C shows vertical acceleration versus compressed length of the robot in the stance phase after the drops.

FIG. 9 shows an example trajectory of the leg contraction l(t) of the robot where the solid dark and light lines represent the analytical solutions of l(t) during the downstroke and upstroke, respectively, and the dashed lines represent the extended solutions.

FIG. 10 shows a trajectory of hybrid locomotion of the robot with longitudinal acceleration and deceleration.

FIG. 11 shows a trajectory of hybrid locomotion of the robot with a 90° turn.

FIG. 12 shows a trajectory of hybrid locomotion with a U-turn.

FIG. 13 shows a trajectory of hybrid locomotion with non-horizontal surfaces.

FIG. 14 shows Poincaré maps depicting the evolution of the landing velocity angle θz in terms of θ_{z}|ₖ₊₁/θ_{z}|ₖ, as a function of θ_{z}|ₖ and ϕ|ₖ: (A) shows predictions for the hopping height of 0.4 m; (B) shows predictions for the hopping height of 0.6 m; (C) shows predictions for the hopping height of 0.7 m; and (D) shows predictions for the hopping height of 0.8 m.

FIG. 15A and FIG. 15B show trajectory of the robot in passive stability test for three scenarios of stable hopping (achieved with both the aerodynamic stabilizer and attitude controller), hopping with the attitude controller only, and hopping with the aerodynamics stabilizer only.

FIG. 16 shows altitude of the robot in agility evaluation.

FIG. 17 shows results from endurance test: (A) shows the altitude of the robot while hopping and the respective motor commands; and (B) shows onboard battery voltage of the robots when jumping and flying.

FIG. 18A shows the overall appearance of a thrust-based hopping robot according to another embodiment of the invention.

FIG. 18B is an enlarged view of the section A in the robot of FIG. 18A.

FIG. 18C illustrates that upon landing (ground contact), the leg of the robot in FIG. 18A undergoes compression, stretching the rubber bands.

FIG. 18D illustrates both upward and downward thrust generated by a propeller of the robot in FIG. 18A by reversing the propeller's spinning direction.

FIG. 19 shows the operating principles of the thrust-based hopping robot of FIGS. 18A-18D.

FIG. 20A shows the theoretical payload limit of thrust-based hopping robots.

FIG. 20B shows experimental payload ratios demonstrated by mobile robots across size scales (wheeled robots excluded).

FIG. 21A shows the distribution of landing speed from the drop test for the stance phase model.

FIG. 21B shows angular errors between the predicted and measured takeoff velocity for the complete stance phase model and empirical linear model.

FIG. 21C shows angular errors between the measured and predicted takeoff body axis for the complete stance phase model and empirical linear model.

FIG. 22A illustrates, for the compression of stance phase model, vectors and angles used to identify the state, including velocity vectors (not to scale) body axes of the robot at landing and takeoff.

FIG. 22B illustrates the landing angle versus take off velocity angle.

FIG. 22C illustrates the landing angle versus takeoff attitude angle.

FIG. 22D shows definitions of the angles used as the input and output for the neural network.

FIG. 22E shows average landing angle error produced by the training set and validation set while learning for 500 epochs.

FIG. 23A shows the overall control architecture involves the hopping height controller, high-level position controller, thrust and attitude management module, and low-level attitude controller.

FIG. 23B illustrates the implementation of the high-level position controller.

FIG. 23C is a diagram illustrating the timing for powered ascent and powered descent used for the hopping height controller.

FIG. 23D is a diagram showing the process of position control, involving the landing state of the current step, takeoff velocity, and the subsequent landing position.

FIG. 24A is a composite photo capturing the robot's trajectory while hopping with a 2-kg payload.

FIG. 24B shows average power consumption and power loading when carrying different payloads, in which error bars indicate one standard deviation.

FIG. 24C are charts showing trajectory tracking results, without payload.

FIG. 24D are charts showing trajectory tracking results, with 2-kg payload.

FIG. 25 shows the leaping performance of the robot with three payload masses.

FIG. 26A is a composite photo showing the trajectory of the robot turning 90 degrees between 2-m hops.

FIG. 26B illustrates the horizontal speeds during the experiment with the sharp turn as seen in FIG. 26A.

FIG. 26C illustrates the horizontal acceleration during the experiment with the sharp turn as seen in FIG. 26A.

FIG. 26D shows the trajectories of the experiments with 1.5-m steps and a 90-degree turn in between for the complete stance phase model.

FIG. 26E shows the trajectories of the experiments with 1.5-m steps and a 90-degree turn in between for the linear model.

FIG. 27A shows hill-side hopping of the robot with LiDAR feedback and a human pilot, where the sub-figure A is a photo of the robot at t=10 s, sub-figure B being a photo of the robot after hopping for 135 s, and the sub-figure on the right being a point cloud map constructed by the hopping robot.

FIG. 27B shows the reference (from the human operator) and the actual position of the robot (in the x axis) during the 200-s field experiment.

FIG. 27C shows the reference (from the human operator) and the actual position of the robot (in the y axis) during the 200-s field experiment.

FIG. 27D shows reference and actual heading angle of the robot taken from the experiment.

FIG. 28A shows the control architecture devised to realize outdoor autonomous hopping of the robotic hopper with real-time feedback from the LiDAR system, including a block diagram illustrating the measurements and signals between the onboard sensors and computers.

FIG. 28B shows a composite image of the robot navigating to the target location while avoiding collisions with trees.

FIG. 28C shows a point cloud map constructed in real time, with the starting point, goal, and the trajectory shown.

FIG. 28D shows the planned and actual trajectories obtained from the autonomous hopping experiment.

Before any embodiments of the invention are explained in detail, it is to be understood that the invention is not limited in its application to the details of embodiment and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

In the drawings, like numerals indicate like parts throughout the several embodiments described herein.

### DETAILED DESCRIPTION OF THE PREFERRED EMBODIMENTS

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

As used herein and in the claims, “couple” or “connect” refers to electrical coupling or connection either directly or indirectly via one or more electrical means unless otherwise stated.

Terms such as “horizontal”, “vertical”, “upwards”, “downwards”, “above”, “below” and similar terms as used herein are for the purpose of describing the invention in its normal in-use orientation and are not intended to limit the invention to any particular orientation.

The invention generally relates to a robot that includes an aerial unit, a passive leg mechanism operably coupled with the aerial unit, and a controller configured to control operation of the aerial unit such that the robot is operable in, at least, a flight mode and a hopping mode. The following disclosure provides some example embodiments of the robot of the invention.

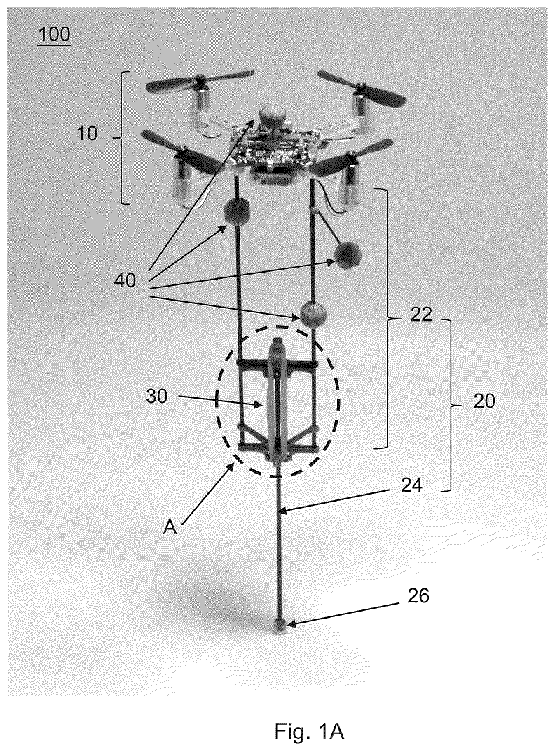

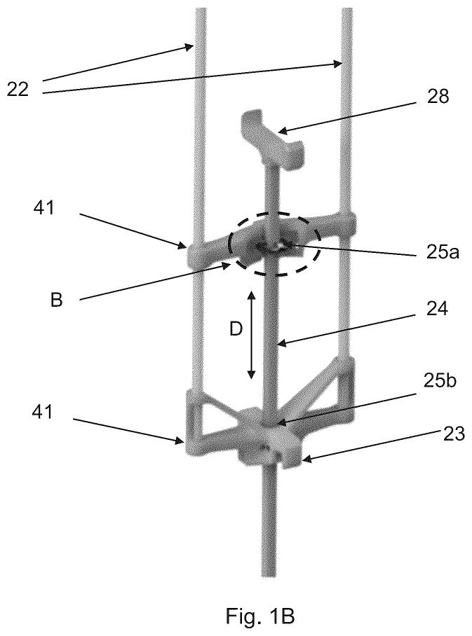

In an first embodiment of the invention, there is provided a hybrid hopping-flying robot that augments a micro aerial vehicle with a passive elastic telescopic leg (see FIGS. 1A-1B). This results in a mechanically simple and efficient design that directly leverages the existing rotors of the micro aerial vehicle for jumping. A robot that can jump and fly is known [43], but it could only execute isolated jumps between flights and cannot perform continuous hopping. Unlike this existing robot, the hybrid hopping and flying robot in some embodiments of the invention is actuated in the aerial phase rather than in the stance phase, thus enabling continuous hopping and adjustable jump height.

The passive elastic leg differentiates the hybrid hopping and flying robot in some embodiments of the invention (i.e., referred to as “Hopcopter” herein) from existing jumping robots, allowing it to achieve unprecedented hopping agility. The absence of stance actuation permits a shorter stance phase, enabling higher jumping frequencies and agility. To demonstrate high hopping agility, a 42-gram Hopcopter prototype is constructed, and the robot's hopping dynamics are identified and characterized. Based on the results, a model-based hopping controller is developed to stabilize the robot during hopping using external feedback. For each hop, the passive telescopic leg absorbs and stores kinetic energy through elastic recoil, while the thrust-based actuation compensates for energy loss and stabilizes attitude and velocity. Experimental results show that the robot can accurately track a reference trajectory, validating the proposed three-dimensional hopping model and showing that the Hopcopter's average hopping speeds approach the theoretical ballistic limit, surpassing state-of-the-art jumping robots including Salto-1P [32]. This distinguishes the proposed approach from those relying on latched elastic actuation, which imposes limitations on continuous hopping and variable jump heights, and from those relying on unlatched series elastic actuation, which require a longer stance time. In flight mode, the robot in some embodiments of the invention functions as a regular micro aerial vehicle, allowing for stable hovering, agile maneuvering, and smooth flight-hopping transitions. Intermittent hops during flight dramatically enhance instantaneous accelerations for rapid and tight turns.

To attain stable hopping using onboard sensors only, the robot is outfitted with active aerodynamic stabilizers. These surfaces dynamically influence landing attitude, stabilizing hopping speed and attitude without external feedback or vision. The realized hybrid hopping-flying locomotion of Hopcopter offers unprecedented versatility in navigating complex environments. Unlike wheeled aerial vehicles that struggle to negotiate rough terrains [44]-[50], the hopping ability allows the robot to overcome obstacles and traverse uneven surfaces. Compared to flight-capable bipedal and legged robots [51]-[54], the hopping mechanism is far more efficient, requiring less energy for locomotion. By seamlessly integrating flying and jumping, our approach enables synergistic hybrid locomotion, with the flight mechanism facilitating passive jumping and intermittent jumping generating large accelerations for rapid turns when flying. This multimodal locomotion capability has the potential to radically expand the range of environments in which robots can operate effectively and efficiently, from cluttered indoor spaces to rugged outdoor terrains.

### Hopcopter Platform in Some Embodiments

A hybrid hopping and flying robot (or vehicle) according to an embodiment is provided. The hybrid hopping and flying robot is referred to as “Hopcopter” herein. As shown in FIG. 1A, the hybrid hopping and flying robot 100 includes an aerial unit 10 and a passive leg mechanism 20 operably coupled with the aerial unit 10. The aerial unit 10 may include a mini unmanned aerial vehicle or a micro unmanned aerial vehicle. The aerial unit 10 may include a micro quadcopter (for example, Bitcraze, Crazyflie 2.1, 27 grams). The passive leg mechanism 20 can include a telescopic leg mechanism or a retractable leg mechanism. The passive leg mechanism 20 features a rigidly fixed upper leg section 22 on the aerial unit 10, a sliding rod as a lower leg section 24, and elastic elements (for example, rubber bands) acting as an elastic mechanism 30. The upper leg section 22 may be made of two carbon fiber rods (for example, diameter: 1.8 mm) rigidly mounted below the aerial unit b via, for example, fasteners. The fasteners may include 3D printed fasteners (for example, Formlab Form 3, Tough 2000). FIG. 1B is an enlarged diagram showing part A in FIG. 1A. As shown in FIG. 1A and FIG. 1B, the lower leg section 24 includes a single rod, a pointy foot 26, and a hook 28 for mounting the rubber bands (for example, a 3D printed hook), which can constitute the main moving components of the hopping mechanism. The lower leg section 24 may be made of a single carbon-fiber rod (for example, 2×2 mm²-square cross section). The lower leg section 24 is movably connected with the upper leg section 22 by one or more connectors 41. The passive leg mechanism 20 further includes one or more guide wheel sets 25a and 25b between the connectors 41 and the lower leg section 24 to restrict motion to vertical translation. That is, each of the one or more guide wheel sets is operably coupled between a respective one of the one or more connectors 41 and the lower leg section 24 to restrict motion of the lower leg section 24 to translation only. Part B in FIG. 1B provides a partial sectional view to show the guide wheel set 25a arranged between the connector 41 and the lower leg section 24. In particular, the lower leg section 24 connects to the upper leg section 22 via two sets of guide wheel sets 25a and 25b, restricting motion to vertical translation (moving direction D) and minimizing sliding friction. The guide wheel sets 25a and 25b may include, e.g., bearings. In this configuration, the axis of translation passes through the center of mass (CoM) of the robot 100. Two rubber bands 30 (for example, diameter: ≈1.5 mm and ring radius: ˜20 mm) anchor between the upper leg section 22 and the tip of the lower leg section 24 as the elastic element. The bands 30 are mounted such that they are pre-stretched and further elongated upon the leg contraction. In addition, one or more reflective spherical markers 40 are affixed on the robot 100 to obtain the pose measurements from a motion capture system. For example, the one or more reflective spherical markers 40 may include four reflective spherical markers. In an embodiment, the entire Hopcopter weighs 34.8 grams, lower than the maximum takeoff weight of 42 g.

The design incorporates two key features to simplify the stance phase dynamics. Firstly, the passive leg mechanism 20 (i.e., the telescopic leg), at 22 cm long (from the foot to the CoM of the robot), is over twice the length of the quadcopter 10's 9 cm wheelbase. Secondly, the rubber bands 30 are pre-stretched, enabling the elastic force to overpower the robot 100's weight. These features allow the robot 100 to be treated as a point mass during the stance phase and decouple the dynamics from gravity's orientation as detailed in the subsequent section.

### Aerial and Stance Dynamics

In flight, Hopcopter's dynamics are characterized by propelling torque (roll, pitch, and yaw) and collective thrust, indistinguishable from a regular rotorcraft [55]-[57].

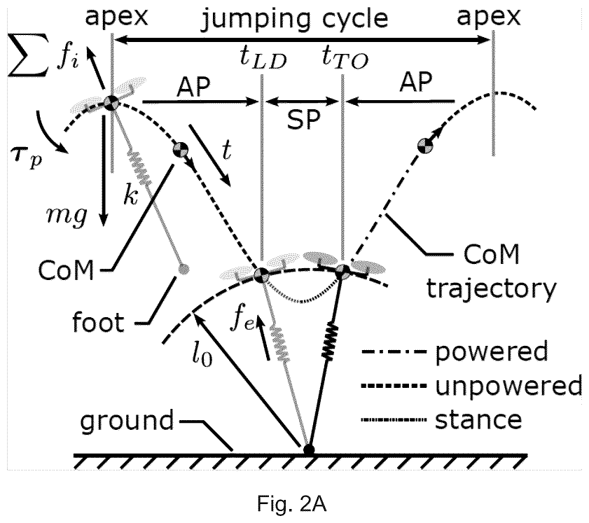

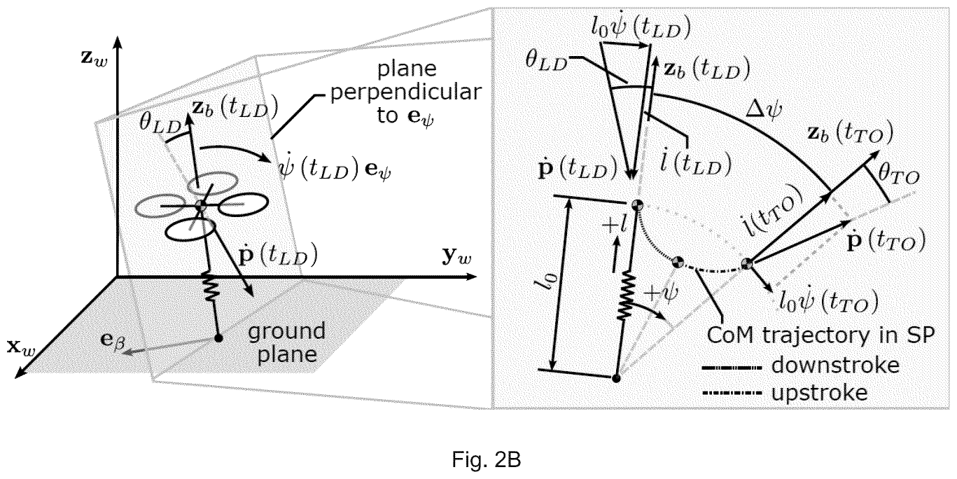

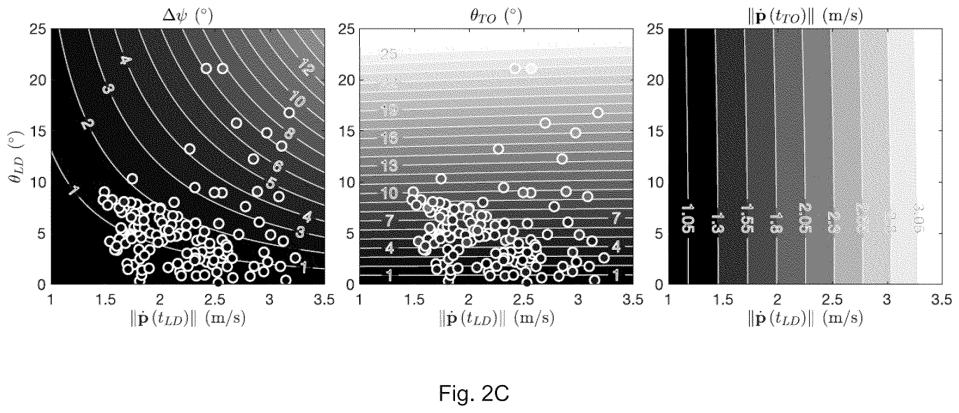

However, when functioning as a monopedal hopper, the robot is a hybrid dynamical system, with one jumping cycle alternating between the aerial and terrestrial stages, separated by the ground contact [58]-[60]. For modeling purposes, in this work, the movement of the CoM of the hybrid robot in each jumping cycle is divided into two phases: aerial (AP), stance (SP) phases, separated by two key timestamps: landing (t_{LD}) and takeoff (t_{TO}) as illustrated in FIG. 2A.

Without the ground contact, in the AP, the robot shares the same flight dynamics with a regular quadcopter with six degrees of freedom (DoFs) in the form of rotational and translational motion. Upon landing, under the condition of no slippage between the foot and the ground [58], [59], the attitude and position of the robot are physically coupled. The ground contact acts as a pivot for the body attitude, with the distance to the CoM changing with the leg contraction. The foot collision marks the transition between AP and SP. A comprehensive model consists of two sets of dynamics and the state transitions between them. Inspired by the classical spring-loaded inverted pendulum (SLIP) model [59], [61], the embodiments of the invention propose a simplified yet complete three-dimensional jumping model that captures the dominant effects, suitable for real-time jumping control.

### Aerial Phase

When flying, the robot is modeled as a rigid body with weight mg and inertia tensor I=diag (Iₓ, I_{y}, I_{z}) in a gravity field. The lightweight telescopic leg is abstracted as a thin rod with a preloaded elastomer. The leg axis passes through the CoM of the robot and aligns with the thrust direction of the propellers as schematically illustrated in FIGS. 2A and 2B. FIG. 2A is a schematic diagram illustrating the dynamics and the two phases of a complete jumping cycle. FIG. 2B is an illustration of the stance phase dynamics from landing (t_{LD}) to takeoff (t_{TO}). FIG. 2C shows takeoff state prediction using the identified stance phase dynamics where the 130 datapoints shows measured landing and takeoff state of the robot in an experiment of jumping model verification.

In the aerial phases, the equations of motion are identical to those of a regular multirotor vehicle [55]-[57], [62] and given by

$$m \ddot{p} = {z}_{b} \sum {f}_{i} - {e}_{3} m g , \qquad ( 1 )$$

$${τ}_{p} = I \dot{ω} + ω \times I ω , \qquad ( 2 )$$

where p=[x, y, z]^{T} denotes the position vector of the CoM of the robot in the inertial frame {x_{w}, y_{w}, z_{w}}. The z axis of the body-fixed frame {x_{b}, y_{b}, z_{b}}, as seen in the inertial frame, represents the thrust direction of the propellers: z_{b}=Re₃, where R∈SO(3) is a rotation matrix mapping the body-fixed frame to the inertial frame and e₃=[0,0,1]^{T} is a basis vector. ω=[ωₓ, ω_{y}, ω_{z}]^{T} is the body-centric angular velocity. The summation Σfᵢ denotes the total thrust magnitude and T_{P} is the total propelling torque in the body frame. Together Σfᵢ and τₚ are control inputs that can be commanded via distributing the power between the four rotors. In a regular flight regime, aerodynamic drag can be neglected [56], [62].

### Landing Transition

Once landed (timestamp t_{LD} in FIG. 2A), the ground normal brings about the leg contraction, decreasing the leg length l(t) from the nominal state of, for example, l₀=22 cm. Without any influence from the propelling thrust, the SP dynamics is completely passive. The main robot body interacts with the ground through the telescopic leg in the form of the restoring force created by the elastomer fₑ. Since the robot can be treated as a point mass [32], [58], [59] instead of a rigid body (Iₓ, I_{y}, I_{z}<<ml₀², thanks to the long leg length as discussed in Note S1 in Supplementary Note section provided in the end part of the description), the robot follows the equation of motion

$$m \ddot{p} = - {e}_{3} m g + {z}_{b} {f}_{e} . \qquad ( 3 )$$

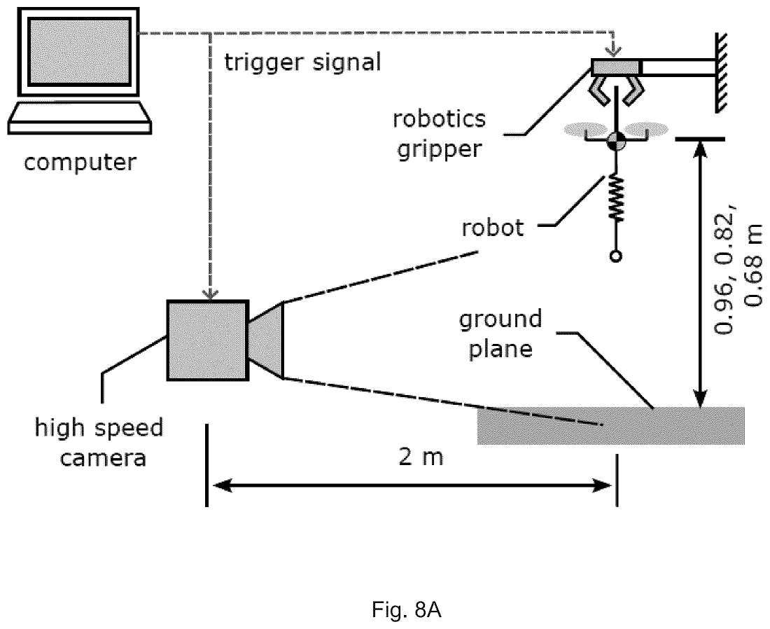

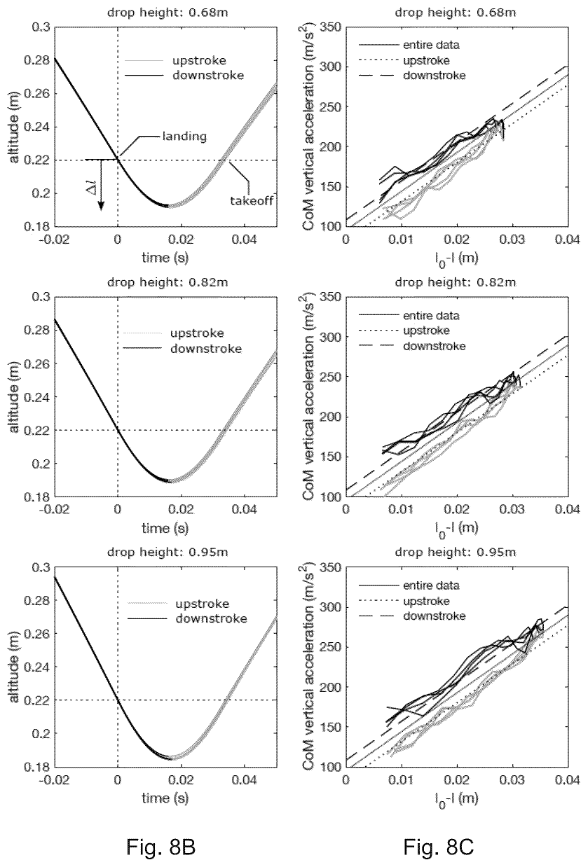

Based on the measurements from the drop tests (see Materials and Methods section below, and FIG. 8A to FIG. 8C), the elastic force fₑ is linearly proportional to the deformation of the elastomer l−l₀−l_{P} by a constant k, with a constant friction (likely attributed to the bearing or the elastic hysteresis) of magnitude f_{c}

$$\begin{matrix}{f}_{e} = - k ( l - {l}_{0} - {l}_{p} ) - sgn ( \dot{l} ) {f}_{c} & for l < {l}_{0} ,\end{matrix} \qquad ( 4 )$$

where l−l₀ is the leg contraction and l_{P} is the pre-stretched length of the elastomer. The friction term accounts for the dissipating energy that results in a hysteresis behavior brought by the loading/downstroke (\dot{l}<0) and unloading/upstroke (\dot{l}>0) motion (see FIG. 8C). By design, the preload force klₚ prevails the weight of the robot (klₚ=3.35 N versus mg=0.34 N, see Materials and Methods section and Table S1). Therefore, the stance dynamics is nominated by fₑ and Equation 3 simplifies to

$$m \ddot{p} = {z}_{b} {f}_{e} , \qquad ( 5 )$$

Assuming no slippage (thanks to the pointy foot), the ground contact point can be regarded as a free-to-rotate spherical hinge and the CoM of the robot is restricted to the translation along the leg axis and the rotation about the foot as shown in FIGS. 2A and 2B. Since the elastic force fₑ is always along the axial direction, the angular momentum measured with respect to the ground contact in the SP is conserved, the trajectory of the CoM can be separately described as the axial and angular motion and is independent of the gravity direction. Denoting the landing velocity as \dot{p}(t_{LD}) and θ_{LD}∈[0, π) as the angle between \dot{p}(t_{LD}) and the leg axis z_{b} (t_{LD}), the leg contraction speed is yielded at touchdown l(t_{LD})=z_{b}(t_{LD})·\dot{p}(t_{LD})=−∥\dot{p}(t_{LD})∥cos θ_{LD}. As long as the body-centric angular velocity immediately before landing is minimized, the angular speed of the CoM \dot{ψ}(t_{LD}) with respect to the ground is the component of \dot{p}(t_{LD}) in the direction orthogonal to z_{b} or l₀\dot{ψ}(t_{LD})=∥\dot{p}(t_{LD})×z_{b}(t_{LD})∥=\dot{p}(t_{LD})∥sin θ_{LD}. As illustrated in FIG. 2B, the subsequent angular motion is characterized by the rotational axis defined by e_{ψ}=−\dot{p}(t_{LD})×z_{b}(t_{LD})/∥\dot{p}(t_{LD})∥, perpendicular to both \dot{p}(t_{LD}) and z_{b}(t_{LD}). The axial \dot{l}(t_{LD}) and angular \dot{ψ}(t_{LD}) speeds become the initial conditions of the robot in the SP.

### Stance Phase and Takeoff Transition

Unlike existing studies of the three-dimensional SLIP models [58], [63], the complexity of the stance dynamics of the Hopcopter is further reduced owing to the strategic design decision to substantially pre-stretch the elastomer. As detailed in Note S2, when the directions of \dot{p}(t_{LD}) and z_{b}(t_{LD}) are largely aligned, the centrifugal acceleration is negligible and the SP is governed by the axial and angular dynamics in the form of two semi-coupled differential equations:

$$m \frac{d}{dt} \dot{l} = - k ( l - {l}_{0} - {l}_{p} ) - sgn ( \dot{l} ) {f}_{c} , \qquad ( 6 )$$

$$m \frac{d}{dt} ( {l}^{2} \dot{ψ} ) = 0. \qquad ( 7 )$$

Given the initial conditions (∥\dot{p}(t_{LD})∥ and θ_{LD}), the axial dynamics is independent of ψ and dictated by the natural frequency Ω=\sqrt{k/m}. An analytical solution of l(t) and the takeoff timestamp t_{TO} corresponding to the moment when the elastic force vanishes (l(t_{TO})=l₀) are yielded as detailed in Note S3. With the expression of l(t), Equation (7) states that \dot{ω}(t)=l₀²\dot{Ψ}(t_{LD})/l²(t). The time integration Δψ=∫ₜ_{_{LD}}^{t}^{_{TO}}\dot{ψ}(t)dt provides the attitude of the robot at the takeoff as the rotation of z_{b} (t) about the axis e_{ψ} in stance phase (t_{SP}, from t_{LD} to t_{TO}, see FIG. 2B). Therefore, the change in the body attitude z_{b}(t), in terms of Δψ, in the entire SP is also fully determined from ∥\dot{p}(t_{LD})∥ and θ_{LD}. Reprojecting to the inertial frame, the takeoff attitude of the robot is given by

$$R ( {t}_{TO} ) = R ( {e}_{ψ} , Δψ ) R ( {t}_{LD} ) , \qquad ( 8 )$$

where R(e_{ψ}, Δψ) is a rotation matrix based on the axis-angle representation. Letting z_{b}(t_{TO})=R(t_{TO})e₃ be the primary body axis at t_{TO}, the takeoff velocity \dot{p}(t_{TO}) is obtained by projecting the axial \dot{l}(t_{TO}) and tangential speeds l₀\dot{ψ}(t_{TO}) of the robot at t_{TO} to the inertial frame. This results in ∥\dot{p}(t_{TO})∥=\sqrt{l₀²\dot{ψ}²(t_{TO})+\dot{l}²(t_{TO})} with the direction specified by the angle between z_{b}(t_{TO}) and \dot{p}(t_{TO}), θ_{TO}=arctan (l₀\dot{ψ}(t_{TO})/\dot{l}(t_{TO})). In the vector form, this is given by

$$\begin{matrix}\dot{p} ( {t}_{TO} ) = \dot{l} ( {t}_{TO} ) {z}_{b} ( {t}_{TO} ) + {l}_{0} \dot{ψ} ( {t}_{TO} ) {e}_{ψ} \times {z}_{b} ( {t}_{TO} ) . & ( 9 ) \\ = ‖ \dot{p} ( {t}_{LD} ) ‖ R ( {e}_{ψ} , {θ}_{TO} ) {z}_{b} ( {t}_{TO} ) , & ( 10 )\end{matrix}$$

As illustrated in FIG. 2B, due to the conservative of angler momentum, vectors z_{b}(t_{LD}), \dot{p}(t_{LD}), z_{b}(t_{TO}) and \dot{p}(t_{TO}) are all coplanar and perpendicular to e_{ψ} and the takeoff velocity is directly influenced by the landing attitude. Therefore, the jumping trajectory can be controlled through the manipulation of Z_{b} (t_{LD}).

With the identified model coefficients Ω=\sqrt{k/m}, fₑ/m, and lₚ in Table S1) from the drop tests (see Materials and Methods section), the takeoff state of the robot specified by Δψ, θ_{TO} and ∥\dot{p}(t_{TO})∥ is predicted according to the landing state (θ_{LD} and ∥\dot{p}(t_{LD})∥) in FIG. 2C. The maps suggest that, for a given landing velocity \dot{p}(t_{LD}), the liftoff velocity \dot{p}(t_{TO}) can be directly manipulated through θ_{LD} in the form of the landing attitude z_{b} (t_{LD}).

This forms the basis of the model-based hopping controller.

### Model-Based Hopping Controller

Similar to other spring-mass monopeds, the passive jumping dynamics of the Hopcopter is unstable and lossy. Stabilizing the attitude of the robot in the aerial phase to guarantee an upright landing attitude is insufficient to prevent the horizontal speed from diverging after consecutive jumps [58], [63], [64]. Concomitantly, energy must be injected into the system to compensate for losses in both stance and aerial phases. However, unlike monopedal hoppers with direct leg actuation (e.g., linear hydraulic and hip actuators in [65] or a series-elastic actuator in [32]), the stance phase of the Hopcopter is completely passive. This unique hopping mechanism demands a dedicated control framework.

The proposed controller for the Hopcopter differs from widely employed policies [32]-[34], [64] based on Raibert's hopping machine [65] and other jumping controllers [34], [36], [38], [58], [63], [66]. The controller according to an embodiment allows the robot to take off in a desired direction in three dimensions. This capacity enables the robot to track trajectories while hopping and facilitates smooth transitions between aerial and terrestrial modes, enabling complex hybrid locomotion. For instance, during high-speed flight, the Hopcopter leverage the ground contact or environment to generate an instantaneous burst of acceleration and hop to decelerate, turn, or accelerate—significantly improving agility beyond flight alone.

The control strategy takes advantage of the derived model of the SP dynamics in order to (i) decrease the control effort and (ii) decouple the altitude control problem from the landing control problem as much as practically possible. As a result, the trajectory of the robot in the aerial phase is mostly ballistic and the landing position control is accomplished through the control of the landing attitude z_{b} (t_{LD}), in a similar manner to the control of the touchdown angle in [32]. This differs from an existing jumping quadrotor [43], in which the position control is directly implemented during the aerial phase using a flight controller designed for a small rotorcraft. The framework renders the hopping locomotion markedly more efficient than flying. Besides, since the elastic force present in the SP dominates the propelling thrust, the use of the ground reaction force through the elastic leg for position control results in superior jumping agility.

### Overview of the Hopping Control Strategy

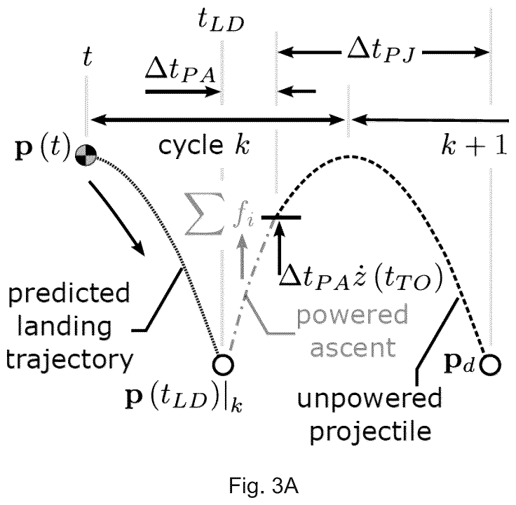

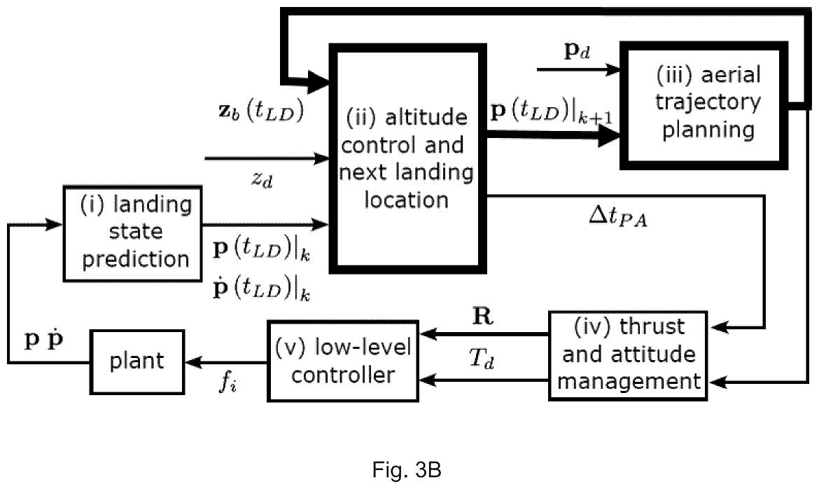

Since the hopping motion is cyclic and the aerial phase of the trajectory is primarily ballistic, the embodiments of the invention regulate the landing attitude of the current hopping cycle (indexed k) to yield the desired landing location in the subsequent hop (indexed k+1, as shown in FIG. 3A). The proposed method strategically decouples the attitude, altitude, and lateral dynamics of the robot by neglecting the aerodynamic drag and exploiting the ability of the robot to adeptly command its attitude in the aerial phase. The embodiments of the invention leverage the developed dynamic model to create a set of equations that predict the landing point at time step k+1 from the landing attitude at time step k and rely on these equations to numerically solve for the setpoint landing attitude that brings about the desired landing location at time step k+1. The structure of the controller may include five sub-modules, labeled (i) to (v), as outlined in FIG. 3B. Starting from the jumping cycle k, (i) predicts the landing location and velocity. This information, together with a pre-specified landing attitude and a hopping altitude setpoint, are employed to predict the takeoff state of cycle k in (ii). In (iii), a numerical optimizer relies on the output of (ii) to form an algebraic loop (bold in FIG. 3B) that determines the desired landing state of cycle k and the thrust requirement during the climb in cycle k to reach the hopping altitude setpoint and the next landing location in cycle k+1. Finally, (iv) is a thrust and attitude manager which converts the outcome from the solver in (iii) to command inputs for the low-level controller (v). The detailed implementations of the controller are as follows.

### Landing State Prediction

The high-level hopping controller loop is executed once per jump cycle. Starting from the apex of cycle k, the total thrust of the Hopcopter is nominally set to zero and the unpowered robot follows a ballistic trajectory as illustrated in FIG. 3A. From the current position p(t) and velocity \dot{p}(t) at timestamp t, the time to touchdown is determined from z=e₃^{T}p(t) and ż=e₃^{T}\dot{p}(t) as Δt_{LD} t_{LD}−t=ż(t)/2+{square root over (2(z(t)−l₀)/g+ż²(t)/g²)}. The landing location and velocity are

$${p ( {t}_{LD} ) \vert}_{k} = p ( t ) + \dot{p} ( t ) Δ {t}_{LD} - {e}_{3} \frac{1}{2} g Δ {t}_{LD}^{2} , \qquad ( 11 )$$

$${\dot{p} ( {t}_{LD} ) \vert}_{k} = \dot{p} ( t ) - {e}_{3} g Δ {t}_{LD} . \qquad ( 12 )$$

During the descent, the attitude of the robot is controlled with the collective thrust and angular velocity minimized, allowing the motion to be treated as free fall from an altitude of z(t)−l₀.

### Altitude Control and Next Landing Location

Based on the landing setpoint attitude z_{b}(t_{LD})=R(t_{LD})e₃ and the computed landing velocity \dot{p}(t_{LD}), the stance phase dynamics (Equation 6 and Equation 7) is integrated forward to produce the liftoff state R(t_{TO}) and \dot{p}(t_{TO}) using Equation 8 and Equation 9 with θ(t_{LD})=arccos(−z_{b}^{T}(t_{LD})\dot{p}(t_{LD})/|\dot{p}(t_{LD})|). Immediately after taking off (detected by a significant change in the axial acceleration), the low-level controller (v) (described in Materials and Methods) swiftly re-orients the robot to an upright orientation (z_{b}=e₃) to minimize the horizontal thrust. Thus, the landing position of cycle k+1 is entirely determined by the lateral component of the liftoff velocity ([e₁, e₂]^{T}\dot{p}(t_{TO})|ₖ) and the time the robot spends in the aerial phase. This flight time is varied according to the setpoint altitude as the aerial maneuver is divided into a powered ascent (PA) and an unpowered projectile (PJ) (FIG. 3A). It is ensured that the hopping altitude setpoint z_{d} is reached by briefly producing vertical thrust of magnitude Σfᵢ=mg for

$$Δ {t}_{PA} = \{ \begin{matrix}( {z}_{d} ) / \dot{z} ( {t}_{TO} ) - \dot{z} ( {t}_{TO} ) / 2 g & for \dot{z} ( {t}_{TO} ) < 2 {gz}_{d} \\ 0 & otherwise\end{matrix} , \qquad ( 13 )$$

where ż(t_{TO})=e₃^{T}\dot{p}(t_{TO}) is the vertical liftoff speed and z_{d} denotes the relative hopping altitude. The former case is when the vertical liftoff speed is insufficient for the robot to passively reach the setpoint and the latter is when the jump height without any thrust assistance is already over z_{d}. During the powered flight phase, the propelling thrust counterbalances the weight and the vehicle retains its upward speed of ż(t_{TO}). The rest of the trajectory is a projectile with duration of

$$Δ {t}_{PJ} = \dot{z} ( {t}_{TO} ) / g + \sqrt{2 {z}_{d} / g} , \qquad ( 14 )$$

in which the first term refers to the rest of the time the robot spends ascending and the latter is free fall. Finally, the landing position for cycle k+1 is iteratively updated as

$${{{p ( {t}_{LD} ) \vert}_{k + 1} = p ( {t}_{LD} ) \vert}_{k} + {[ \begin{matrix}{e}_{1} & {e}_{2}\end{matrix} ]}^{T} \dot{p} ( {t}_{TO} ) \vert}_{k} ( Δ {t}_{PA} + Δ {t}_{PJ} ) . \qquad ( 15 )$$

The outcomes of Equations 11-15 verify that the touchdown location of the next cycle (k+1) is predominantly determined by the landing attitude z_{b} (t_{LD}) of the current cycle.

### Landing Attitude Computation and Aerial Trajectory Planning

From the estimated current landing position p(t_{LD})|ₖ provided by Equation 11, the controller employs Equation 15 to iteratively search for the touchdown attitude that minimizes the predicted position error of the next landing,

$${{{z}_{b} ( {t}_{LD} ) \vert}_{k} = arg {min}_{{{z}_{b} ( {t}_{LD} ) \vert}_{k}} ‖ {p}_{d} - p ( {t}_{LD} ) \vert}_{k + 1} ‖ , \qquad ( 16 )$$

under the no-slip condition as constrained by the ground friction coefficient μ (Note S4)

$${{arc cos ( {e}_{3} \cdot {z}_{b} ( {t}_{LD} ) ) \vert}_{k} , arc cos ( {e}_{3} \cdot {z}_{b} ( {t}_{TO} ) ) \vert}_{k} < {tan}^{- 1} μ . \qquad ( 17 )$$

Depending on the setpoint of p_{d} and the current state of the robot, the error can be marginalized to zero or a particular value, which indicates whether the robot is able to reach the desired location in a single or multiple steps.

### Thrust and Attitude Manager

After the landing attitude z_{b} (t_{LD}) is determined from Equation 16, it is realized in when the robot is falling by the low-level controller (v). To regulate the jumping altitude, after the liftoff, the robot is quickly reoriented to an upright direction and the collective thrust magnitude is maintained at Σfᵢ=mg for Δt_{PA} as described by Equation 13. The action injects energy into the system to compensate for any losses. Thereafter, the robot remains upright until the landing location is again predicted by (i) for the next jump cycle.

### Planning Strategy for Trajectory Tracking

Unlike flying robots, which are able to stabilize any control errors continuously, the cyclic nature of the hopping motion only allows the corrective measure to be executed once per cycle. The action to alter the landing attitude when the robot is falling only affects the landing location in the next cycle. Therefore, to track a predefined trajectory, the desired landing location p_{d} in Equation 16 is chosen to be the desired location of the robot at t_{LD}|ₖ₊₁, under the assumption that t_{LD}|ₖ₊₁−t=Δt_{LD}+2\sqrt{2z_{d}/g}. This consideration eliminates the inherent latency, allowing the robot to track a time-varying trajectory more precisely. Still, the complexity of achievable trajectories is intrinsically limited by the hopping frequency.

### Hopping Tests and Model Verification

To validate the identified parameters and the derived dynamic model, a preliminary controlled hopping experiment with the developed controller is performed. As detailed in Materials and Methods, the landing states (∥\dot{p}(t_{LD})∥ and θ_{LD}) of 130 consecutive jumps were recorded. The experiment employs the devised model to predict the takeoff states in terms of the body rotation Δψ and takeoff angle θ_{TO} and compares the predictions with the measurements as presented in FIG. 2C (∥\dot{p}(t_{TO})∥ cannot be accurately measured due to the existence of the powered climbing). The measurements are highly aligned with the predictions, with the root mean square errors (RMSEs) of only 1.0 and 1.6° for Δψ and θ_{TO}. The consistency between the model predictions and measurements validates that the derived equations and associated assumptions are suitable for capturing the stance dynamics of the Hopcopter.

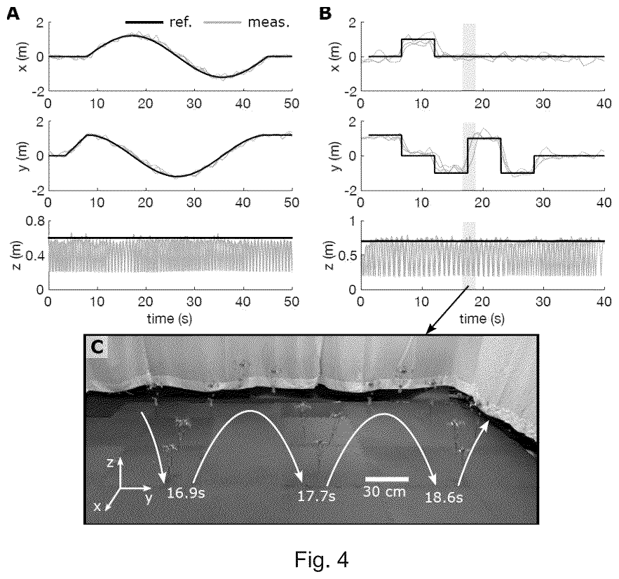

Next, the tracking performance was evaluated using circular and step trajectories. For the circular trajectory, the robot was instructed to hop at a constant altitude (0.60 m) around a circle with a radius of 1.20 m at an average speed of 0.2 ms⁻¹. The step trajectory demands the robot to maintain a jump height of 0.75 m and laterally translate by up to 2 m several times in 40 s. Three repeated trials were conducted for each trajectory. The resultant trajectories are shown in FIG. 4, in A and B, which show trajectory tracking experiments under the hopping mode (FIG. 4, in A, shows reference and realized circular trajectories, and FIG. 4, in B, shows reference and realized step trajectories). The tracking performance is determined by calculating the root mean square errors (RMSEs) of three repeated tests: the RMSE of the landing position is 16 cm for the circular trajectory and 49 cm for the step trajectory. For the jump height, the RMSEs are 4.1 cm and 4.8 cm, respectively. FIG. 4, in B, suggests that the amplified error of the step trajectory is due to the inability to respond promptly to significant alterations in the desired trajectory. These results demonstrate that the proposed controller can achieve accurate trajectory tracking with low altitude error and moderate landing error, even with large displacements between steps and the absence of control authority during the aerial phase.

### Hopping Agility

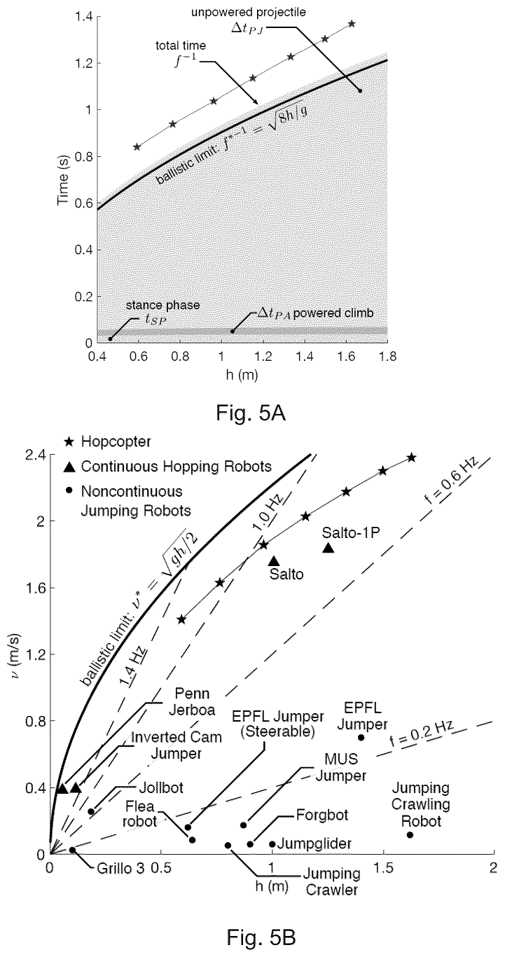

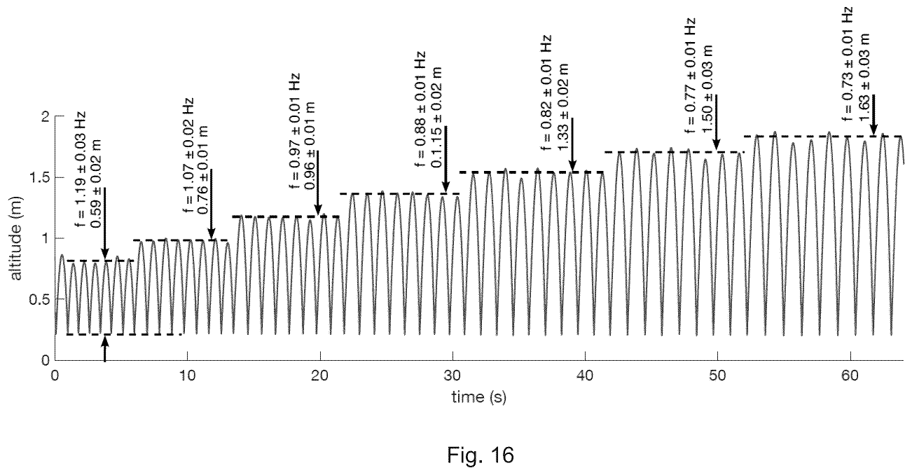

Next, an experiment is conducted to investigate the relationship between the hopping height and frequency of the robot, and to calculate its hopping agility, defined as the cycle-averaged vertical speed of the robot v=2hf (The definition of hopping agility presented here deviates from that of vertical jumping agility as defined in (31). The latter refers to the vertical climbing speed). The robot is commanded to hop in place for over 60 s using the developed position controller. The test is divided into seven segments, each corresponding to a different hopping height ranging from 0.59 m to 1.63 m. In each segment, the robot hopped at a constant height for at least six cycles (FIG. 16). Then the time period of one hopping cycle for each segment system is measured and is plotted against the corresponding height (see FIG. 5A). It includes the period predicted by the model, which can be broken down into the time the robot spends in the stance phase (t_{SP}=t_{TO}−t_{LD} in Equation S12 in Note S3), powered climbing phase (Δt_{PA} in Equation 13), and the ballistic phase (Δtₚⱼ in Equation 14). Additionally, the ballistic limit f*⁻¹=\sqrt{8h/g} [31] is identified, which occurs when the robot spends negligible time in the stance phase and the entire flight phase is ballistic.

As seen in FIG. 5A, the measured periods are approximately 100 ms longer than the model prediction. This discrepancy is mainly attributed to the fact that the model neglects the thrust generated for the attitude control effort when the robot is descending, which prolongs the falling time. The model prediction is 40 ms longer than the ballistic limit, which corresponds to the time the robot spends in the stance phase. Therefore, one can infer that these two factors collectively lengthen the robot's hopping period compared to the theoretical limit.

The hopping agility is computed as the product of the height and frequency. Due to the short stance time (<45 ms), the Hopcopter achieved a hopping agility of 2.38 m/s when h=1.63 m, which is 30% higher than 1.83 m/s for 1.25 m attained by Salto-1P (with a stance time over 120 ms) [31], [32] and other jumping robots (FIG. 5B and Table S2). All in all, the Hopcopter exploits the natural dynamics of a springy telescopic leg with high stiffness to minimize the ground contact time (see Note S3), which enables high agility due to the reduced stance time during hopping.

### Synergistic Hybrid Locomotion for Agile Maneuvers

Strategically combining hopping and flying can uniquely enhance maneuverability and agility, as the hopping mode can generate bursts of acceleration for flight. By momentarily switching to hopping mode during flight for a single jump, the monopedal robot can generate an instantaneously large acceleration from the ground normal. Using the developed hopping model, the takeoff direction is regulated through the landing attitude. This operation assists the robot in decelerating, accelerating from hover, or turning tightly, providing enhanced agility despite the limited thrust-to-weight ratio (for example 1.2).

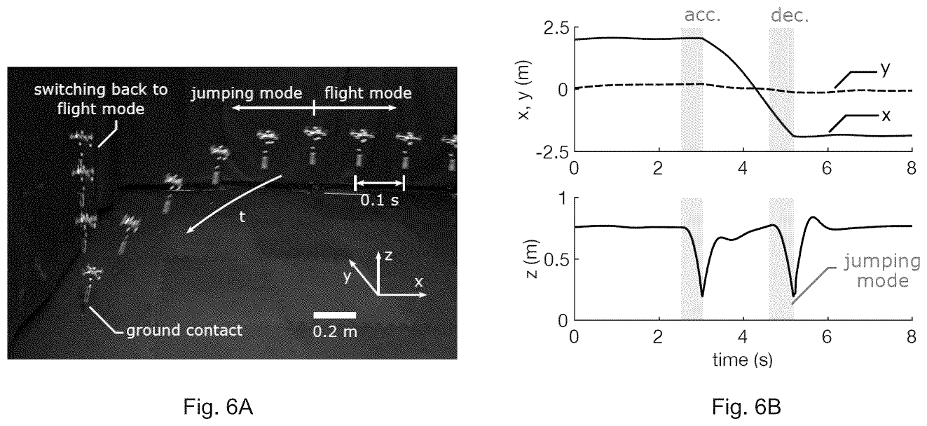

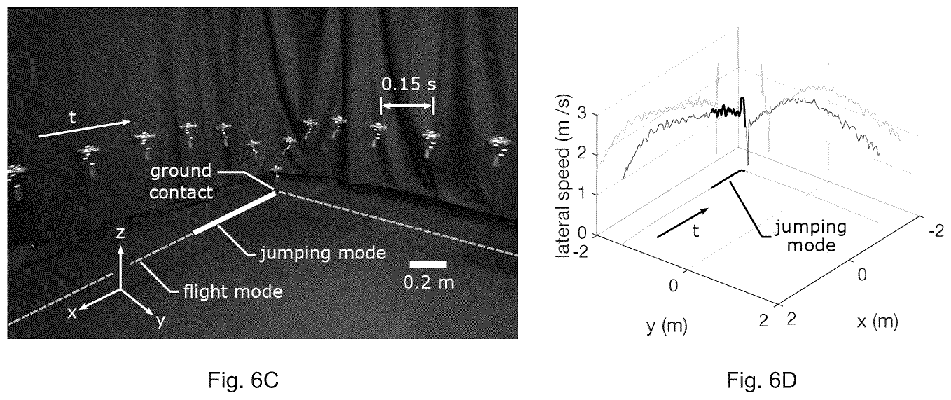

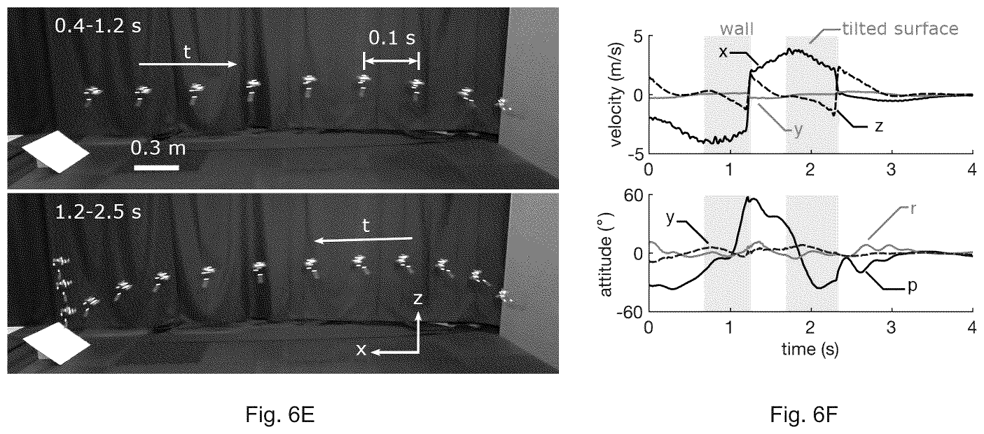

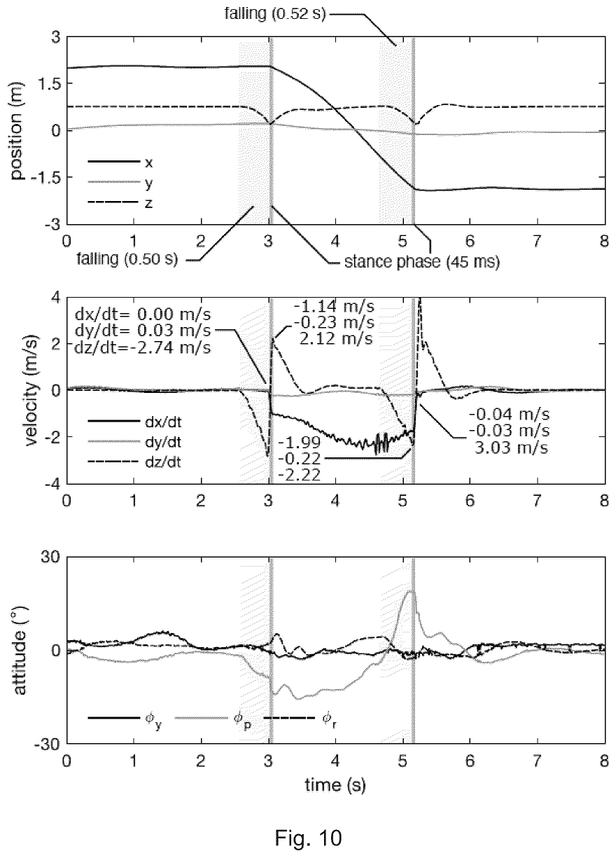

The first maneuver demonstrates the use of elastic leg and ground normal to accelerate and then decelerate the robot in flight. As shown in FIG. 6A and FIG. 6B, the robot is initially commanded to hover. To accelerate forward, the hopping mode is activated and the robot enters a free fall (marked in gray regions in FIG. 6B). Once landed at a pitch angle of 14°, the passive stance dynamics induces an impulsive takeoff with the forward speed of 1.14 ms⁻¹ with less than 45 ms spent in the SP, producing the lateral SP acceleration of 26.0 ms⁻² (the landing and takeoff velocities and SP acceleration are computed as detailed in Note S5). Including the fall period (0.50 s as marked by shadings in FIG. 6B and FIG. 10), the average lateral acceleration is 2.2 ms⁻². After the liftoff, the robot continues its flight and reaches the forward speed of over 1.99 ms⁻¹ before executing the second jump to land at a pitch angle of 19° and deftly decelerate to lateral speed of 0.05 ms⁻¹. The sudden stop results in a lateral SP deceleration of 43.5 ms⁻² and an average deceleration of 3.3 ms⁻² (including the falling period of 0.52 s as marked in FIGS. 6A-6F and 10).

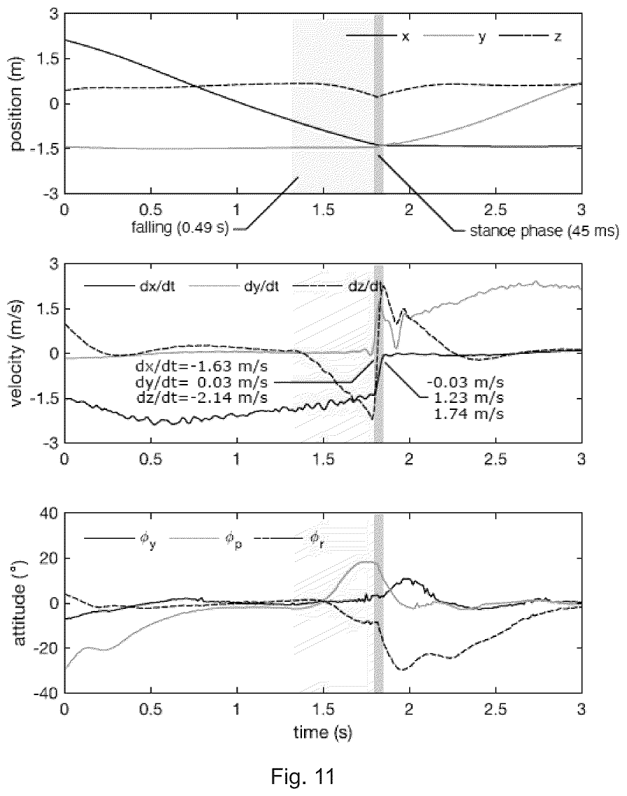

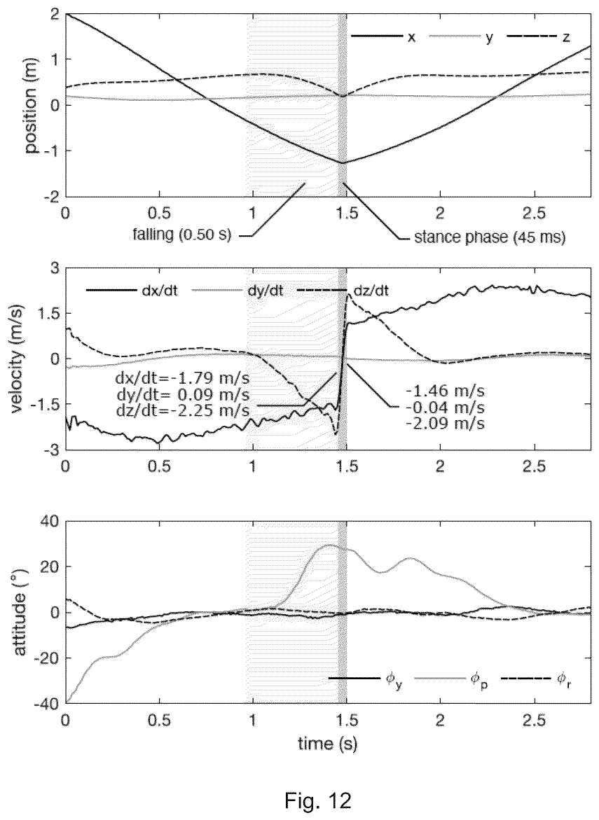

Next, the agility is illustrated through rapid and tight turns. The robot leverages the ground to swiftly change the travel direction by 90° as depicted in FIGS. 6C and 6D. Beginning with the flight speed of 1.9 ms⁻¹, the leg-assisted right turn alters the flight course in the space of 0.54 s (from falling to completion of the SP). The robot lands with the lateral speed of 1.63 ms⁻¹ and results in the post jump speed of over 1.23 ms⁻¹ as shown in FIG. 11. This equates to the lateral SP acceleration of 44.4 ms⁻² (in 45 ms) and average acceleration of 4.2 ms⁻². The large SP acceleration results in a sharp right-angle trajectory instead of a curve as visible in FIG. 6C. An even higher acceleration is achieved when the hybrid locomotion is implemented for suddenly reversing the flight direction (FIG. 12). The jump with a pitch angle of 28° at landing entirely turned the flight around in 0.55 s (from falling to completion of the SP), from the lateral landing velocity of 1.79 ms⁻¹ to the post jump speed of 1.46 ms⁻¹ in the opposite direction, equating to a lateral SP acceleration of 72.3 ms⁻² (in 45 ms) and an average lateral acceleration of 6.9 ms⁻².

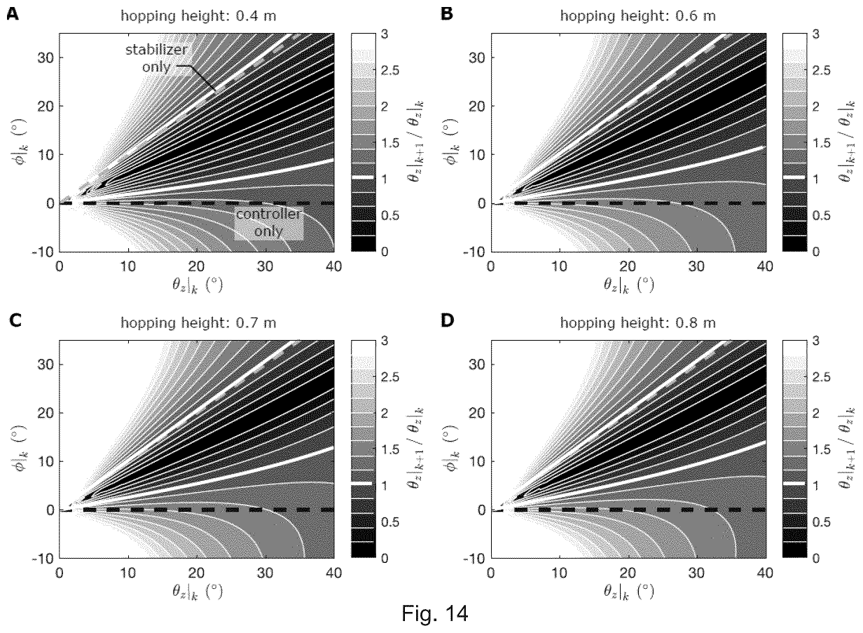

To further push the agility limit, hybrid jumps on a wall and a tilted surface are realized. Non-horizontal surfaces extend the range of non-slip landing and takeoff angles (Note S4). This effectively raises the achievable lateral acceleration. In the experiment, the robot flies toward a wall at a speed over 4 ms⁻¹. Within 0.54 s or 1.8 m prior to reaching the surface, the attitude controller reorients the robot for landing and the robot touches down on the wall with the tilt (pitch) angle of 570 and landing speed of 3.6 ms⁻¹ (FIGS. 6E and 6F and FIG. 14). The wall jump reverses the lateral speed of the robot to 2.68 ms⁻¹ within 45 ms. Immediately after the bounce, the robot spends 0.43 s accelerating toward another inclined surface (30°) and executes a second jump in 0.63 s (from falling to completion of the SP) to decelerate the flight from 3.9 ms⁻¹ to end the maneuver with a hover. The average lateral accelerations in these two periods are 11.4 and 5.7 ms⁻², whereas the lateral SP accelerations reach 139.8 and 66.6 ms⁻².

The results demonstrate that the jump-flying locomotion enables average and instantaneous lateral accelerations that are remarkable compared to its thrust-to-weight ratio of only 1.2. The Hopcopter can accomplish instantaneous and average accelerations of over 14 g and 1.2 g by using the ground normal and the elastic leg in intermittent jumps. This is notably higher than the reported accelerations of other micro aerial robots with similar or higher thrust-to-weight ratios [56], [57], [67]. The hybrid locomotion is especially advantageous for robots with limited thrust power, such as small and lightweight platforms, as it allows them to perform rapid and tight maneuvers that would otherwise be impossible.

### Self-Stabilized Hopping Via Active Aerodynamic Stabilizer

According to the proposed hopping dynamic model, in hopping, the takeoff velocity of the robot is directly dependent on landing attitude and landing velocity. This implies that to stabilize the robot, a velocity measurement as feedback is necessary. To reduce the robot's dependence on sensors and external measurements, an actuated aerodynamic stabilizer is proposed to interact with the airflow to stabilize the robot. The strategy to enable the robot to hop in place without position or velocity feedback involves the adjustment of the landing angle θ_{LD} based on the robot's velocity \dot{p} in the falling phase. This is by appropriately balancing the attitude controller with the rotational torque created by the stabilizer.

### Aerodynamic Stabilizer

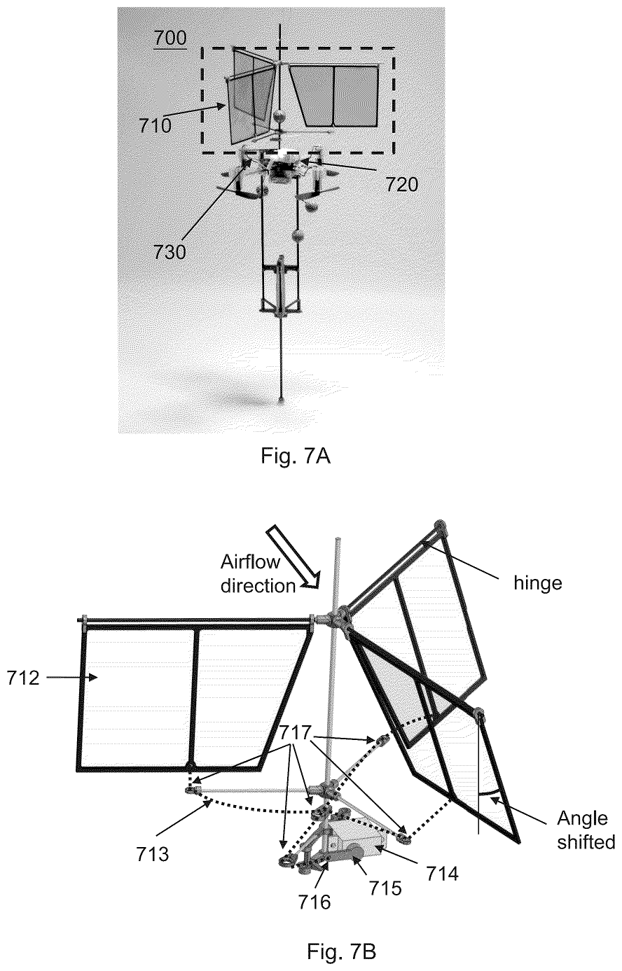

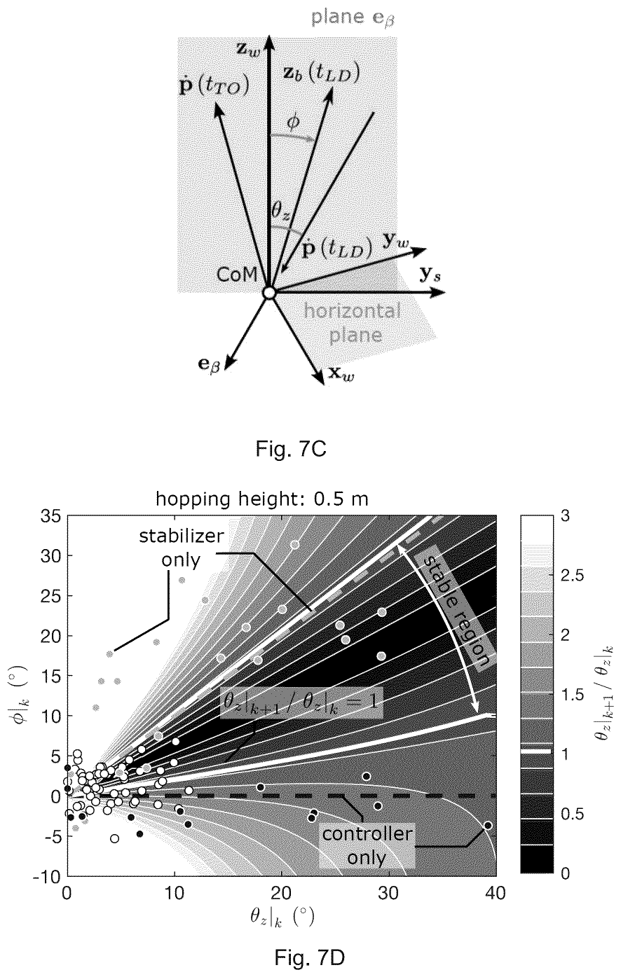

FIGS. 7A-7D shows example detachable active aerodynamic stabilizers and Poincaré maps. FIG. 7A illustrates a robot 700 equipped with an example aerodynamics stabilizer 710 according to an embodiment. FIG. 7B is an enlarged diagram of part C in FIG. 7A to show details of the stabilizer 710. FIG. 7C is a diagram displaying the relationships between landing velocity, landing attitude and takeoff velocity. FIG. 7D shows Poincaré maps depicting the evolution of the landing velocity angle θ_{z} in terms of θ_{z}|ₖ₊₁/θ_{z}|ₖ, as a function of θ_{z}|ₖ and ϕ|ₖ. Circular dots represent the recorded landing state in the hopping stability test. Black, gray and white colors represent the measurements when only the attitude controller, aerodynamic stabilizers, or both mechanisms were active. As shown in FIG. 7A and FIG. 7B, the detachable aerodynamic stabilizer 710 for the Hopcopter comprises three horizontally hinged surfaces 712 and weighs 4.9 grams. Three cables 713 (dashed lines) are mounted between the bottom of the three surfaces 712 and the end of a crank (i.e., a cable mount 716) on a drive unit, for example, a servomotor 714 (H-King 282AS). The three cables 713 are installed to pass through the five cable guides 717 (each cable passes through three cable guides 717). These surfaces 712 can be made rigid by pulling on cables 713 by the drive unit, or allowed to swing freely in response to airflow when the cables 713 are loosened. Tightening the cables 713 makes the bottom of surfaces 712 tightly close to the three cable guides 717 and activates the stabilizer 710, enabling them to bear aerodynamic load and generate torque to steer the robot's attitude based on airflow. Conversely, loosening the cables 713 deactivates the stabilizer 710, allowing the three surfaces 712 to rotate freely around the hinges, avoiding the generation of aerodynamic force and torque.

### Damper-Mediated Stability

The stabilizers are activated only during the descent while hopping. They use the upward airflow to create a torque that rotates the robot's attitude and reduces the landing angle θ_{TD} by making its major axis parallel and opposite to its translational velocity: z_{b}→−\dot{p}. In the meantime, the attitude controller applies a propelling torque to make the robot upright z_{b}→z_{w}=e₃. As a consequence of the competing efforts, the robot lands with its major axis z_{b} pointing between the vertical axis and the velocity vector −\dot{p}(t_{LD}) (see FIG. 7C). By tuning the control gains and the stabilizer configuration, the hopping dynamics can be stabilized without velocity measurements. That is, the Hopcopter gains the ability to operate in real-world environments using only the feedback from its onboard inertial sensor.

To manifest the damper-assisted stability, Poincaré maps are numerically constructed assuming a constant hopping height of 0.5 m. The landing state is chosen as the fixed point of the limit cycle. Under the influence of the attitude controller and the aerodynamic stabilizer, the vectors z_{w}, z_{b}, and \dot{p}(t_{LD}) are coplanar. The angle between the landing velocity and the vertical, θ_{z}=arccos(−z_{w}^{T}\dot{p}(t_{LD})/∥\dot{p}(t_{LD})∥) (see FIG. 7C), represents the horizontal speed that should approach zero over repeated hops in the case of stable hopping. In addition to θ_{z}, the landing attitude ϕ, defined as the signed angle between the robot's primary axis z_{b} and the vertical at landing (positive when arccos(−z_{b}^{T}\dot{p}(t_{LD})/∥\dot{p}(t_{LD})∥<θ_{z} as seen in FIG. 7C and negative when arccos(−z_{b}^{T}\dot{p}(t_{LD})/∥\dot{p}(t_{LD})∥>θ_{z}), affects the takeoff state and subsequent landing state. The model of the stance dynamics is leveraged to predict the next landing state for any combination of θ_{z} and ϕ as described in Materials and Methods.

The Poincaré maps plot θ_{z}|ₖ₊₁/θ_{z}|ₖ for different θ_{z}|ₖ and ϕ|ₖ at a particular hopping height, where k represents the hopping cycle (FIG. 7D and FIG. 14). The maps reveal the stable regions (θ_{z}|ₖ₊₁/θ_{z}|ₖ<1), establishing the conditions for converging hopping speed. Notably, the red dashed line in the Poincaré maps corresponds to ϕ|ₖ=0, representing the scenario in which the attitude controller dominates and the robot consistently lands with an upright orientation. On the other hand, the dashed line indicated by “stabilizer only” depicts cases where the stabilizer dominates, aligning the landing velocity and attitude (θ_{z}|ₖ=ϕ|ₖ). These dashed lines lie near the boundaries of the stable region, indicating that reliance on either strategy alone would not result in stability with sufficient robustness. However, the Poincaré maps exhibit a significant overlap between the stable region and the area between the dashed lines. By tuning the control gains and stabilizer configuration, the interplay between the controller and the mechanism stabilizes the hopping speed and attitude over repeated jumps without velocity measurements.

### Hopping Stability Test

To substantiate the insights from the Poincaré analysis, three sets of experiments are conducted to evaluate the performance of the hopping robot under each control strategy (attitude control and aerodynamic stabilizer) individually, as well as their combination. For each set of experiments, the robot starts to hop after a drop from about 75 cm. The hopping trajectory is tracked to determine the robot's attitude and velocity in the landing phase.

When utilizing only the attitude controller (dashed line indicated by “controller only”), the robot is expected to land consistently in an upright orientation or 0=0, but without any guarantee on the horizontal hopping speed or θ_{z}. Experimental results confirm this (FIG. 7D), showing that the robot could hop for 3-5 cycles before the horizontal speed diverges as θ_{z}|ₖ₊₁/θ_{z}|ₖ>1.

Relying solely on the stabilizer (the attitude controller was only active in the CP, i.e., when the robot is ascending) is predicted to marginalize the difference between θ_{z} and ϕ, but not directly reducing θ_{z}. Again, experiments validate this (FIG. 7D). Some discrepancies between the model prediction (θ_{z}=0) and the results reflect a limited effectiveness of the aerodynamic stabilizer, which is dependent on the size and time the robot spent descending. Overall, the robot displays poor stability and crashes after 6-10 hopping cycles.

In contrast, experiments integrating both the attitude controller and stabilizer yield highly robust hopping as theorized. The robot retains near zero horizontal velocity component and near upright attitude across multiple successive jumps (white dots in FIG. 7D), achieving over 56 hops in 45 s within a 3×3-m arena in the absence of position and velocity feedback.

### Field Hopping Demonstration

To further demonstrate the robustness and reliability of the stabilizing strategy, three field tests are conducted in varying environments, including stairs, a corridor, and outdoor terrain. In each test, a human operator commands the desired landing attitude for the controller, though the actual landing posture depends on both the attitude setpoint and aerodynamic stabilizer as previously described. The adjusted desired landing attitude results in a bias that directs the robot to hop toward the prescribed direction. This control scheme allows the Hopcopter to ascend/descend a flight of stairs, navigate the narrow corridor space, and traverse rough terrain. Through these field experiments, it is verified that the active stabilizer enables stable and resilient mobility without requiring vision or additional sensors for velocity feedback.

As described, the embodiments of the invention provide a hybrid hopping and flying robot (Hopcopter) that combines hopping and flying capabilities to achieve high-performance locomotion. Its passive telescopic leg distinguishes it from existing bio-inspired jumping robots that rely on latched or unlatched elastic actuation as it dispenses the need for a trigger, actuation in stance, or variable mechanical advantage, making it mechanically simpler and more reliable. The thrust-based actuation of the passive telescopic leg allows fine-tuning of jump height and enables the Hopcopter's exceptional hopping agility, surpassing the state-of-the-art jumping robots. The short stance phase enabled by the absence of actuation in the stance phase permits higher hopping frequencies, resulting in its high agility. The robot achieves a maximum velocity of 2.38 m/s at a jump height of 1.63 m, exceeding the highest agility reported in jumping robots (FIG. 5B and Table S2), including Salto-1P [31], [32], [68]. The use of thrust permits fine tuning of jump height. The Hopcopter demonstrates jumps from 0.6 to 1.6 m in experiments, showcasing its wide jump height range.

The Hopcopter's ability to both fly and hop facilitates rapid changes in flight speed and direction. The robot's jumping ability can be leveraged to mitigate damage from collisions with walls or ground by employing jumping maneuvers. The integration of attitude control and aerodynamic stabilizers establishes the robot's hopping control autonomy. Poincaré analysis and experiments show that the attitude controller and aerodynamic stabilizers work together synergistically to stabilize the Hopcopter's hopping dynamics. Without external feedback, the robot achieves over 56 consecutive jumps with near-zero velocity and upright landing-demonstrating the value of integrating attitude control and aerodynamic surfaces.

Crucially, the passive leg design of Hopcopter could be readily applied to conventional rotorcraft. With simple addition of an elastic leg and control changes, a standard quadcopter could transform into a hopping robot, unlocking new performance frontiers through hybrid locomotion. Overall, the Hopcopter represents an improved platform that transcends the limitations of aerial or terrestrial locomotion alone, demonstrating the potential of integrating flight and hopping capabilities.

### Endurance and Power Efficiency

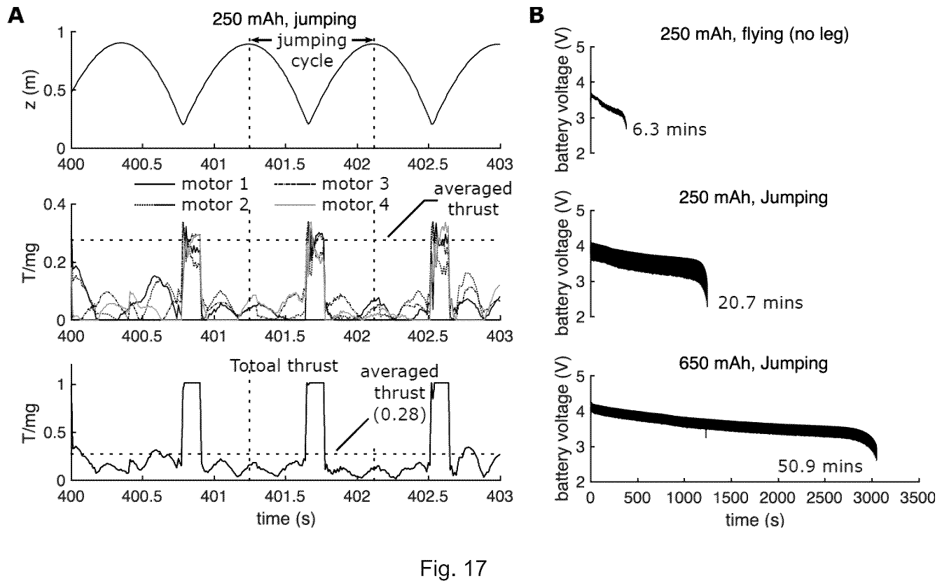

Unlike the aerial mode, the Hopcopter generates thrust intermittently rather than continuously during the hopping mode. This mode of operation presents an opportunity to substantially extend Hopcopter's operation time while reducing power consumption. To evaluate the endurance, a continuous jumping test is conducted with a fully charged 250-mAh single-cell Li-Ion battery (8.3 g). The robot hops continuously for over 1246 s (20.8 minutes). With a 650-mAh Li-Ion battery (16.8 g), the endurance increases to over 3052 s (50.9 minutes). However, the total mass of the robot (43.1 g) with a high-capacity battery exceeds the maximum takeoff weight for flight (42.0 g). Battery voltages recorded onboard during the tests are shown in FIG. 17B. Notably, the proposed terrestrial locomotion approach shows a four to eight-fold increase in endurance in comparison to the benchmark quadcopter (Crazyflie 2.1 with retroreflective markers but without the leg, 32.1 g) which only hovers for 379 s with a 250-mAh battery.

The lack on a reliable onboard current sensor and the weight limitation render direct measurement of the robot's operational power consumption impractical. Nevertheless, the duty cycle of the motors is used as a metric to compare the flight and terrestrial operations.

This is because the robot is required to constantly generate T≈mg when hovering, whereas it only generates T=mg momentarily after takeoff while hopping. Defining the vehicle-based duty ratio D=(1/T)∫_{T}Σ(fᵢ/mg)dt, D=1 is obtained for the benchmark quadcopter flight. In endurance testing, the Hopcopter spends over 85% of time in ballistic and stance phases with minimal thrust for attitude control (Σfᵢ<0.11 mg outside the powered phases, see FIG. 17A). For these reasons, the overall duty ratio across 1246 s was only 0.28, representing over three-fold improvement in efficiency and endurance. In comparison, the hybrid quadcopter robots, PogoDrone [43] and LEO [53] saves only 20% and 44% power respectively via jumping and walking locomotion compared to flying, with a duty ratio exceeding 0.5.

### Materials and Methods

### Experimental Setup and Measurements

The experiments are carried out in a 3×3×2.5-m³ arena with ten motion capture cameras (for example, OptiTrack Prime 13w). The pose measurements are used for both control and ground truth measurements. The high-level controllers, including the hopping and flight controllers, are implemented by Python on the ground computer and executed at 100 Hz. The custom attitude controller is implemented onboard and operated at 1 kHz. The robot and the ground station are communicated through a radio module (for example, Bitcraze Carzyradio PA) via Crazyflie Python API.

### Drop Tests for Parameter Identification.

As the stance phase dynamics captured by Equations 6 and 7 are subject to a few unknown lumped physical parameters, namely Ω=\sqrt{k/m}, f_{c}/m, and lₚ (l₀=22 cm is a design parameter), a drop test is devised to identify these model parameters according to the axial dynamics of the robot (Equation 6) prior to applying the equations to for predicting and controlling the hopping motion.

The setup of the drop tests is schematically presented in FIG. 8A. A robotic gripper can be provided (or fabricated) to hold the robot via a cable and release when triggered. The end of the cable is tied through the CoM of the vehicle to ensure the robot is in an upright orientation. A high-speed camera (for example, MotionBLITZ EoSens mini 2) captures the trajectory of the robot at 1,000 frames per second, covering the landing site.

Both the gripper and the camera can be controlled by the same computer. The system is schematically illustrated in FIG. 8A. Using the Kanade-Lucas-Tomasi tracker [69], feature points are identified and traced on the robot between frames. Two-dimensional trajectories are reconstructed by calculating the geometric center of the tracked feature points.

The tests are carried out at three drop heights: 0.68, 0.82 and 0.95 m, with four drops at each height. The altitude of the robot in the free-drop experiments is indicated with twelve reconstructed trajectories as plotted in FIG. 8B. The robot spends 32.0±0.7 ms, 32.5±0.5, and 33.0±0.7 ms in the stance phase for the drop heights of 0.68, 0.82 and 0.95 m. The leg contraction l₀−l(t) is calculated from the data to plot the contraction against the acceleration in FIG. 8C. The outcome suggests two linear trend lines with the same gradient with a vertical offset. The lower and upper lines correspond to the leg compression and retraction, respectively. The evident and uniform gap between downstroke and upstroke (dark and light) accelerations reflects the energy loss or hysteresis in the form of coulomb friction. This leads to the proposed elastic force model in Equation 4. The least squares method is applied to estimate the model parameters. The best fitted linear model (solid lines in FIG. 8C) produces k/m=5.00×10³ s⁻², fₕ/m=12.7 m/s², and l_{P}=1.97 cm.

The identified parameters, listed in Table S1, corroborate that the weight of the robot is negligible compared to the force of the pre-stretched elastomer as klₚ/mg≈10.

### Low-Level Control for Flight, Hopping, and Hybrid Maneuvers.

The same set of equations are applied to determine the rotor commands for flight and when the attitude of the robot during the aerial hopping phase is regulated. To achieve the designated attitude, a proportional-integral-derivative controller [55] is first implemented to compute the required body-centric torque τ_{p,d}.

Depending on the operational demand, the target thrust magnitude T_{d} can be zero, mg, or a particular value. To evaluate the force allocation between four rotors, f=[f₁, f₂, f₃, f₄]^{T} and a 4×4 configuration matrix A are defined for power distribution

$${[ \begin{matrix}{τ}_{p} & T\end{matrix} ]}^{T} = Af . \qquad ( 18 )$$

To ensure that fᵢ≥0 even when T_{d}=0, the following attitude-priority allocation (similar to [57]) is employed to compute f.

$$f = {arg min}_{f} \vert {T}_{d} - T \vert \\ subject to {f}_{i} \geq 0 and {τ}_{p , d} = {τ}_{p} , \qquad ( 19 )$$

Despite that the collective thrust generation may not be correctly set to T_{d}, this assures the torque is correctly generated (τ_{p,d}=τₚ) and minimizes the error of thrust (T−T_{d}) when the desired thrust and torque may cause saturation of motors, especially for the unpowered projectile where T_{d} is set to zero.

### Model Verification.

The robot is commanded to hop at varying altitude setpoints in the range of 0.5 to 0.7 m and translate laterally in the range of 0 to 1 m per step for over 90 s. The trajectory is recorded. The data are processed to obtain the landing states and takeoff states. The landing and takeoff timestamps are identified from the CoM location. The transition velocities (\dot{p}(t_{LD}), \dot{p}(t_{TO})) and attitude states (z_{b}(t_{LD}), z_{b}(t_{TO})) with respect to the inertial frame are deduced. Since, in practice, these four vectors may not be perfectly coplanar as modeled in FIG. 2A, the rotational axis e_{ψ} is computed as a unit normal vector of the best-fitted plane:

$${e}_{ψ} = {arg min}_{n} \frac{1}{2} ( {( {n}^{T} \dot{p} ( {t}_{LD} ) / ‖ \dot{p} ( {t}_{LD} ) ‖ )}^{2} + \qquad ( 20 )$$

$${{( {n}^{T} \dot{p} ( {t}_{TO} ) / ‖ \dot{p} ( {t}_{TO} ) ‖ )}^{2} + {( {n}^{T} {z}_{b} ( {t}_{LD} ) )}^{2} + {( {n}^{T} {z}_{b} ( {t}_{TO} ) )}^{2} )}^{\frac{1}{2}} .$$

The averaged value of the objective function in Equation 20 is 0.8°, indicating minimal misalignment. After the reprojection on to the rotational plane normal to e_{ψ}, the angles θ_{LD}, Δψ and θ_{TO} for each jump are obtained. From the data of 130 jumps in 90 s, a wide region of the landing state (1.5<∥\dot{p}(t_{LD})∥<3.3 ms⁻¹ and 0°<θ_{LD}<20°) is covered.

### Poincaré Maps for Hopping Stability Analysis.

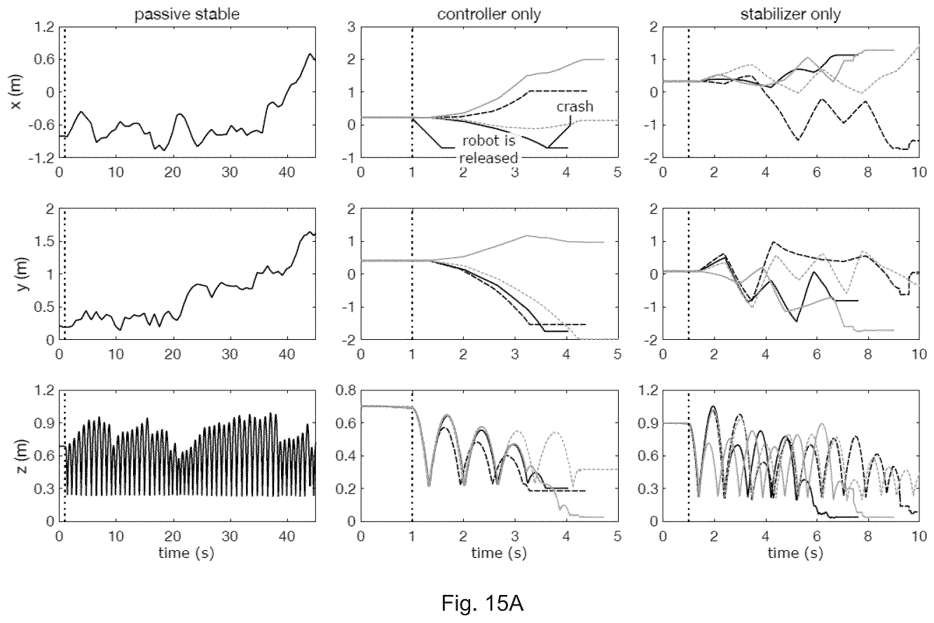

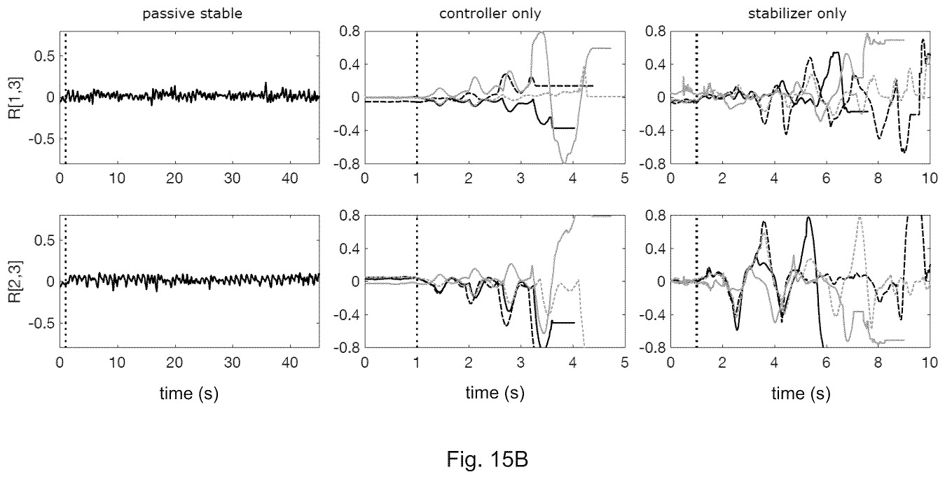

The constructed Poincaré maps assume a constant jumping height z_{d}. Hence, the vertical landing speed at cycle k is determined by ż(t_{LD})=\sqrt{2gz_{d}}. Given the landing attitude ϕ|ₖ and the angle of the landing velocity θ_{z}|ₖ, the landing angle θ_{LD}|ₖ=|ϕ|ₖ−θ_{z}|ₖ| is calculated under the assumption that vectors z_{W}, z_{b} (t_{LD})|ₖ, and \dot{p}(t_{LD})|ₖ, are coplanar and orthogonal to the rotational axis e_{ψ}. The takeoff states, z_{b}(t_{TO})ₖ| and \dot{p}(t_{TO})|ₖ, are obtained from Equation 8 and Equation 10. Following takeoff, the robot briefly throttles up in an upright orientation to compensate the energy lost (PA) before entering the ballistic trajectory (PJ). The horizontal velocity remains constant during flight. This implies the horizontal speed at takeoff at cycle k is equal to the horizontal speed at landing at cycle k+1. The vertical landing speeds at cycle k+1 and k are the same as dictated by the jump height z_{d}. The angle of the landing velocity θ_{z}|ₖ₊₁ is then the direction of the landing velocity relative to the vertical. This allows to compute θ_{z}|ₖ₊₁ or θ_{z}|ₖ₊₁/θ_{z}|ₖ for any θ_{z}|ₖ and ϕ|ₖ, which results in the Poincaré maps describes the stability of θ_{z} over jumping cycles (FIGS. 7D and 15).

### Supplementary Notes

### Moment of Inertia (Note S1)

After landing, the moment of inertia of the robot with respect to the ground contact point is obtained via the parallel axis theorem, taking into consideration the ground as the location of the axis of rotation,

$$I = {I}_{cm} + {ml}^{2} diag ( 1 , 1 , 0 ) , \qquad ( S1 )$$

where I_{cm}=diag(Iₓ,I_{y}, I_{z}). For a micro quadcopter (Bitcraze, Crazyflie 2.1), Iₓ, I_{y}, I_{z}≈2 g·cm², whereas ml²≈1×10⁴ g·cm² for l₀=0.22 m and m=27 g. That is, thanks to the long leg design, the term ml² dominates. Consequently, the robot can be treated as a point mass (instead of a rigid body) when the yaw rotations are minimized.

### Simplification of the Stance Dynamics (Note S2)

When the spring force dominates the weight of the robot, the motion of the robot in stance is described by Equation 5. Treating the non-slip ground contact point as the origin of an auxiliary inertial frame of reference, the position of the CoM is described by the leg vector l(t)z_{b}. The axial and angular dynamics correspond to the motion of l(t) and z_{b}(t).

Starting with the angular motion, the angular rate about z_{b} upon landing is assumed to be minimized by the attitude controller. The initial angular momentum in the stance phase specified by the angular velocity \dot{ψ}(t_{LD})e_{ψ} (perpendicular to z_{b} as described in Landing Transition) as shown in FIG. 2B. Furthermore, since the external force (z_{b}fₑ) does not contribute to any torque, the angular momentum of the robot (magnitude and direction) is unchanged. The rotation axis is constrained to e_{ψ}. As a consequence d/dt(ml²\dot{ψ}(t))=0, or

$${ml}^{2} ( t ) \dot{ψ} ( t ) = {ml}_{0}^{2} \dot{ψ} ( {t}_{LD} ) . \qquad ( S2 )$$

To derive the axial dynamics, \ddot{p} in Equation 5 is expressed using the leg vector as d/dt(l(t)z_{b}(t)). Since the leg axis z_{b}(t) evolves according to the angular velocity \dot{ψ}(t)e_{ψ}, it follows that d/dt(z_{b}(t))=\dot{ψ}(t)e_{ψ}×z_{b}(t) and Equation 5 becomes

$$m ( \ddot{l} {z}_{b} + 2 \dot{l} \dot{ψ} {e}_{ψ} \times {z}_{b} + l \ddot{ψ} {e}_{ψ} \times {z}_{b} + l \dot{ψ} {e}_{ψ} \times ( \dot{ψ} {e}_{ψ} \times {z}_{b} ) ) = {z}_{b} {f}_{e} . \qquad ( S 3 )$$

To extract the axial dynamics, the projection of Equation S3 is taken along z_{b}.

$$m \ddot{l} = m {\dot{ψ}}^{2} l + {f}_{e} . \qquad ( S4 )$$

wherein the term \dot{ψ}²l denotes the centrifugal acceleration brought by the rotation.

Lastly, the significance of \dot{ψ}²l is considered in comparison to fₑ/m. The prototype is fabricated with a large pre-stretched elastic force. As the identified parameters listed in Table S1, fₑ/m>klₚ/m=96 ms⁻². On the other hand, the upper bound of \dot{ψ} can be estimated from the speed of the robot at touch down. For a jump height of h=1 m, |\dot{p}|≈\sqrt{2gh}=4.4 ms⁻¹. If the landing angle θ_{LD} is around 200 or less (as evidenced in the experimental results in FIG. 2C), the angular speed, \dot{ψ}<|\dot{p}|sin(20°)/l₀ and \dot{ψ}²l<|\dot{p}|²/l₀=10 ms⁻². Since, the centrifugal acceleration is an order of magnitude smaller than the contribution from the elastomer, the dependence on \dot{ψ} can be neglected and Equation S4 reduces to Equation 6 after incorporating fₑ from Equation 4.

### Solutions of the Stance Phase Dynamics (Note S3)

Thanks to the simplification in Note S2, the stance dynamics is separated into axial and angular dynamics. The axial motion is captured by an unforced ordinary linear differential equation. The response of the systems obtained analytically.

Given the initial condition at landing with t=t_{LD} as the initial timestamp, obtained is

$$l ( {t}_{LD} ) = {l}_{0} and \dot{l} ( {t}_{LD} ) = {z}_{b} ( {t}_{LD} ) \cdot \dot{p} ( {t}_{LD} ) < 0. \qquad ( S5 )$$

During the downstroke (\dot{l}<0), the term sgn(\dot{l}) in Equation 6 is −1, the solution is

$$l ( t ) = ( \dot{l} ( {t}_{LD} ) / Ω ) sin ( Ω ( t - {t}_{LD} ) ) - ( {l}_{p} + {f}_{h} / k ) cos ( Ω ( t - {t}_{LD} ) ) + ( {l}_{0} + {l}_{p} + {f}_{h} / k ) , \qquad ( S6 )$$

with Ω=\sqrt{k/m}. The time when the leg is fully contracted can be found by solving for \dot{l}(t_{MD})=0. This results in

$${t}_{MD} = {t}_{TD} + \frac{1}{Ω} arctan ( - \frac{\dot{l} ( {t}_{LD} ) / Ω}{{l}_{p} + {f}_{h} / k} ) , \qquad ( S7 )$$

$$and$$

$$l ( {t}_{MD} ) = - \sqrt{{( \dot{l} ( {t}_{LD} ) / Ω )}^{2} + {( {l}_{p} + {f}_{h} / k )}^{2}} + ( {l}_{0} + {l}_{p} + {f}_{h} / k ) . \qquad ( S8 )$$

This condition becomes the initial state of the next phase, in which the leg recoils (\dot{l}>0). The solution of Equation 6 in this time period is

$$l ( t ) = ( l ( {t}_{MD} ) - {l}_{0} - {l}_{p} + {f}_{h} / k ) cos ( Ω ( t - {t}_{MD} ) ) + ( {l}_{0} + {l}_{p} - {f}_{h} / k ) , \qquad ( S9 )$$

$$\dot{l} ( t ) = - Ω ( l ( {t}_{MD} ) - {l}_{0} - {l}_{p} + {f}_{h} / k ) sin ( Ω ( t - {t}_{MD} ) )$$

Then, the takeoff time is found by solving Equation S6 for l(t_{TO})=l₀. This yields

$${t}_{TO} = {t}_{MD} + \frac{1}{Ω} arccos ( \frac{- {l}_{p} + {f}_{h} / k}{l ( {t}_{MD} ) - {l}_{0} - {l}_{p} + {f}_{h} / k} ) , \qquad ( S10 )$$

$$and$$

$$\dot{l} ( {t}_{TO} ) = - Ω ( l ( {t}_{MD} ) - {l}_{0} - {l}_{p} + {f}_{h} / k ) sin ( Ω ( {t}_{TO} - {t}_{MD} ) ) . \qquad ( S11 )$$

Therefore, the total time spent in the stance phase is

$${t}_{SP} = {t}_{TO} - {t}_{LD} = \frac{1}{Ω} arctan ( - \frac{\dot{l} ( {t}_{LD} ) / Ω}{{l}_{p} + {f}_{h} / k} ) + \frac{1}{Ω} arccos ( \frac{- {l}_{p} + {f}_{h} / k}{l ( {t}_{MD} ) - {l}_{0} - {l}_{p} + {f}_{h} / k} ) , \qquad ( S12 )$$

$$which is upper bounded by {t}_{SP} \leq \frac{π}{Ω} = π \sqrt{\frac{m}{k}} = 45 ms .$$

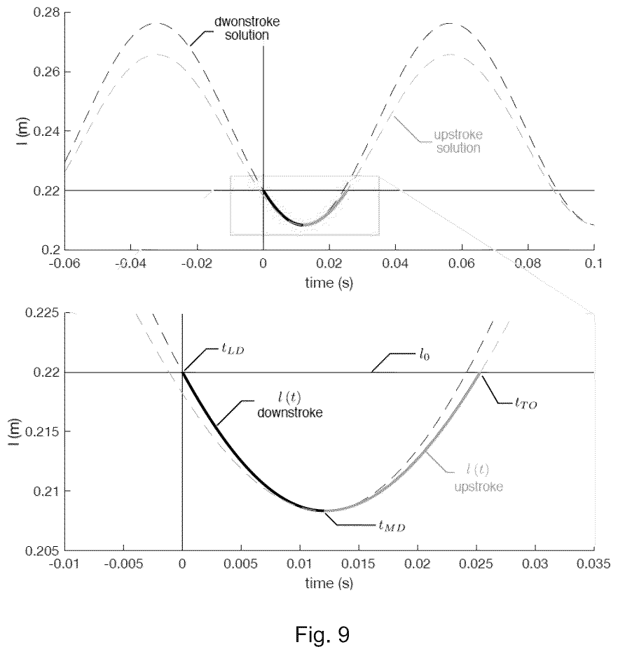

That is, the maximum stance time is inversely proportional to the square root of the stiffness k. Meanwhile, Equation S11 provides the knowledge required for computing the takeoff velocity. An example plot of l(t) in the entire stance phase is shown in FIG. 9.

As per Equation 7, once l(t) is determined, one can integrate forward the angular dynamics to determine Δψ:

$$\begin{matrix}Δψ & = & {\int }_{{t}_{LD}}^{{t}_{TO}} \dot{ψ} ( t ) dt = {l}_{0}^{2} \dot{ψ} ( {t}_{LD} ) {\int }_{{t}_{LD}}^{{t}_{TO}} {l}^{- 2} ( t ) dt & ( S13 ) \\ & = & {l}_{0}^{2} \dot{ψ} ( {t}_{LD} ) ( {\int }_{{t}_{LD}}^{{t}_{MD}} {l}^{- 2} ( t ) dt + {\int }_{{t}_{MD}}^{{t}_{TO}} {l}^{- 2} ( t ) dt ) , & ( S14 ) \\ & & & \end{matrix}$$

in which the expressions for 1(t) are taken from Equations S6 and S9.

### Friction Limit (Note S4)

The derived model describing the SP dynamics hinges on the non-slip assumption. This may not be satisfied in extreme maneuvers when the friction coefficient μ is low. Since the elastic force (aligned with z_{b}) dominates the SP dynamics, its vertical component becomes the ground normal and the lateral component should not exceed the friction limit. A slippage can be prevented by restricting the tilt angle of the robot arccos(e₃·z_{b}) to be lower than tan⁻¹μ in the entire stance phase. Since this angle is maximized either at t_{LD} or t_{TO}, this requires

$$ψ ( {t}_{LD} ) and ψ ( {t}_{TO} ) \leq {tan}^{- 1} μ , \qquad ( S15 )$$

as the tilt angle is maximized either at the landing or takeoff.

### Measurements of Stance Phase Acceleration (Note S5)

Due to the motion capture system's limited sample rate (≈100 Hz) and spatial resolution (≈1 mm), the timestamps of the touchdown and takeoff events surrounding the short stance phase (t_{SP}<45 ms, refer to the analysis in Note S3 and FIGS. 8A to 8C from the drop tests) cannot be precisely captured. To accurately estimate the stance phase acceleration, a few simplifying assumptions are employed and the estimation problem is converted into an optimization problem.

To begin, the recorded position of the robot is inspected for a short time period before and after a jump and the trajectory is divided into three phases: the stance phase sandwiched by aerial phase characterized as the pre-jump and post-jump periods. The stance time t_{SP}=t_{TO}−t_{LD} is conservative assumed 45 ms, but the exact landing and takeoff timestamps are not known.

The trajectories of the robot before and after the jump (\hat{p}_{LD}, \hat{p}_{TO}) are assumed to be parametric functions of time, with the robot only subject to a constant vertical acceleration of \hat{\ddot{p}}_{LD,TO}=−a_{LD,TO}e₃ (nominally g for free fall). Under this assumption, the following expressions can be derived for the position and velocity of the robot:

$${\dot{\hat{p}}}_{LD} ( t ) = {v}_{LD} + {a}_{LD} ( {t}_{LD} - t ) {e}_{3} , \qquad ( S16 )$$

$${\dot{\hat{p}}}_{TO} ( t ) = {v}_{TO} - {a}_{TO} ( t - {t}_{TO} ) {e}_{3} , \qquad ( S17 )$$

where v_{LD} and v_{TO} are the landing and takeoff velocities to be determined, and

$${\hat{p}}_{LD} ( t ) = {s}_{LD} + {v}_{LD} ( {t}_{LD} - t ) + \frac{1}{2} {{a}_{LD} ( {t}_{LD} - t )}^{2} {e}_{3} , \qquad ( S18 )$$

$${\hat{p}}_{TO} ( t ) = {s}_{TO} + {v}_{TO} ( t - {t}_{TO} ) - \frac{1}{2} {{a}_{LD} ( t - {t}_{TO} )}^{2} {e}_{3} , \qquad ( S19 )$$

where s_{LD} and s_{TO} and the landing and takeoff locations to be determined.

To account for possible deviations in a_{LD} and a_{TO} from g due to attitude and altitude control before landing and after takeoff, unknown parameters Θ={a_{LD}, a_{TO}, v_{LD}, v_{TO}, s_{LD}, s_{TO}} along with the landing timestamp are simultaneously searched for. This is by conducting the least squares regression of the measured trajectory and the anticipated trajectory of the robot in the aerial phase before and after stance, with the interested periods being short time intervals just before (t_{LD}−Δt<t<t_{LD}) and after (t_{TO}<t<t_{TO}+Δt) the stance.

Assuming the length of the stance phase is t_{SP}=t_{TO}−t_{LD}, given a particular length of time window Δt, the measured trajectories of the robot between t_{LD}−Δt to t_{LD} and t_{TO} to t_{TO}+Δt should follows Equations S18 and S19. Based on this principle, t_{LD} can be estimated by

$${Θ}^{*} , {t}_{LD}^{*} = arg {min}_{Θ , {t}_{LD}} {\sum }_{{t}_{LD} - Δ t < t < {t}_{LD}} {( p ( t ) - {\hat{p}}_{LD} ( t ) )}^{2} + {\sum }_{{t}_{TO} < t < {t}_{TO} + Δ t} {( p ( t ) - {\hat{p}}_{TO} ( t ) )}^{2} \qquad ( S20 )$$

$$subject to {t}_{TO} = {t}_{LD} + {t}_{SP} ,$$

where the sums are over the data points from the respective time ranges. Δt=0.4 s is selected to ensure sufficient data points (≈80) are included to determine 15 unknowns. Extending Δt may not lead to an improved fit as the acceleration may not be constant over a prolonged period thanks to the propelling thrust. Once the optimal parameters are determined, the landing and takeoff velocities can be evaluated using Equations S16 and S17. This method allows to compute the velocities without needing to take numerical derivatives, which can be sensitive to noise in the measurements and the choice of low-pass filter cutoff frequency.

FIG. 8A is a schematic diagram of an experimental setup of the drop tests for parameter identification. FIG. 8B shows the altitude of the robot in the free-drop experiments where dark and light curves represent falling and ascending (downstroke and upstroke) phases. FIG. 8C shows vertical acceleration versus the compressed length of the robot in the stance phase after the drops. FIG. 9 shows an example trajectory of the leg contraction l(t). The solid dark and light lines represent the analytical solutions of l(t) during the downstroke and upstroke, respectively. The dashed lines represent the extended solutions.

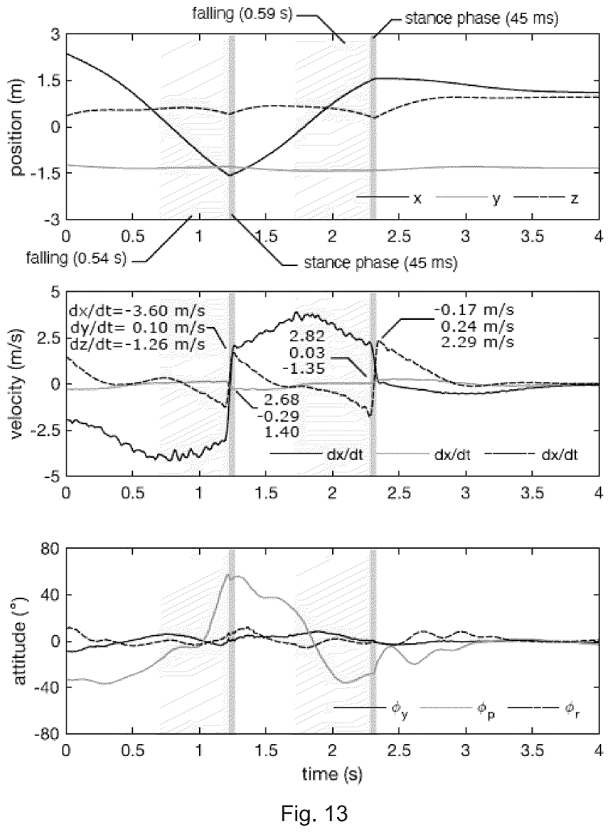

FIG. 10 shows a trajectory of hybrid locomotion of the robot with longitudinal acceleration and deceleration. FIG. 11 shows a trajectory of hybrid locomotion of the robot with a 900 turn. FIG. 12 shows a trajectory of hybrid locomotion with a U-turn. FIG. 13 shows a trajectory of hybrid locomotion with non-horizontal surfaces. FIG. 14 shows Poincaré maps depicting the evolution of the landing velocity angle θ_{z} in terms of θ_{z}|ₖ₊₁/θ_{z}|ₖ, as a function of θ_{z}|ₖ and ϕ|ₖ: FIG. 14, in A, shows predictions for the hopping height of 0.4 m; FIG. 14, in B, shows predictions for the hopping height of 0.6 m; FIG. 14, in C, shows predictions for the hopping height of 0.7 m; and FIG. 14, in D, shows predictions for the hopping height of 0.8 m.

FIG. 15A and FIG. 15B show trajectory of the robot in passive stability test for three scenarios of stable hopping (achieved with both the aerodynamic stabilizer and attitude controller), hopping with the attitude controller only, and hopping with the aerodynamics stabilizer only. The stable hopping scenario was obtained by implementing both the aerodynamic stabilizer and attitude controller. The four different patterned curves represent four repeated experiments. FIG. 16 shows altitude of the robot in agility evaluation. FIG. 17 shows results from endurance test: FIG. 17, in A, shows the altitude of the robot while hopping and the respective motor commands; and FIG. 17, in B, shows onboard battery voltage of the robots when jumping and flying.

TABLE S1
Identified Parameters of the Hopcopter

| Parameter | Description | Value | Unit |
|---|---|---|---|
| lₒ | original length of the leg | 22.00 | cm |
| lₚ | pre-stretch length of the elastomer | 1.97 | cm |
| k | spring constant of the elastomer | 170.06 | N/m |
| m | mass of the robot | 34.8 | g |
| ƒ_{c} | constant friction | 0.45 | N |

TABLE S2
Jumping height, frequency and the hopping agility of reported
jumping robots

| | Continuous | Mass | Jump | Frequency | Hopping |
|---|---|---|---|---|---|
| Robot | jumping | (g) | height (m) | (Hz) | agility (m/s) |
| Hopcopter | Y | 34.8 | 1.63 | 0.73 | 2.38 |
| | | | 1.50 | 0.77 | 2.31 |
| | | | 1.33 | 0.82 | 2.18 |
| | | | 1.15 | 0.88 | 2.02 |
| | | | 0.96 | 0.97 | 1.86 |
| | | | 0.76 | 1.07 | 1.63 |
| | | | 0.59 | 1.19 | 1.40 |
| Salto-1P [32] | Y | 98 | 1.25 | 0.73 | 1.83 |
| Salto [31] | Y | 100 | 1.01 | 0.87 | 1.76 |
| EPFL Jumper | N | 7 | 1.4 | 1/4 | 0.70 |
| [13], [31] | | | | | |
| Hybrid-Spring | N | 22.5 | 32 | 1/120 | 0.53 |
| Jumper [19] | | | | | |
| Inverted Cam | Y | 169 | 0.12 | 1.7 | 0.41 |
| Jumper [21] | | | | | |
| Penn Jerboa [34] | Y | 2419 | 0.055 | 3.5 | 0.39 |
| TAUB [22] | N | 23 | 3.35 | 1/20 | 0.34 |
| Jollbot [12, 23] | N | 465 | 0.184 | 1/1.44 | 0.26 |
| MSU Jumper [23] | N | 23.5 | 0.87 | 1/10 | 0.17 |
| EPFL Jumper | N | 14.3 | 0.62 | 0.13 | 0.16 |
| (Steerable) [24] | | | | | |
| Jumping Crawling | N | 59.4 | 1.62 | 1/28 | 0.12 |
| Robot [25] | | | | | |
| Flea Robot [23, 26] | N | 1.1 | 0.64 | 1/15 | 0.09 |
| Frogbot [23, 27] | N | 1300 | 0.9 | 1/30 | 0.06 |
| Jumpglider [28] | N | 67.5 | 1.0 | 0.03 | 0.06 |
| Jumping Crawler | N | 105 | 0.8 | 1/30 | 0.05 |
| [20] | | | | | |
| Grillo 3 [29] | N | 22 | 0.1 | 0.125 | 0.03 |

In flight mode, the robot functions as a regular micro aerial vehicle, allowing for stable hovering, agile maneuvering. Besides, thanks to the passive leg, the robot can perform a synergistic hybrid jumping and flying locomotion by performing intermittent mid-flight jumps. For instance, during high-speed flight, the robot leverages the ground contact or environment to generate an instantaneous burst of acceleration and hop to decelerate, turn, or accelerate—significantly improving agility beyond flight alone. Having a jumping leg also improves the endurance of the robot. In jumping mode, the robot generates thrust intermittently rather than continuously during the hopping mode. This mode of operation presents an opportunity to substantially extend robot's operation time and reducing power consumption when the robot is not necessary to keep aloft. Compared with flying, jumping mode can extend the operation time by four-fold.

To attain stable hopping using onboard sensors only, the robot is outfitted with an active aerodynamic stabilizer as a separate part. The stabilizer influences landing attitude, stabilizing hopping speed and attitude without external feedback or vision. The realized hybrid hopping-flying locomotion of the robot offers unprecedented versatility in navigating complex environments.

Some embodiments of the invention provide a hybrid hopping and flying robot comprising a micro quadcopter attached to a telescopic leg with an elastic element. The telescopic leg includes upper and lower sections, connected by guide wheel sets to allow vertical translation. Pre-stretched rubber bands are employed as an elastic element (elastomer). The design according to some embodiments of the invention enables the elastic force to dominate gravity and decouple the robot's dynamics from gravity's orientation which simplifies the jumping dynamics and enables a controlled jumping locomotion.

Some embodiments of the invention provide a model-based hopping controller with ability to control take-off velocity and landing positions of the robot, enabling trajectory tracking and complex hybrid locomotion. The controller may be configured to numerically solve for the landing attitude based on a model of dynamics of the robot during a hop. The controller may be configured to control the landing positions and takeoff velocities of the robot in three dimensions.

Use of ground reaction force through the elastic leg for efficient position control results in superior jumping agility compared to existing flying robots.

Various sensors can be carried for environmental detection for the hybrid hopping and flying robot. However, its unique of jumping locomotion enhances the agility of the movement of the robot and boosts its efficiency and prolongs its working time by over four-fold. In addition, thanks to the simple mechanical structure of the telescopic leg, this design can also be installed on conventional quadcopters as an additional component, allowing them to gain jumping locomotion.

According to the embodiments of the invention, by the combination of hopping and flying capabilities of the robot, mechanical simplicity and power efficiency can be achieved.

By its hybrid locomotion, the robot transcends the limitations of aerial or terrestrial locomotion alone, allowing it to navigate complex environments with ease and with boosted agility. Its ability to hop and fly enables rapid changes in the moving direction, making it more versatile than traditional aerial robots.

The passive telescopic leg design of the robot allows it to perform high-performance locomotion without the need for a trigger, actuation in stance, or variable mechanical advantage. This makes it mechanically simpler and more reliable than other bio-inspired jumping robots that rely on latched or unlatched elastic actuation.

The robot surpasses the state-of-the-art jumping robots, achieving a maximum velocity (jumping agility) of 2.38 m/s at a jump height of 1.63 m. Its thrust-based actuation allows fine-tuning of jump height, and its short stance phase enables higher hopping frequencies, resulting in remarkable agility.

Unlike aerial mode, the robot generates thrust intermittently during hopping mode, extending its operation time and reducing power consumption. This feature allows the robot to achieve a four-fold increase in endurance compared to benchmark quadcopters, making it more energy-efficient for long-duration tasks.

The passive leg design of the robot can be easily integrated into conventional rotorcraft, enabling standard quadcopters to transform into hopping robots with simple additions and control changes. This adaptability unlocks new performance frontiers through hybrid locomotion and broadens the potential applications for aerial and terrestrial robots.

It will also be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computing system” and “computing device” are used, these terms are intended to include (but not limited to) any appropriate arrangement of computer or information processing hardware capable of implementing the function described.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive. Example optional features of some embodiments of the invention are provided in the summary and the description. Some embodiments of the invention may include one or more of these optional features (some of which are not specifically illustrated in the drawings). Some embodiments of the invention may lack one or more of these optional features (some of which are not specifically illustrated in the drawings).

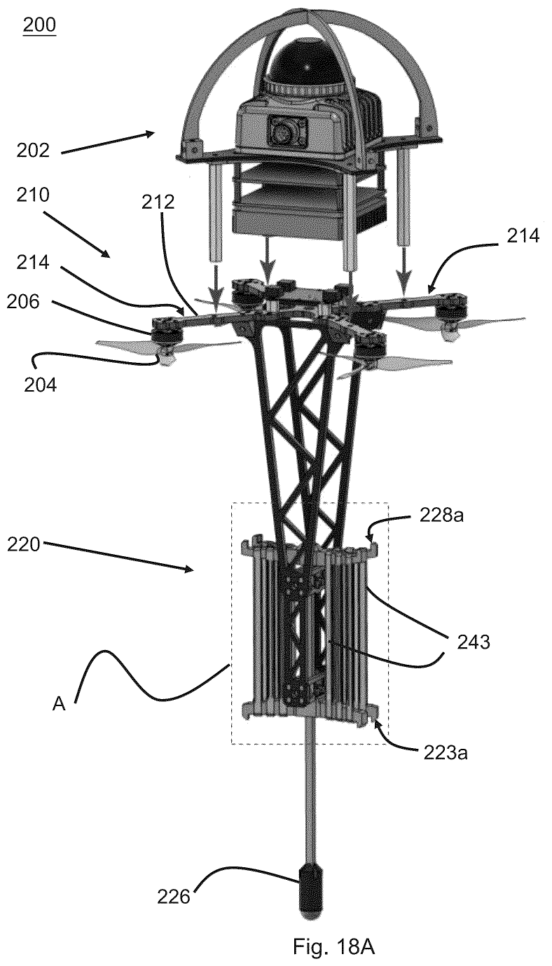

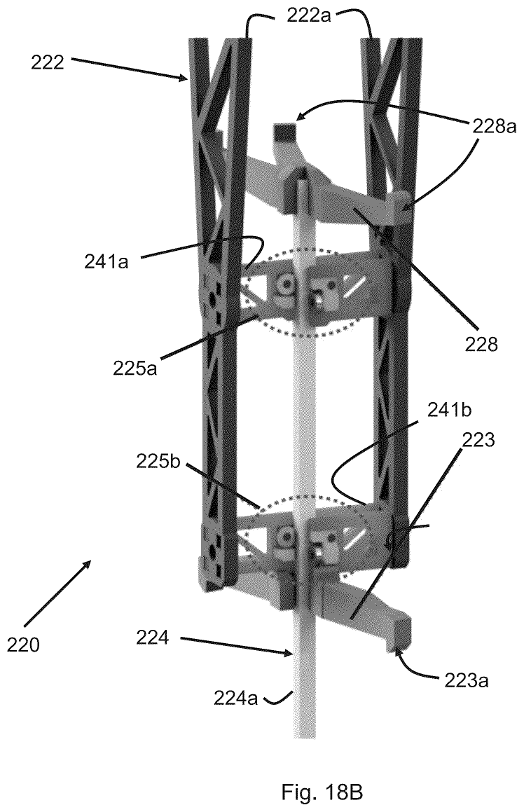

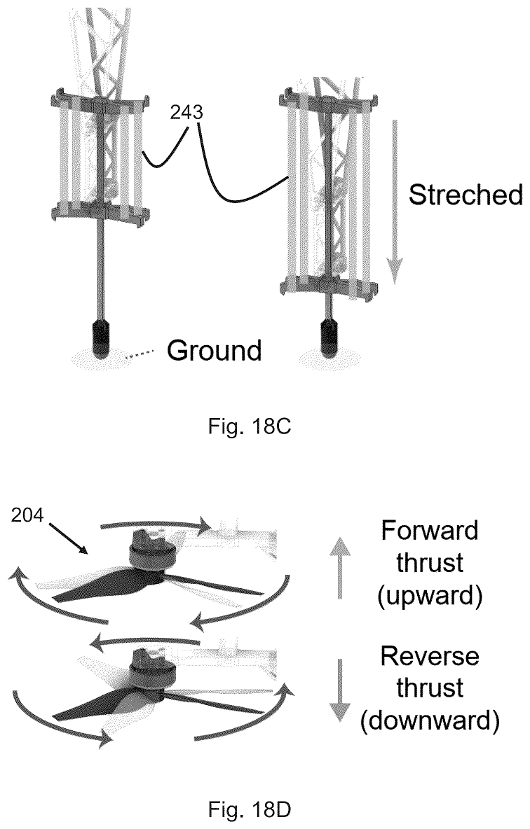

Another embodiment of the invention will now be described with reference to FIGS. 18A-18D. The embodiment provides a thrust-based robotic hopper capable of carrying payloads up to 9 times its own weight while maintaining agile mobility over less structured terrain. The 220-gram robot carries up to 2 kg while hopping—a capability that bridges the gap between high-payload ground robots and agile aerial platforms. Key advancements that enable this high-payload capacity include the integration of bidirectional thrusters, allowing for both upward and downward thrust generation to enhance energy management while hopping. Additionally, a refined model of dynamics is provided that accounts for heavy payload conditions, particularly for large jumps. To address the increased computational demands, a neural network compression technique is employed, ensuring real-time onboard control. The robot's capabilities are demonstrated through a series of experiments, including autonomous navigation while carrying a 730-g LiDAR payload.

This showcases the robot's potential for applications such as mobile sensing and mapping in challenging environments.

Two key technical contributions underpin this advancement in this embodiment. First, bidirectional thrusters [98]-[102] are introduced, enabling the robot to accelerate towards the ground during the descending phase of its hop. This additional actuation mechanism allows the robot to compensate for the increased energy dissipation resulting from heavier payloads, significantly expanding its load-bearing capabilities. Second, a more comprehensive derivation of the stance phase dynamics is presented. Unlike the model introduced above for the robot in FIGS. 1A-2B, this approach incorporates the weight of both the robot and its payload during the stance phase. While this consideration notably increases the model's complexity [96], it is essential for maintaining satisfactory hopping performance as the robot's mass becomes substantial. To address the increased computational demands of this more sophisticated model, a neural network (NN) compression technique [103] is employed, ensuring efficient onboard control.

A. Prototype with Bidirectional Thrusters

The design of the robot in FIGS. 18A-18D will now be described, which is similar to the robot shown in FIGS. 1A-1B in some aspects. For the sake of brevity, common or identical parts or mechanisms between FIGS. 18A-18D and FIGS. 1A-1B, but only those being different will be described herein. The robot 200 in FIGS. 18A-18D combines a quadrotor 210 as an aerial unit, and a passive leg mechanism 220 coupled to the quadrotor 210 (see FIG. 18A). The quadrotor 210 includes a thrust module which includes four rotors, a frame 212 with four arms 214 to which the four rotors are installed, and a flight control board (e.g., Bitcraze, Crazyflie bolt 1.1, not shown) electrically connected to the four rotors. The four rotors are respectively installed to free ends of the four arms 214, and in each rotor, there is a brushless motors 206 connected with a 3.5-inch propeller 204. In addition, bidirectional electronic speed controllers (not shown, e.g., ESCs, Flycolor X-Cross 45A) are employed which are respectively connected to and adapted to control the four brushless motors 206. This allows each rotor to independently generate forward (upward) or reverse (downward) thrust depending on the spinning direction as shown in FIG. 18D. The thruster module as a whole is therefore adapted to provide bidirectional thrusts. Although not shown, there is a controller module configured to control operation of the quadrotor 210 such that the robot 200 is operable in at least a hopping mode. However, the passive leg mechanism 220 has no active control and it functions as result of the movement of the quadrotor 210 as will be described in detail below. For illustrative purpose, a payload 202 is shown in FIG. 18A as being installable to the quadcopter 210.

The passive leg mechanism 220 is best illustrated in FIG. 18B. The passive leg mechanism 220 includes a telescopic leg arrangement and an elastomer module. The telescopic leg arrangement contains an upper leg section 222 connected fixedly to the bottom side of the frame 212 of the quadrotor 210. The upper leg section 222 contains two upper legs 222a that are separated apart from each other and extending in parallel. It can be seen from FIG. 18B that each upper leg 222 has a larger width near its top end and the width gradually decreases toward a lower end of the upper leg 222. The passive leg mechanism 220 further includes a lower leg section 224 movably connected with the upper leg section 222 via a connection module. The lower leg section 224 includes a lower leg 224a located between and substantially equidistantly to the two upper legs 222a, and is adapted to move relative to the upper legs 222a. A lower end of the lower leg 224a is equipped with a rubber foot 226.

The connection module contains an upper connector 241a that is mounted with an upper bearing module 225a, and a lower connector 241b that is mounted with a lower bearing module 225b. Both the upper connector 241a and the lower connector 241b are fixedly connected to the two upper legs 222a, which help maintain the distance between the two upper legs 222a and provide support to the upper bearing module 225a and the lower bearing module 225b. As can be seen in FIG. 18B, the upper bearing module 225a is mounted to a center of the upper connector 241a, and the lower bearing module 225b is mounted to a center of the lower connector 241b lower connector 241b. Both the upper bearing module 225a and the lower bearing module 225b are adapted to allow the lower leg 224a to slide along the same direction as the extending direction of the two upper legs 222a.

The elastomer module is operably coupled between the upper leg section 222 and the lower leg section 224. The elastomer module contains an upper elastomer mounting hook 228 and a lower upper elastomer mounting hook 223. Each of the upper elastomer mounting hook 228 and the lower upper elastomer mounting hook 223 contains a plurality of fingers 228a, 223a, where between a finger 228a of the upper elastomer mounting hook 228 and a corresponding finger 223a of the lower upper elastomer mounting hook 223, an elastomer 243 (e.g., a rubber band) is connected.

To account for the difference in aerodynamic efficiencies of propellers in the rotors in the forward and reverse configurations, four types of propellers (diameters between 3 to 4 inches) are tested for thrust and torque coefficients in both configurations following the protocols in [104]. The results reveal that the ratio of thrust coefficients in the reverse direction to forward direction, defined as Υ, varies from −0.36 to −0.56. The propeller type with the highest absolute (0.56) was selected.

As mentioned above the lower leg 224a is constrained to the upper legs 222a via two sets of bearings, constraining the relative movement between the upper leg section 222 and the lower leg section 224 to a single degree of freedom while minimizing the sliding friction. The telescopic motion is spring-loaded with the elastomers 243. In the default state when the leg length is l₀, the elastomers are pre-streched by a length lₚ. The leg contraction results in further elongation of the elastomers beyond lₚ (FIG. 18C). FIG. 18C shows that the stretching of the elastomers facilitate hopping motion of the robot 200. This strategy permits more kinetic energy to be temporarily stored in the leg structure upon landing under the same leg contraction. The mass of the robot (without payload) is mᵣ=220 g.

### Thrust-based Hopping Strategy

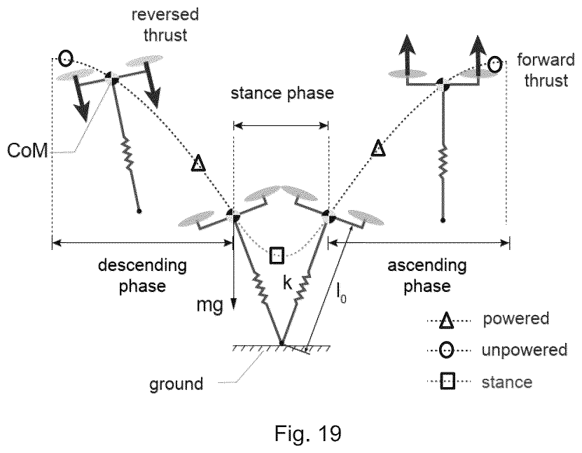

Unlike previous hopping robots that used inertial motors[96], [105] or leg motors [92], [94], the robot 200 shown in FIGS. 18A-18D utilize the thrust generated by propellers to regulate the hopping locomotion as the robot alternates between aerial and terrestrial phase. With the passive leg, the stance/terrestrial phase is completely passive. As the robot transitions from the aerial phase to the stance phase, the ground reaction force induces the leg to retract, elongating the elastomer. This leads to energy loss in the leg mechanism. Consequently, the takeoff speed will be smaller than the landing speed. To retain the hopping height, energy is injected into the system during the aerial phase via propelling thrust as illustrated in FIG. 19. As a hybrid dynamical system, the robot 200 alternates between aerial and terrestrial phases, with landing and takeoff transitions. Thanks to the unactuated spring-loaded leg, the hopper swings passively in the stance phase. To retain the desired hopping height and control the hopping trajectory, propelling thrust is employed to compensate for vicious losses and attitude control in the aerial phase.

In particular, forward (upright) thrust is applied when the robot ascends, immediately after the robot takes off. This powered ascent strategy was similarly adopted in the robot shown in FIGS. 1A-1B. Thanks to the use of bidirectional thrusters, the robot in FIGS. 18A-18D gains the ability to add more energy into the system via powered descent. This is by applying reverse (downward) propelling thrust prior to landing to accelerate the fall. The use of powered descent is beneficial when the robot carries a heavy payload, which incurs larger energy loss in the stance phase.

The total energy of the robot's system will gradually decrease with each hopping step, due to the energy loss both in the terrestrial and aerial phase. In the terrestrial phase, the energy loss is caused by landing impact on the ground and the viscous dissipation of leg mechanism during stretching and compressing. Consequently, the magnitude of takeoff velocity will be smaller than the landing velocity as a proportion of e. While in the aerial phase, the energy will be lost due to the air drag especially at high translational moving velocity, which means the higher it hops, the more air drag the robot will be undertaken. To compensate for the lost energy in each hopping step, the thrust force generated from propellers is leveraged to inject energy to the robot's system during the aerial phase, as illustrated in FIG. 19. The direction of the thrust (upward or downward) is determined by the direction of the robot's moving velocity in the air (ascending or descending), to make sure it do positive work to the robot's system. In this case, the forward thrust is adopted to add energy in the ascending phase, while the reverse thrust is used to further increase the energy in descending phase. Benefiting from the additional reverse thrust in descending phase, the robot could have more time to compensate the energy loss than the robot in FIGS. 1A-1B, thereby has more capability to carry payload as will be illustrated later. Apart from compensating for the energy lost, propelling torque is responsible for stabilizing the attitude of the robot inflight. This is used to manipulate the hopping trajectory. Unlike flying, the hopping trajectory is influenced by the attitude of the robot at the moment in lands on the ground. This hopping principle applicable to the robot with a single passive leg will be described in more detail later, leading to the development of the hopping controller.

Next, the enhanced payload capability of the hopping robot in FIGS. 18A-18B is analyzed, which is achieved through the combination of an elastic leg mechanism and a bi-directional thrust strategy. A simple model is presented to quantify this enhancement and compare the results with experimental data and other mobile robots. Consider a thrust-based hopping robot of mass mᵣ carrying a payload of mass mₚ, the amount of energy in the system required for the robot to reach the hopping height h is (mᵣ+mₚ)gh. η is defined as the proportion of energy lost per cycle, accounting for energy dissipation due to ground impact, leg mechanism, air resistance, and other viscous losses. The total energy loss per cycle amounts to η(mᵣ+mₚ)gh.

For the robot to maintain a continuous jump at height h, it must be actuated to compensate for the energy loss. This is ideally achieved by applying upward (forward) propelling thrust T_{f} during ascent and downward (reverse) thrust Tᵣ during descent when the robot is in the air as depicted in FIG. 19. The energy balance condition can be expressed as:

$$( {T}_{f} + {T}_{r} \vert ) h = η ( {m}_{r} + {m}_{p} ) gh , \qquad ( 21 )$$

independent of h as it cancels out on both sides.

To determine the maximum payload mass mₚ, the maximum forward thrust is considered using the notion of thrust-to-weight ratio Γ=T_{f}/mᵣg. In addition, since the reverse thrust is usually lower than the forward thrust, Υ=Tᵣ/T_{f}≤1 is introduced to indicate the performance of the bidirectional thruster. Employing these definitions, (21) becomes:

$$\frac{{m}_{p}}{{m}_{r}} = Γ \frac{1 + γ}{η} - 1. \qquad ( 22 )$$

To understand the significance of (22), a regular flying robot with an identical thrust-to-weight ratio Γ is considered. In such a case, the maximum payload mass is given by mₚ/mᵣ=Γ−1. In comparison, for thrust-based hopping, the thrust-to-weight ratio is effectively amplified by a factor of (1+Υ)/η.

This amplification is influenced by two key factors: Υ and η. The energy loss factor η is largely determined by the leg efficiency and can be dependent on the hopping height. For instance, previous 35-gram hopping robot with unidirectional thrust (Υ=0) has an estimated η of approximately 0.23 for jump heights from 0.68 m to 0.96 m. This implies an amplification factor of approximately 4.4. Theoretically, without considering control constraints, the 35-gram hopper with a thrust limit of 42 gf could carry a payload of up to 150 grams when control is not considered. Therein, the robot was able to hop while carrying a light payload with the total mass mᵣ+mₚ=43 g, slightly over the thrust limit. However, the true payload capability was not analyzed or examined.

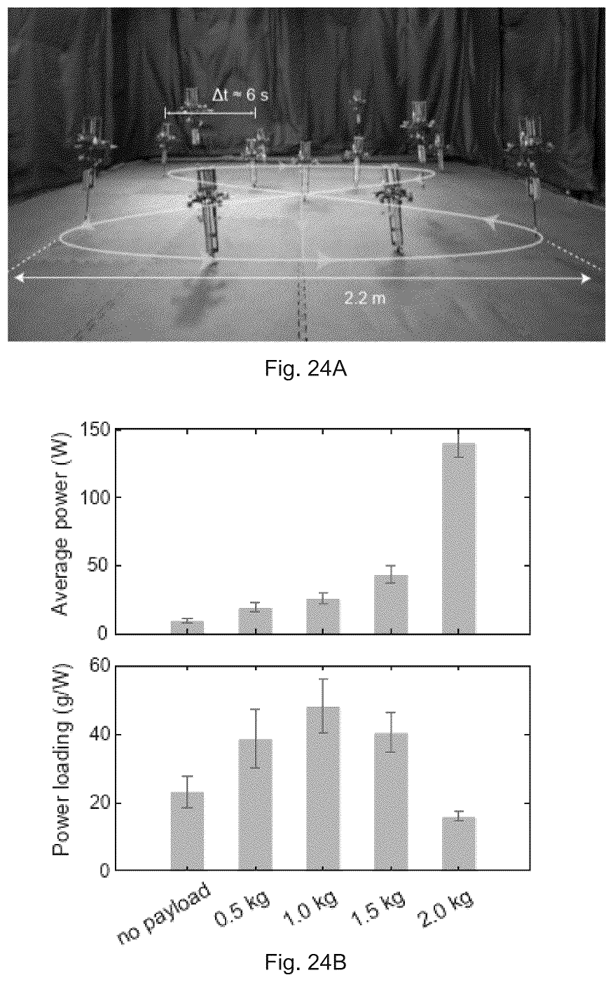

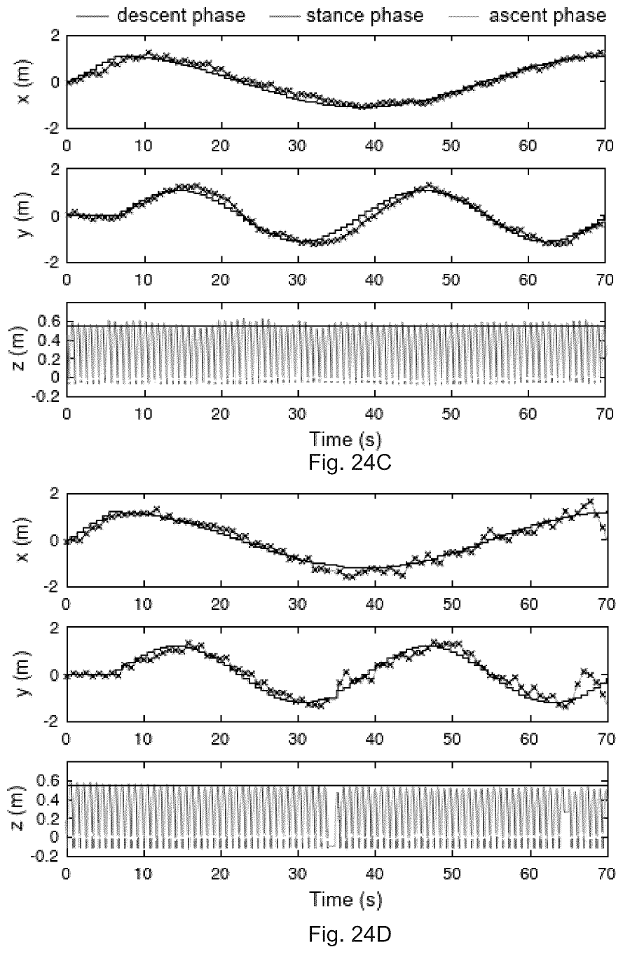

In the later section, it will be experimentally demonstrated that the robot in FIG. 24A, with a mass mᵣ=220 g and a maximum thrust of 440 gf (Γ=2), is able to operate reliably when carrying a 2.0 kg payload, thanks to the use of bidirectional thrusters. This equates to a payload ratio mₚ/mᵣ of 9.1 and a total mass of 2220 g, 5.0 times as large as the thrust limit. According to (22), the result implies a loss factor q below 0.31. Moreover, without the use of reverse thrust (Υ=0), the robot can still carry a payload as heavy as 1.5 kg, implying a similar loss factor of η=0.26.

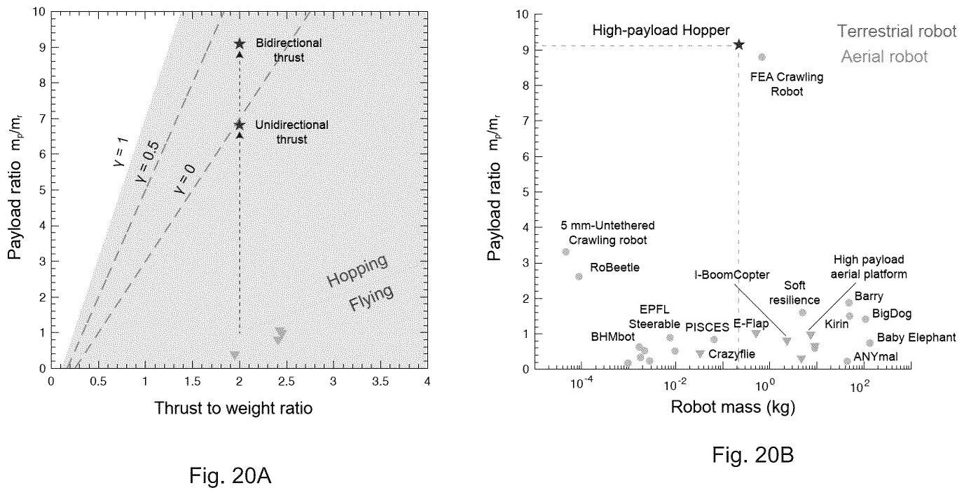

Comparing with other aerial and terrestrial robots with power autonomy [79], [81], [82], [87], [24], [106]-[124] across size scales (FIG. 20B), the robot of FIGS. 18A-18D (hereinafter “the proposed robot”) shows a substantially higher payload ratio while maintaining an ability to traverse less structured terrain. FIG. 20B highlights the superior payload capacity of the proposed thrust-based hopper, which also demonstrates an ability to overcome obstacles and traverse over less structured terrain. Among existing robots, a crawling robot powered by fluidic elastomer actuators [115] displayed an exceptional payload ratio of 8.8. However, the crawling motion of the robot in [115] is far less agile (14 mm/s) and incompatible with uneven ground. In addition, although there exist high-performance racing drones with exceptionally high thrust-to-weight ratios (˜4-5 [85], [125] or as large as 12 [126]), they have yet to demonstrate heavy payload carrying flight. More importantly, such systems would similarly and dramatically benefit from hopping when it comes to payload ratio as indicated by (22) and FIG. 20A. FIG. 20A shows that the payload limit (mₚ normalized by the original robot's mass mᵣ as payload ratio mₚ/mᵣ) against the thrust-to-weight (Γ=T/mᵣ) ratio. The proposed robot with Γ=2 experimentally demonstrates its ability to carry a payload 9.1 times as heavy as its own weight when hopping. This limit is increased with the use of directional thrusters (Υ>0).

The dynamics of the hopping robot in FIGS. 18A-18D can be divided into two primary phases: the aerial phase and the stance phase. The aerial phase is further subdivided into ascending and descending states, as depicted in FIG. 19. Transitions between the aerial and stance phases are marked as landing and takeoff events. Within the aerial phase, the robot can be in either powered or unpowered flight, regardless of whether it is ascending or descending. The powered flight corresponds to the robot actively generating thrust.

### Model of the Flight Dynamics

Neglecting aerodynamic drag, in the aerial phase, the robot is regarded as a rigid body of mass m=mᵣ+mₚ, indistinguishable from a regular quadrotor. The translational dynamic equation can be written into

$$mp = {{Re}_{3} ( - 1 )}^{k} {\sum }_{i = 1}^{4} {f}_{i} + mg {e}_{3} , \qquad ( 23 )$$

where p=[x, y, z]^{T} denotes the position of the robot in the inertial frame, R is the rotation matrix associated with the body frame, e3=[0, 0, 1]^{T} is a basis vector, k∈{0, 1} indicates the spinning direction of the propellers (k=0 for forward thrust and k=1 for reverse thrust), Σᵢ₌₁⁴ fi is the total thrust magnitude, and g is the free-fall acceleration.

The attitude dynamics in the aerial phase is governed by

$$I {\dot{ω}}_{b} + {ω}_{b} \times I {ω}_{b} = {τ}_{p} , \qquad ( 24 )$$

where I is the inertial tensor, ω_{b}=[ωₓ, ω_{y}, ω_{z}]^{T} is the body-centric angular velocity, τₚ is the torque generated by the propellers.

Given the configuration of the robot with the propeller armlength d, the torque in (24) can be derived as

$${τ}_{p} = {\sum }_{i = 1}^{4} {1}_{i} \times {e}_{3} {f}_{i} + {e}_{3} {M}_{i} , \qquad ( 25 )$$

where Iᵢ indicates the location of the i^{th} rotor, for example, lᵢ=d\sqrt{2}[1, −1,0]. Mᵢ is the propeller's induced torque.

Due to the asymmetric profile of the propeller blades, individual rotor thrust fᵢ and induced torque Mᵢ are dependent on the operating condition (forward or reverse thrust). Given the same motor commands or spinning rate, the magnitudes of both fᵢ and Mᵢ are reduced by a factor of Υ and Υₘ, respectively, for reverse operations. This characteristic must be taken into account when the low-level controller determines the motor commands from the desired thrust and torque values.

### Air-Ground Transition

As a hybrid dynamical system, the robot exhibits a discrete dynamic behavior at the air-ground transitions.

Immediately after landing (timestamp: t_{LD}), the nonslip pointy foot is considered as a spherical joint. The stationary ground contact point (pivot) can be regarded as the origin of the stance phase model. Defining pₛ=[xₛ, yₛ, zₛ]^{T} as the position of the Center of Mass (CoM) from the pivot, the initial position and velocity of the stance phase can be computed from the aerial phase state according

$${p}_{s} ( {t}_{LD} ) = R ( {t}_{LD} ) {e}_{3} {l}_{0} = {z}_{b} ( {t}_{LD} ) {l}_{0} , \qquad ( 26 )$$

$${\dot{p}}_{s} ( {t}_{LD} ) = \dot{p} ( {t}_{LD} ) , \qquad ( 27 )$$

where l₀ is the undeformed leg length. The landing time stamp t_{LD} can be solved for based on p(t) from (23) and R(t) from (24) using

$${e}_{3}^{T} p ( {t}_{LD} ) = {e}_{3}^{T} R ( {t}_{LD} ) {e}_{3} {l}_{0} . \qquad ( 28 )$$

For the transition back from stance to aerial phase, the position and translational velocity at takeoff time are continuous and can be written as

$$p ( {t}_{TO} ) = {p}_{s} ( {t}_{TO} ) + p ( {t}_{LD} ) , \qquad ( 29 )$$

$$\dot{p} ( {t}_{TO} ) = {\dot{p}}_{s} ( {t}_{TO} ) , \qquad ( 30 )$$

with t_{TO} being the takeoff time. This is when the elastic leg recoils to its original length or

$$‖ {p}_{s} ( {t}_{TO} ) ‖ = {l}_{0} . \qquad ( 31 )$$

Meanwhile, the attitude and angular velocity of the robot at takeoff moment can be found as

$$R ( {t}_{TO} ) {e}_{3} = {z}_{b} ( {t}_{TO} ) = {p}_{s} ( {t}_{TO} ) / {l}_{0} , \qquad ( 32 )$$

$${ω}_{b} ( {t}_{TO} ) \times {p}_{s} ( {t}_{TO} ) = {\dot{p}}_{s} ( {t}_{TO} ) . \qquad ( 33 )$$

The dynamics of pₛ depend on the elastic leg mechanism as described below.

Unlike the previous SLIP-based model for the robot in FIGS. 1A-1B that neglects the weight of the robot in the stance phase, the consideration for carrying a heavy payload renders the influence of the term mg important in the short stance duration even when compared with the large elastic force.

In the following model, the robot is regarded as a point mass rotating around the non-slip ground contact point. The design with a relatively long leg (nominal length: l₀) allows neglecting the moment of inertia of the robot. Consequently, the equation of motion is simplified to

$$m {\ddot{p}}_{s} = \frac{{p}_{s}}{‖ {p}_{s} ‖} ( - {k}_{s} ( l - {l}_{0} - {l}_{p} ) - ϵ \dot{l} ) - mg {e}_{3} , \qquad ( 34 )$$

where kₛ is the linear stiffness of the elastomer, l=∥pₛ∥ is the instantaneous leg length, and E is a linear damping coefficient.

### Validation of the Stance Phase Model

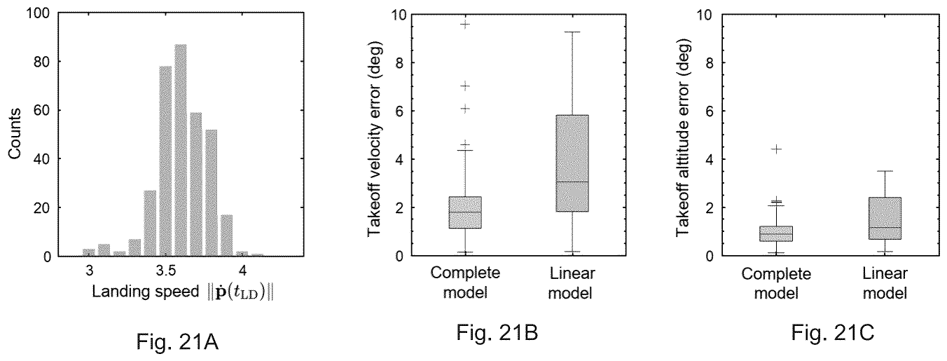

To validate the stance phase model in (34) and identify relevant physical parameters, the landing and takeoff states of the robot are experimentally collected by dropping the robot from different heights (between 0.42 m and 0.88 m) and orientations. A total of 343 data points are collected (average height: 0.68 m). In this test, the total weight of the robot was 824 g, including a 500-g dummy payload and an enlarged battery. The resultant landing speeds varied from 3 m/s to over 4 m/s as illustrated in FIG. 21A. In FIGS. 21A-21C, the boxes represent the interquartile range (IQR), with the median line. Whiskers extend to the lowest and highest data points within 1.5 times the IQR from the box edges.

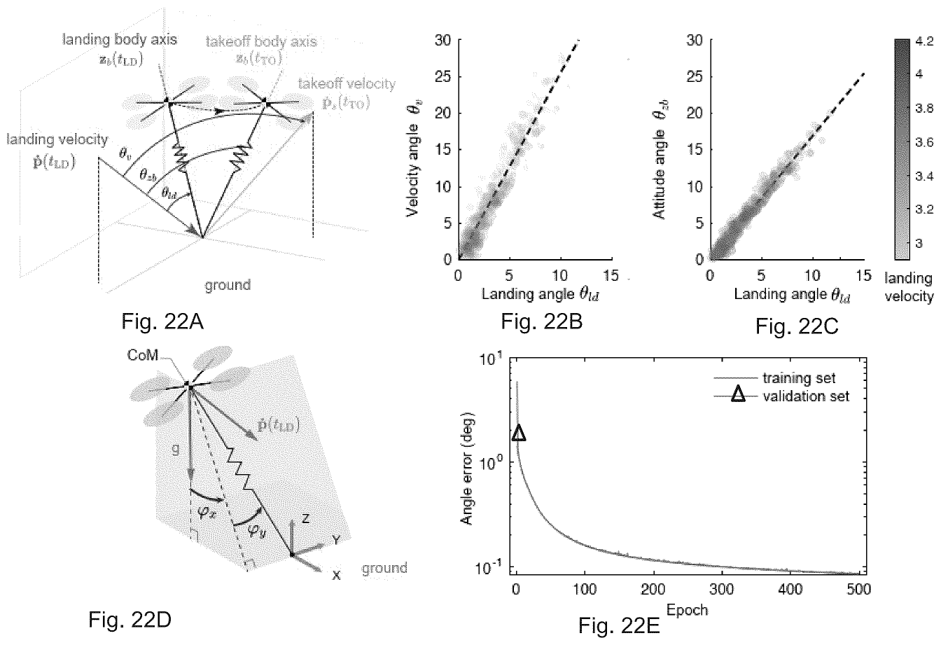

The trajectory data captured from the motion capture system were processed and encoded. The landing state consists of the landing velocity \dot{p}(t_{LD}) and the body axis R(t_{LD})e₃=z_{b}(t_{LD}) as present in (26) and (27). Similarly, the takeoff state includes the velocity \dot{p}ₛ(t_{TO}) from (30) and body attitude z_{b}(t_{TO}) or pₛ(t_{TO})/l₀ from (32). Together, these vectors are visually illustrated in FIG. 22A.

Based on the complete stance phase in (34), a Genetic Algorithm is employed to identify unknown parameters: Θ={l₀, lₚ, kₛ, ε}. The objective function is

$${Θ}^{*} = {arg min}_{Θ} [ {w}_{Θ} {ϵ}_{zb} ( Θ ) + {ϵ}_{v} ( Θ ) ] , \qquad ( 35 )$$

where w_{Θ}=2 is a positive weight, ε_{zb}(Θ) is the Root Mean Square (RMS) angular error of the takeoff body axis (the difference between the experimental measurements and the model predictions based on the landing states), and εᵥ(Θ) the RMS error of the takeoff velocity axis.

To evaluate the accuracy of the model, the pre-diction errors are inspected. The best-fitted parameters result in the average prediction error of 0.9° for the takeoff body axis z_{b}(t_{TO}) and 2.0° for the direction of the takeoff velocity \dot{p}ₛ(t_{TO}), plotted as ‘Complete model’ in FIG. 21B and FIG. 21C. This verifies that the dynamics described by (34) accurately captures the actual behavior of the robot.

### Compression of Inverse Stance Phase Model for Onboard Control

With the initial state from (36) and (37), and identified parameters, the 3-DoF stance phase dynamics can be simulated forward to obtain the takeoff state. The inverse map, providing the landing state corresponding to the desired takeoff state, is required for stabilizing and controlling the robot's hopping trajectory.

One approach to obtain the inverse map is to search for the landing state that results in the desired takeoff state (e.g., shooting methods), requiring the stance phase dynamics to be simulated several times to yield the solution. Unfortunately, simulating the stance phase dynamics forward using (34) on the flight control board is computationally demanding and cannot be achieved at a sufficiently high frequency. For the robot of FIGS. 1A-1B, this issue was circumvented by neglecting the mg term, which effectively reduces the dimension of the system and allows for an analytical solution to be obtained. However, this simplification is not ideal for a robot carrying a heavy payload, as the weight term becomes significant. In this section, two alternative methods to address this challenge are examined. The first approach is to empirically fit the model to the inverse map linearly, substantially decreasing computational complexity. However, this linear model is still based on an assumption that is valid when the influence of the term mg is negligible. This strategy, or a look-up table, becomes unattainable when the weight term is considered as the map becomes nonlinear and the dimension of the map increases from 1 to 5. To overcome this issue, a neural network-based compression model is then introduced to encode the solution of (34). This approach provides high accuracy over a wide range of landing states and allows the map to be used onboard under limited computational power.

### Linear Model

For the robot of FIGS. 1A-1B, it was established that when the weight of the robot in (34) is small compared with the elastic force, all four vectors associated with the landing and takeoff states, namely \dot{p}(t_{LD}), z_{b}(t_{LD}), \dot{p}ₛ(t_{TO}), and z_{b}(t_{TO}), are coplanar. It is defined that (i) the landing angle θ_{ld} as the angle between the landing velocity \dot{p}(t_{LD}) and attitude z_{b}(t_{LD}), (ii) θᵥ as the angle between the landing and takeoff velocities, and (iii) θz_{b} as the angle between the landing velocity and takeoff body axis as illustrated in FIG. 22A.

Based on previous findings for the robot of FIGS. 1A-1B, the takeoff state could be predicted by the landing state (velocity and landing angle) for a small range of θ_{ld}. As a result, all four vectors are approximately coplanar and the stance phase map could be further simplified. As plotted in FIGS. 22B and 22C, both θᵥ and θ_{zb} empirically exhibit an approximately linear relationship against θ_{ld} as follows.

$${θ}_{v} = {κ}_{v} {θ}_{ld} , \qquad ( 36 )$$

$${θ}_{zb} = {κ}_{zb} {θ}_{ld} , \qquad ( 37 )$$

Where kᵥ=2.54 and k_{zb}=1.69 are empirically determined constants.

The linear relations in (36) and (37) can be employed to predict the takeoff state (\dot{p}ₛ(t_{TO}), z_{b}(t_{TO})) from the landing state (\dot{p}(t_{LD}), z_{b}(t_{LD})) without directly applying the full dynamics or (34). The linear model predicts the takeoff velocity direction and body axis with the average angular errors of 3.8° and 1.5°, with the error distributions illustrated by boxplots in FIG. 21B and FIG. 21C. As anticipated, the errors are somewhat larger than the predictions made by the complete model in (34), partially attributed to the negligence of the weight time.

Inverse Stance Phase Model with Neural Network Compression

Here, a neural network is used to construct an inverse map of the complete stance phase model. This is required by the hopping controller as described later. To capture the impact of the term mge₃ in (34) in the model, information on the direction of the takeoff velocity with respect to gravity is incorporated. The network then predicts the required landing attitude. In addition, different payload masses are taken into consideration. This allows the model to be readily implemented for the robot carrying different payloads without retraining. As the NN is designed to function with the hopping controller, it takes a 6×1 vector as input and produces a 2×1 output vector. The input contains information on the landing velocity and the desired direction of the takeoff velocity. The network then outputs the body attitude of the robot that would result in the desired direction of the takeoff velocity (this is provided by the hopping controller) for that particular landing velocity.

More specifically, the input is

$${x}_{N} = [ \begin{matrix}‖ \dot{p} ( {t}_{LD} ) ‖ \\ arccos ( \frac{{e}_{3}^{T} \dot{p} ( {t}_{LD} )}{‖ \dot{p} ( {t}_{LD} ) ‖} ) \\ \dot{p} ( {t}_{TO} ) / ‖ \dot{p} ( {t}_{TO} ) ‖ \\ {m}_{p}\end{matrix} ] , \qquad ( 38 )$$

where the first element is the landing speed and the second is the angle between the velocity and gravity. Together, they emphasize the relative direction of gravity. The third entry is the takeoff velocity direction and the last is the payload mass.

The output is defined as

$${y}_{N} = {[ {φ}_{x} , {φ}_{y} ]}^{T} , \qquad ( 39 )$$

in which the elements are Euler angles rep-resenting the landing attitude (z_{b}(t_{LD})=[cos(φ_{y}) sin(φₓ), sin(φ_{y}), cos(φₓ) cos(φ_{y})]^{T}) that results in the landing velocity in x_{N}. The angle definitions are visualized in FIG. 22D.

1) Training Data Generation: To train the neural network model, training data from the complete stance phase model is generated first instead of relying on the limited experimental data. The numerical simulation (4th-order Runge-Kutta method) provides a large range of data that uniformly spans the input space, reducing bias in the process.

To cover a wide range of possible scenarios, the landing state is considered first, which consists of three dimensions of data (landing speed, angle, and payload mass) from the input vector and two from the output (φₓ, φ_{y}), amounting to five independent variables. A specific range is assigned for these five independent elements, within which 15 discrete points are uniformly generated, yielding 155 sets of training data. For the landing speed, the range is from 1 to 5 m/s, corresponding to a hopping height from 0.05 m to 1.28 m. For the angle with respect to the vertical, the range is from 0° to 30°. For payload mass, the input varies from 0.5 kg to 1.5 kg. For landing attitude specified by y_{N}, both Euler angles span a range of ±15°. These ranges encompass conditions of most low-speed hopping. After the simulation with the complete stance phase model, the remaining elements in x_{N} are obtained, corresponding to the takeoff velocity. The resultant takeoff speeds vary from 1 m/s to 5 m/s. Remark that the takeoff speed could be as high as the landing speed despite viscous losses when the center of mass of the robot when taking off is lower than at landing. In the end, all eight elements for N=15⁵ pairs of input/output vectors are obtained.

2) Training of the neural network: a neural network is trained to represent the inverse map of the stance phase based on the generated simulation data, mapping the 6×1 input x_{N} to the 2×1 output y_{N}. The architecture of the network consists of six fully connected layers structured as 6→64→256→256→32→2, employing rectified linear unit (ReLU) activations. This design incorporates a total of 91,170 parameters, significantly fewer than the 15⁵=759, 375 parameters required for a direct lookup table of the inverted dynamics.

To optimize the neural network's output, a loss function is defined that minimizes the angular discrepancy between the predicted landing attitude vector and the training data, represented by the dot product of the two unit vectors. This loss function is expressed as:

$$min \frac{1}{N} {\sum }_{i}^{N} {( 1 - {z}_{b}^{T} ( {y}_{n} ( i ) ) {\hat{z}}_{b} ( {x}_{N} ( i ) ) )}^{2} \qquad ( 40 )$$

where the index i refers to the i^{th} set of data. Here z_{b}^{T}(y_{N}(i)) is the landing attitude corresponding to y_{N} taken from the training data, and \hat{z}_{b}(x_{N}(i)) is the predicted landing attitude based on the output of the network, computed using the current set of hyperparameters. The minimization is over a set of hyperparameters of the entire network.

The neural network was implemented and trained using PyTorch, employing the Adam optimizer with a learning rate of 0.01. To balance the contributions of different vector ranges to the total loss, batch-wise weighting is applied. The dataset, comprising 155 samples, was randomly shuffled and partitioned into training (80%), validation (10%), and test (10%) sets. To mitigate overfitting, performance on the validation set during training is monitored. Training progressed for 2000 epochs, with convergence monitored using an angle discrepancy metric derived from the loss function. As illustrated in FIG. 22E, this metric converged to 0.09° for both training and validation sets after 500 epochs, ultimately reaching 0.060 at the conclusion of training.

To assess the trained network, its performance is evaluated on the test set (75,937 samples). The predicted attitude \hat{z}_{b} (t_{LD}) constructed from the output vector is compared with the ground truth and inspected the angular errors. The results demonstrate that, excluding a few outliers, the errors are consistently below 0.1. This is negligible when compared against the takeoff angular errors computed from the predictions from the complete model and the experimentally collected data (velocity: 4.2°, attitude: 2.0°, FIGS. 21B and 21C).

Next, the control architecture for stabilizing the attitude and trajectory of the thrust-based hopping robot is presented. The controller leverages the fact that the stance phase is extremely short and passive, meaning no active control is exerted during this phase. This controller is hinged on the reverse map of the stance phase, compressed in to the trained neural network. The key method employed is controlling the landing attitude, which serves as the initial condition for the stance phase. This effectively manipulates the direction of the takeoff attitude, takeoff velocity, and subsequent aerial phase trajectory.

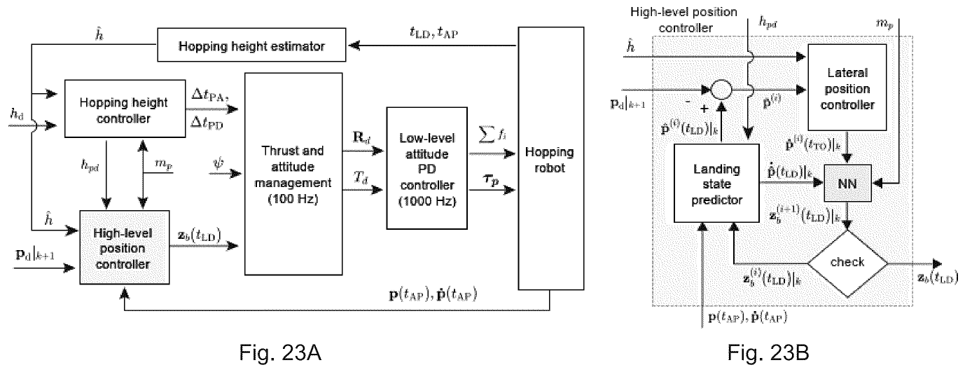

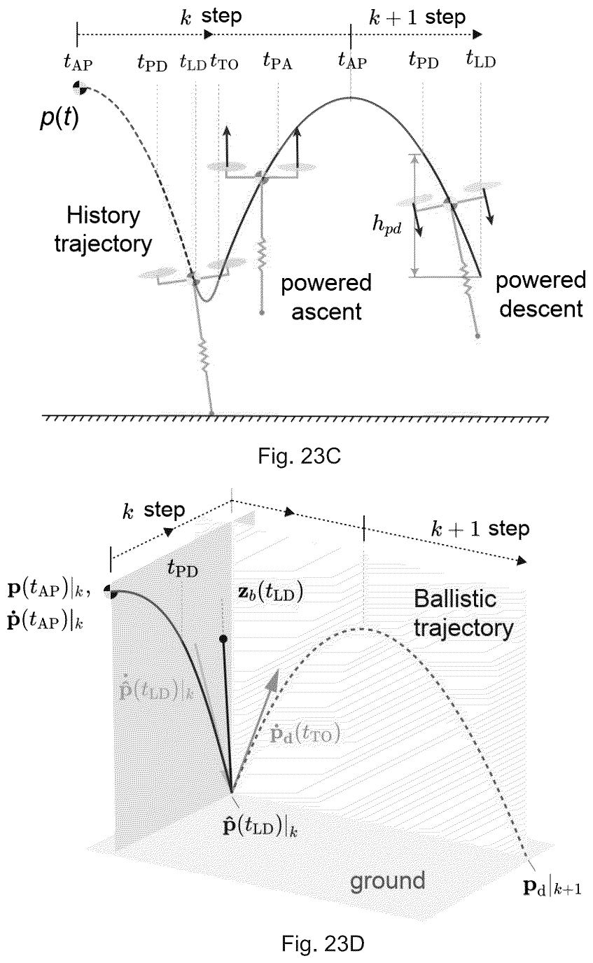

The controller is divided into four primary components: (i) a height controller, (ii) a high-level position controller, (iii) thrust and attitude management, and (iv) a low-level attitude controller, as illustrated in FIG. 23A. The hopping height controller ensures the robot reaches the desired hopping height by determining the appropriate duration for applying forward and reverse thrust during the ascending and descending aerial phase. This calculation determines the amount of energy to be injected into the system to compensate for any losses. The high-level position controller, making use of the trained neural network, executes once per hopping cycle, calculating the landing attitude based on the discrepancy between the predicted and desired landing positions. The outputs from both the height and position controllers are fed into the thrust and attitude management module, which determines the thrust direction, magnitude, and robot orientation throughout the entire aerial phase. Subsequently, the thrust and attitude commands are relayed to the onboard low-level controller for motor actuation.

In addition to the use of the NN-compressed reverse stance phase model, the primary distinction from the robot of FIGS. 1A-1B lies in the introduction of reverse thrust, which leads to two significant changes: (i) the coupling of landing attitude and reverse thrust in the landing state prediction within the high-level position controller, and (ii) the incorporation of an additional component in thrust management to account for the powered descent phase. These modifications are necessary because the use of reverse thrust during the falling phase induces lateral acceleration when the robot aligns its body axis with the desired landing attitude. This lateral acceleration causes the actual landing point to deviate from the expected point (based on a free-falling trajectory), consequently influencing the selection of the optimal landing attitude.

### Hopping Height Controller

As indicated by (21), the hopping height is closely related to the amount of energy in the system, which can be regulated through powered ascent and descent during the flight phase. Therefore, the height control strategy involves two main steps: nominal height prediction and height control. First, a method for predicting the nominal hopping height of the next step when the robot is landing is presented. Then, the control strategy is detailed, which adjusts the thrust duration of the robot in the aerial phase. The amount of adjustment is based on the nominal hopping height and the desired hopping height, taking into consideration the payload weight. This ensures the desired hopping height is approximately reached.

1) Nominal Hopping height: The nominal hopping height h is estimated based on the current amount of energy of the robot. This serves as a reference value for the hopping height controller to evaluate whether additional energy is required for the robot to reach the desired height h_{d}. The estimation is carried out cyclically at the moment (t_{LD}) of the landing of each hop step, based on the recorded apex velocity \dot{p}(t_{AP}) and the descent duration t_{LD}−t_{AP} (refer to FIG. 23C). t_{AP} is determined by monitoring the vertical speed and the landing timestamp. t_{LD} is detected through ground impact.

In this step, the nominal height is computed assuming the kinetic energy of the robot at landing is subsequently converted to the potential energy, after taking into consideration the loss factor η that captures the energy loss in the leg mechanism in the stance phase. This yields

$$mg \dot{h} = \frac{1 - η}{2} m ( {\dot{p} ( {t}_{AP} )}^{T} \dot{p} ( {t}_{AP} ) + {{g}^{2} ( {t}_{LD} - {t}_{AP} )}^{2} ) , \qquad ( 41 )$$

$$\hat{h} = \frac{1 - η}{2 g} ( {\dot{p} ( {t}_{AP} )}^{T} \dot{p} ( {t}_{AP} ) + {{g}^{2} ( {t}_{LD} - {t}_{AP} )}^{2} ) . \qquad ( 42 )$$

In the absence of control, ĥ will be the maximally feasible hopping height of the robot after it takes off. Furthermore, the conservation of energy also informs us about the speed of the robot when it takes off from

$$\frac{1}{2} m {‖ {\dot{p}}_{d} ( {t}_{TO} ) \vert ‖}^{2} = mg \hat{h} , \qquad ( 43 )$$

with the nominal height ĥ obtained when \dot{p}_{d}(t_{TO}) is upright.

2) Hopping height control: Depending on the nominal hopping height in (42) and the desired height h_{d}, the height control strategy regulates two key parameters: the duration of powered ascent (t_{PA}−t_{TO}) and powered descent (t_{LD}−t_{PD}). The approach varies depending on the payload weight.

First, (22) is employed to determine the maximum payload mass mₚ that is compatible with the unidirectional thrust limit (taking Υ=0 and η=0.25), resulting in mₚ=(Γ/η+1)mᵣg=1.54 kg.

For lighter payload within this limit, only powered ascent is employed, setting t_{PD} in FIG. 23C (and later on in (48)-(51)) to t_{LD}. The powered ascent time t_{PA}−t_{TO} is chosen based on the nominal hopping height h from (42) and the set point h_{d}. Following the strategy mentioned for the robot in FIGS. 1A-1B, the control decision is made as follows.

If the nominal hopping height is higher than the desired height (ĥ>h_{d}), the powered ascent is forgone as no additional energy needs to be injected into the system.

Otherwise, a short burst of powered ascent is applied immediately after takeoff to maximize the power input. The required energy input to achieve the desired height is mg(h_{d}−ĥ). Given that the vertical speed of the robot immediately after takeoff is approximately \sqrt{2 gĥ}, the required powered ascent time t_{PA}−t_{TO} can be approximated from

$${T}_{f} \sqrt{2 g \hat{h}} ( {t}_{PA} - {t}_{TO} ) = mg ( {h}_{d} - \hat{h} ) , \qquad ( 44 )$$

where T_{f} is the magnitude of the forward thrust force. Its value depends on the payload mass. To meet the energy condition in (21), T_{f} should be greater than 77 mg. Concurrently, T_{f} cannot exceed its maximum limit (Γmᵣg) while leaving some room for torque generation and attitude control.

For payload exceeding the unidirectional thrust limit of 1.54 kg, both powered ascent and descent are employed. The powered descent was designed to inject more energy into the system. The additional energy needed during the powered descent phase could be evaluated by subtracting the maximum energy that could be replenished during the ascent phase Γmᵣgĥ from the expected energy lost ηmgĥ in each hop. It follows that when the energy is injected with the maximum reverse thrust Tᵣ=ΥΓmᵣg, the required powered descent distance h_{pd} can be estimated from:

$$( γΓ {m}_{r} g ) {h}_{pd} = η mg \hat{h} - Γ {m}_{r} g \hat{h} , \qquad ( 45 )$$

$${h}_{pd} = ( \frac{η m}{Γ {m}_{r}} - 1 ) \frac{\hat{h}}{γ} . \qquad ( 46 )$$

Based on the maximum payload mass condition in (22), the payload mass is upper bounded as mₚ<(Γ(1+Υ)/(η−1)mᵣ, such the total mass satisfies m<(Γ(1+Υ)/(η−1)mᵣ/η. Hence, in (46), there are the term ηm/Γmᵣ−1<1/Υ and h_{pd}<ĥ. This means the powered descent distance is shorter than ĥ as expected. In practice, Tᵣ is set to be lower than the maximum limit of ΥΓmᵣg in order to maintain sufficient attitude control capability. Therefore, (45) is only approximately valid. Taking a cue from (45), a tuning parameter kₕ is introduced to yield h_{pd} as a function of ĥ according to

$${h}_{pd} = {κ}_{h} \hat{h} . \qquad ( 47 )$$

Expressing h_{pd} as e₃^{T}(\hat{p}(t_{PD})−\hat{p}(t_{LD})), the duration for powered descent t_{LD}−t_{PD} can also be later computed using (48)-(51). This use of powered descent increases the vertical speed of the robot at landing, pushing the robot closer to the desired height h_{d} in the subsequent jump.

### High-Level Position Control

Similar to hopping robots capable of continuous jumps such as the robot in FIGS. 1A-1B, or that in [31] and unlike aerial robots, the aerial locomotion of the robot in this work is without direct position control. Instead, the hopping trajectory is regulated through the jumping direction or the direction of the takeoff velocity following the short stance phase. As previously mentioned, the takeoff velocity is highly dependent on the attitude of the robot at landing.

The high-level position control is performed in three steps: (i) a landing state predictor estimates the current (cycle k) landing state based on the apex position and velocity, (ii) the errors between the desired landing position for cycle k+1 and the current landing position is used to calculate a desired aerial trajectory which is represented by a takeoff velocity, (iii) the landing attitude needed to achieve the takeoff velocity is iteratively estimated.

The coupling between the landing attitude and the takeoff velocity, which influences the subsequent landing location, complicates the control strategy. The controller must solve for the desired landing attitude iteratively as illustrated by FIG. 23B. The iterative approach, indexed by a bracketed super-script (·)⁽ⁱ⁾, initializes with the landing attitude z_{b}⁽⁰⁾(t_{LD})|ₖ. It then computes the upcoming landing position \hat{p}⁽⁰⁾(t_{LD})|ₖ and corresponding takeoff velocity \hat{p}^{(O)}(t_{TO})|ₖ₊₁. This leads to the expected next landing position \hat{p}⁽⁰⁾(t_{LD})|ₖ₊₁. Based on the difference between this and the setpoint position, the controller updates the landing attitude, yielding z_{b}⁽¹⁾(t_{LD})|ₖ. The process is repeated until the position error of \hat{p}(t_{LD})⁽ⁱ⁾|ₖ₊₁ is marginalized.

Below, an elaboration is firstly provided on how the landing position of the current cycle k is predicted. This is computed once per hop. Then, the position control is detailed. These steps are iteratively executed once per hop. For brevity, the iteration index (·)⁽ⁱ⁾ is omitted from the following equations.

1) Landing state prediction: The upcoming landing state, comprising the landing position and velocity is predicted (\hat{p}(t_{LD})|ₖ, \hat{\dot{p}}(t_{LD})|ₖ) once per hopping cycle after the robot reaches the apex during the aerial phase.

As shown in FIG. 23D, the predictor assumes a free-fall descent followed by a powered descent (at time t_{PD}), neglecting air drag. Given the apex position p(t_{AP}) and velocity \dot{p}(t_{AP}), the position \hat{p}(t_{PD})|ₖ and velocity of the robot \hat{\dot{p}}(t_{PD})|ₖ) at the beginning of the powered descent phase are estimated as

$$\hat{p} ( {t}_{PD} ) {\vert}_{k} = p ( {t}_{AP} ) {\vert}_{k} + \dot{p} ( {t}_{AP} ) {\vert}_{k} ( {t}_{PD} - {t}_{AP} ) - \frac{1}{2} {e}_{3} {g ( {t}_{PD} - {t}_{AP} )}^{2} , \qquad ( 48 )$$

$$\dot{\hat{p}} ( {t}_{PD} ) {\vert}_{k} = \dot{p} ( {t}_{AP} ) {\vert}_{k} - {ge}_{3} ( {t}_{PD} - {t}_{AP} ) , \qquad ( 49 )$$

where t_{AP} is the apex timestamp and t_{PD} marks the start of the powered descent phase. The beginning of the powered descent phase t_{PD} is empirically obtained when the robot falls to a height h_{pd} (designated by the height controller in (46)) and is computed from e₃^{T}(\hat{p}(t_{PD})=h_{pd}. Hence, the time the robot spends in free fall is t_{PD}−t_{AP}.

During the powered descent with a reverse thrust Tᵣ, the robot is assumed to be aligned with the desired landing attitude z_{b}(t_{LD})|k. It experiences an additional acceleration of Tᵣ/mz_{b}. Thus, the estimated landing position \hat{p}(t_{LD}) and velocity of the robot \hat{\dot{p}}(t_{LD}) are

$$\hat{p} ( {t}_{LD} ) {\vert}_{k} = \hat{p} ( {t}_{PD} ) {\vert}_{k} + \dot{\hat{p}} ( {t}_{PD} ) {\vert}_{k} ( {t}_{LD} - {t}_{PD} ) - \frac{1}{2} ( {e}_{3} g + {z}_{b} ( {t}_{LD} ) {\vert}_{k} {T}_{r} / m ) {( {t}_{LD} - {t}_{PD} )}^{2} , \qquad ( 50 )$$

$$\dot{\hat{p}} ( {t}_{LD} ) {\vert}_{k} = \dot{\hat{p}} ( {t}_{PD} ) {\vert}_{k} - ( {e}_{3} g + {z}_{b} ( {t}_{LD} ) {\vert}_{k} {T}_{r} / m ) ( {t}_{LD} - {t}_{PD} ) , \qquad ( 51 )$$

where the landing time t_{LD} is calculated by imposing the flat ground condition e₃^{T}\hat{p}(t_{LD})|ₖ=0.

(2) Desired takeoff velocity: To ensure the robot follows a prescribed hopping trajectory, an iterative lateral position control strategy is implemented based on the predicted landing position of the next hop \hat{p}(t_{LD})ₖ₊₁. This is then used to compute the required takeoff velocity \hat{\dot{p}}(t_{TO})|ₖ that would approximately and subsequently navigate the robot to the desired position \dot{p}_{d}(t_{TO})|ₖ.

Similar to the strategy mentioned above for the robot in FIGS. 1A-1B, the strategy described here completely relies on regulating the takeoff velocity of the robot via manipulating the landing attitude, without directly controlling the position of the robot in the aerial phase. This means that starting from the apex, the landing position of the robot in the current cycle (indexed as k) is largely determined and predicted as \hat{p}(t_{LD})|ₖ by (50). Nevertheless, the next landing point \hat{p}(t_{LD})|ₖ₊₁ can be altered by strategically regulating the takeoff velocity \dot{p}(t_{TO})|ₖ in the current step. This target takeoff velocity is realized by controlling the robot's landing attitude z_{b}(t_{LD})|ₖ as it serves as the initial conditions for the passive stance phase.

Starting from the predicted landing position \hat{p}(t_{LD})|ₖ and a hypothetical takeoff velocity \dot{p}(t_{TO})|ₖ, the landing position \hat{p}(t_{LD})|ₖ₊₁ in the next hopping step is estimated by assuming an entirely ballistic trajectory. As the flight phase time is equal to 2e₃^{T}\dot{p}(t_{TO})|ₖ/g, the next landing location is expected to be

$$\hat{p} ( {t}_{LD} ) {\vert}_{k + 1} = \hat{p} ( {t}_{LD} ) {\vert}_{k} + \dot{p} ( {t}_{TO} ) {\vert}_{k} ( \frac{2 {e}_{3}^{T} \dot{p} ( {t}_{TO} ) {\vert}_{k}}{g} ) - \frac{1}{2} {{ge}_{3} ( \frac{2 {e}_{3}^{T} \dot{p} ( {t}_{TO} ) {\vert}_{k}}{g} )}^{2} , \qquad ( 52 )$$

which can be re-arranged into

$$\dot{p} ( {t}_{TO} ) {\vert}_{k} = \frac{g ( \hat{p} ( {t}_{LD} ) {\vert}_{k + 1} - \hat{p} ( {t}_{LD} ) {\vert}_{k} )}{2 {e}_{3}^{T} \dot{p} ( {t}_{TO} ) {\vert}_{k}} + {e}_{3} ( {e}_{3}^{T} \dot{p} ( {t}_{TO} ) {\vert}_{k} ) , \qquad ( 53 )$$

In this form, an explicit expression of \dot{p}(t_{TO})|ₖ is attempted to be found. To do so, \dot{p}(t_{TO})|ₖ is expressed in terms of horizontal and vertical components. With the energy equation in (43), one have

$${‖ [ {\begin{matrix}{e}_{1} & {{e}_{2} ]}^{T} \dot{p} ( {t}_{TO} ) \vert\end{matrix}}_{k} ) ‖}^{2} + {( {e}_{3}^{T} \dot{p} ( {t}_{TO} ) {\vert}_{k} )}^{2} = 2 g \hat{h} . \qquad ( 54 )$$

Substituting \dot{p}(t_{TO})|ₖ from (53) into (54) yields

$$\frac{{‖ \hat{p} ( {t}_{LD} ) {\vert}_{k + 1} - \hat{p} ( {t}_{LD} ) {\vert}_{k} ‖}^{2} {g}^{2}}{4 {( {e}_{3}^{T} \dot{p} ( {t}_{TO} ) {\vert}_{k} )}^{2}} + {( {e}_{3}^{T} \dot{p} ( {t}_{TO} ) {\vert}_{k} )}^{2} = 2 g \hat{h} , \qquad ( 55 )$$

where the fact that e₃^{T}(\hat{p}(t_{LD})|ₖ₊₁−\hat{p}(t_{LD})|ₖ)=0 (flat ground condition) is applied. The result permits us to solve for the vertical component of \dot{p}(t_{TO})|ₖ from

$$\frac{{e}_{3}^{T} \dot{p} ( {t}_{TO} ) {\vert}_{k}}{\sqrt{g \hat{h}}} = \sqrt{1 + \sqrt{1 - {‖ \frac{\hat{p} ( {t}_{LD} ) {\vert}_{k + 1} - \hat{p} ( {t}_{LD} ) {\vert}_{k}}{2 \hat{h}} ‖}^{2}}} . \qquad ( 56 )$$

Then, the horizontal components can be evaluated by projecting (53) along the directions of e₁ and e₂, making use of (56) as

$${e}_{1 , 2}^{T} \dot{p} ( {t}_{TO} ) {\vert}_{k} = \frac{{ge}_{1 , 2}^{T} ( \hat{p} ( {t}_{LD} ) {\vert}_{k + 1} - \hat{p} ( {t}_{LD} ) {\vert}_{k} )}{2 {e}_{3}^{T} \dot{p} ( {t}_{TO} ) {\vert}_{k}} . \qquad ( 57 )$$

Together, (56) and (57) provide a full expression of the takeoff velocity as a function of \hat{p}(t_{LD})|ₖ, which is dependent on z_{b}(t_{LD})|ₖ through (50).

3) Iterative implementation of the position controller: In this final step, the landing attitude z⁽ⁱ⁾(t_{LD})|ₖ and the takeoff velocity \dot{p}⁽ⁱ⁾(t_{TO})|ₖ are iteratively determined which together minimize the landing position error.

First, after the robot has reached the apex, the landing attitude is initialized to be the vertical: z_{b}⁽⁰⁾(t_{LD})|ₖ=e₃. This is used to by (50) and (53) to predict the current \hat{p}(t_{LD})|ₖ and the next landing positions \hat{p}(t_{LD})|ₖ₊₁.

The landing position at cycle k+1 is highly dependent on the takeoff velocity \dot{p}(t_{TO})|ₖ. Hence, \hat{p}(t_{LD})|ₖ₊₁ is regarded as the setpoint position and (56) and (57) are used to estimate the required takeoff velocity \dot{p}(t_{TO})|ₖ. This is by substituting \hat{p}(t_{LD})|ₖ₊₁ in those equations with the reference p_{d}|ₖ₊₁ (if the robot is unable to reach the setpoint in a single hop, an intermediate setpoint is introduced). Once the corresponding value of \dot{p}(t_{TO})|ₖ is evaluated, it is used as an input vector x_{N} for the NN. The output y_{N} of the network is translated to an auxiliary attitude vector \hat{z}_{b}⁽ⁱ⁾(t_{LD}). The outcome is then used to incrementally update the desired landing attitude at step k for the next iteration according to

$${z}_{b}^{( i + 1 )} ( {t}_{LD} ) = \frac{{z}_{b}^{( i )} ( {t}_{LD} ) + {w}_{z} {\hat{z}}_{b}^{( i )} ( {t}_{LD} )}{‖ {z}_{b}^{( i )} ( {t}_{LD} ) + {w}_{z} {\hat{z}}_{b}^{( i )} ( {t}_{LD} ) ‖} , \qquad ( 58 )$$

where w_{z}=0.5 is an update weight.

Next, steps 2 and 3 are repeated to recompute the desired takeoff velocity and update the desired landing attitude in an iterative fashion. The process is terminated when ∥z_{b}⁽ⁱ⁾(t_{LD})−z_{b}⁽ⁱ⁻¹⁾(t_{LD})∥<10⁻⁴. In practice, this usually takes 3-4 iterations. After the convergence, the final value of z_{b} (t_{LD}) is passed on to the attitude controller as elaborated below.

### Thrust and Attitude Management Module

In this step, thrust T and attitude R of the robot in the aerial phase are controlled according to the operational states: unpowered flight, powered descent, and powered ascent, as depicted in FIG. 19. Depending on the commanded thrust and attitude, the low-level control is then responsible for computing the control torque and corresponding motor commands.

While hopping, the thrust direction switches twice each cycle when power descent is adopted. In the meantime, the thrust magnitude in the powered ascent and descent is provided by the height controller. Whereas during the unpowered flight phase, the desired thrust is nominally zero, complying with the assumption of ballistic trajectories used for the next landing position estimation in (52).

To compute the attitude setpoint R_{d} from the desired body axis z_{b}, the fact is used that z_{b}=Re₃ is independent of the yaw angle ψ when the rotation matrix is parameterized by roll ϕ, pitch θ, and yaw ψ angles as R=R_{z}(ψ)R_{y}(ϕ)Rₓ(θ). Treating ψ as an arbitrary setpoint, the desired roll and pitch rotations can be determined from z_{b} and ψ according to

$${R}_{y} ( ϕ ) {R}_{x} ( θ ) {e}_{3} = {{R}_{z} ( ψ )}^{T} {z}_{b} . \qquad ( 59 )$$

As previously described, the desired attitude while the robot is ascending is z_{b}=e₃. In contrast, while descending (powered or unpowered), the desired attitude is determined by the landing position controller as the desired landing attitude. The target thrust and attitude are then taken by the low-level attitude controller to produce the motor comments.

### D. Low-level Attitude Controller

Given the desired thrust T_{d} and attitude setpoint R_{d} from the thrust and attitude management module, the following controller is employed to regulate the robot's attitude and generate appropriate motor commands.

The attitude controller aims to correct both attitude and angular rate errors, taking into consideration a possibly large attitude error. Hence, the attitude error is computed as R^{T}R_{d}, which represents the rotation between the desired attitude R_{d} and the current attitude R. This error is then expressed using the angle-axis representation as a vector e_{θ} to avoid the singularity issue. The control torque τ is then calculated as [127]:

$$τ = {k}_{p} {e}_{θ} + {k}_{d} ( {ω}_{d} - {ω}_{b} ) \qquad ( 60 )$$

where kₚ and k_{d} are control gains and ω_{d} is the desired angular rate, calculated by taking the numerical derivative of the desired attitude.

To obtain the motor commands u=[u₁, u₂, u₃, u₄]^{T} from the control torque r and desired thrust T_{d}, the following optimization strategy is deployed.

$$u = {arg min}_{u} \vert {T}_{d} - T \vert \\ subject to \\ {u}_{i} \geq 0 \\ and \\ τ = {A}_{f , r} u . \qquad ( 61 )$$

Here, the matrix A_{f,r}={A_{f}, Aᵣ} (for forward and reverse thrust) maps the motor commands to torque.

Unlike the use of linear mapping and matrix inverse as commonly deployed in quadrotors, the method in (61) is required in this work as the desired thrust value in the aerial phase, particularly in the unpowered phase, is oftentimes small or zero. Computing the motor commands directly from deterministically solving the linear map would result in negative values of uᵢ's. In such cases, the proposed method would allow the robot to generate thrust slightly higher than the target in order to ensure the motor commands remain positive and the desired control torque is produced.

To evaluate the performance of the robot, the hopping strategy, and validate the payload carrying ability, several indoor and outdoor experiments are conducted. First, in order to compare the effect of payload weight on the robot's ability to track the trajectory, the trajectory tracking performance of the robot is evaluated with variable payload up to 2 kg. Second, the hopping maneuver is investigated with various payload weights. Third, to demonstrate the agility of the hopping robot while carrying a heavy load, a 90-degree sharp turn experiment is conducted, with a 500-gram payload. Finally, the robot is equipped with an onboard computer and LiDAR sensor as functional payload to perform outdoor hopping experiments, testing the robot both with and without autonomous navigation to showcase its potential for operating in and exploring unknown environments.

### Trajectory Tracking

To validate the hopping performance of the robot and its payload carrying capacity, the trajectory tracking experiments are conducted with payload mass: no payload, 0.5 kg, 1.0 kg, 1.5 kg, and 2.0 kg.

The reference trajectory was designed as a figure-8 path, confined within a 2.2×2.2-m area, as illustrated in FIG. 24A. The desired hopping height h_{d} was set to a constant 0.55 m. For the high-level position controller, the desired landing points for each hopping step (indicated by index k) were set to

$${p}_{d \vert k} = {[ 1.1 cos ( 2 π \frac{k}{80} ) , 1.1 sin ( 4 π \frac{k}{80} ) , 0 ]}^{T} , \\ for \\ k = 0 , 1 , 2 , … , 80. \qquad ( 62 )$$

The position and velocity feedback at the apex (p(t_{AP}), \dot{p}(t_{AP})) was acquired through the motion capture system (Optitrack Prime 13w) at a frequency of 100 Hz. Additionally, to prevent IMU estimation drift during the robot's free fall (un-powered aerial phase) due to near-zero accelerometer readings, attitude measurements were transmitted to the onboard attitude estimator at a frequency of 10 Hz. The complete stance phase model described previously was employed to predict the landing attitude z_{b} (t_{LD}) for each hopping step.

Without any payload, the robot only used powered ascent with a thrust command of T_{f}=0.53 mᵣg=116 gf, with an averaged powered ascending duration of Δt_{PA}=0.15 s as given by the height controller. The tracking results in FIG. 24C show the robot closely following the prescribed trajectory, with the root mean square errors of 0.17 m for the landing position and 3.6 cm for the hopping height. In FIG. 24C as well as in FIG. 24D, the cross markers are the landing positions.

Furthermore, the power consumption during the maneuvers is estimated based on the thrust commands, exploiting the empirical model of propulsion power. Including the power expended by the flight avionics of approximately 0.5 W, an average power consumption of 10.6 W or 7.1 J per hop is yielded. The corresponding power loading is 23.1 g/W. Over the 69-s trajectory, the robot traveled 11.47 m, with an average lateral speed of 0.17 m/s.

With the increased payload weight (0.5 kg, 1.0 kg, and 1.5 kg) the powered ascent thrust command was set to 0.99 mᵣg, 1.39 mᵣg, and 2.09 mᵣg, respectively. Based on the average duration of powered ascent, the robot consumed, on average, 19.5, 26.1, 43.6 W, or 13.0 to 17.5 and 29.2 J of energy per step. The average power loading of 38.6, 48.1, and 40.3 are higher than the no payload trajectory.

When carrying a 2-kg payload, nearer to the theoretical payload limit of 2.22 as computed by (22), the robot took advantage of the bidirectional thrusters to realize powered descent. The tuning parameter for the powered descent in (47) was set to kₕ=0.8. The average powered ascent and descent durations are 0.27 and 0.19 s. Thanks to the use of power descent, the power loading of 15.9 is approximately half of those of previous experiments accomplished with only powered ascent (see FIG. 24B) As observed in FIG. 24D, the tracking performance slightly deteriorated when compared with the no payload case. This is reflected by the slightly increased RMSEs of 0.36 m for the landing position and similar RMSEs of 1.9 cm for hopping height.

Leaping with Payload

As indicated by the complete stance phase model in (34), the influence of the term mge₃, corresponding to the total weight of the platform, on the hopping dynamics becomes increasingly important when the directions of the leg vector (denoted by pₛ/∥pₛ∥) and the gravity (e₃) are misaligned. This occurs in more aggressive jumps with larger steps when the robot's landing attitude z_{b} deviates significantly from the vertical. Therefore, the inverted complete stance phase model, compressed into the NN controller, should allow the robot to perform large jumps more accurately than the simplified linear model in (36) or an incomplete model used in the robot of FIGS. 1A-1B as those models neglect the impact of the term mge₃ for simplification.

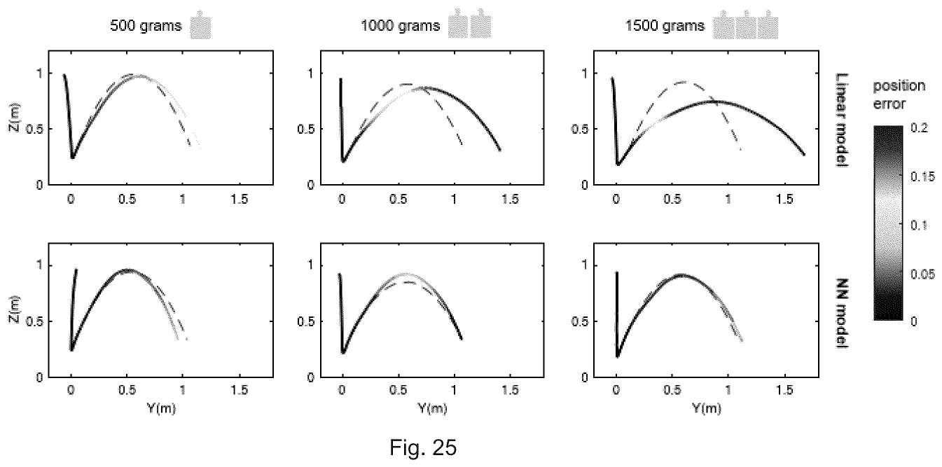

Thus, to showcase the advantage of the NN-based controller, exploiting the complete stance phase model, a trajectory is designed with a large step and compared hopping performance with that obtained using a controller with the linear model (FIG. 25). In FIG. 25, the realized trajectories contrast the results obtained from the controllers based on the linear model (first row) and the NN-based model (second row). The dash lines indicate the desired ballistic trajectory. The solid lines represent the actual trajectory. The greyscale bar shows the position error compared with the reference.

In this experiment, the hopper was commanded to perform a single hop with a step length of 1.0 m at a 0.65 m hopping height. To accomplish this, the lateral speed at the takeoff must reach 1.4 m/s. This was completed when the robot carried a 0.5 kg payload. The experiment was repeated with 1.0 kg and 1.5 kg payloads. Except for the stance phase model, other implementations and parameters for the two control methods were identical, including the high-level position controller, height controller, and low-level attitude controller.

The resultant trajectories are plotted in FIG. 9. For the lighter payload (0.5 kg), the difference between the two control methods is less clear. The position errors of the landing point are 0.07 m and 0.11 m for the NN-based model and the linear model. However, as the payload mass increases, the weight plays a more important role in the passive stance phase. Neglecting the robot's weight caused the hopper to overshoot the landing target. For the 1.5-kg payload, the robot landed 0.58 m away from the setpoint for the linear model-based controller whereas the error is only 0.07 m for the NN-based method. In addition, for the NN-based controller, the performance was not visibly affected by the variation in payload mass. The results corroborate the superior performance of the NN-based controller for payload carrying when compared with controllers derived from the linear models or simplified stance dynamics for the robot of FIGS. 1A-1B.

Sharp Turn with Large Steps and Payload

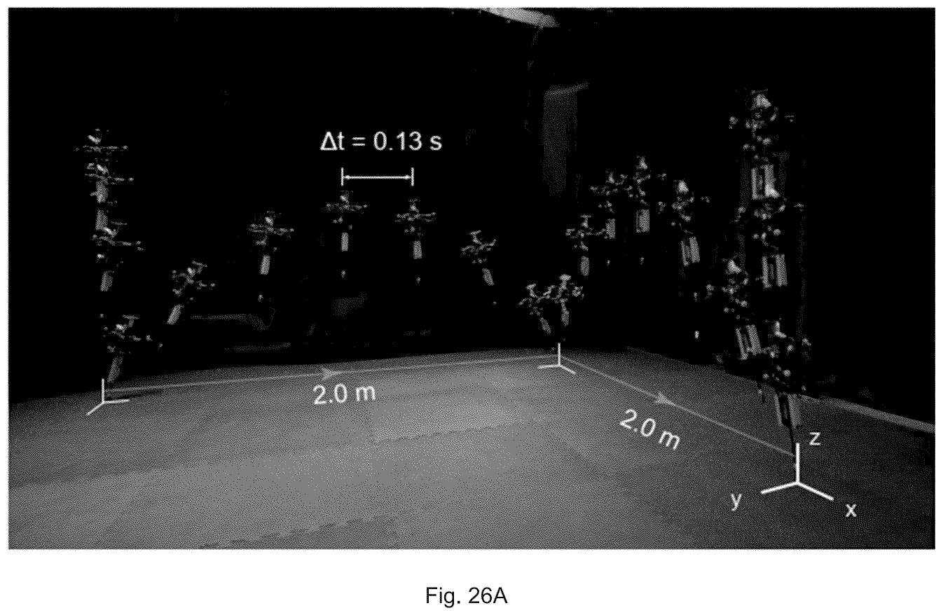

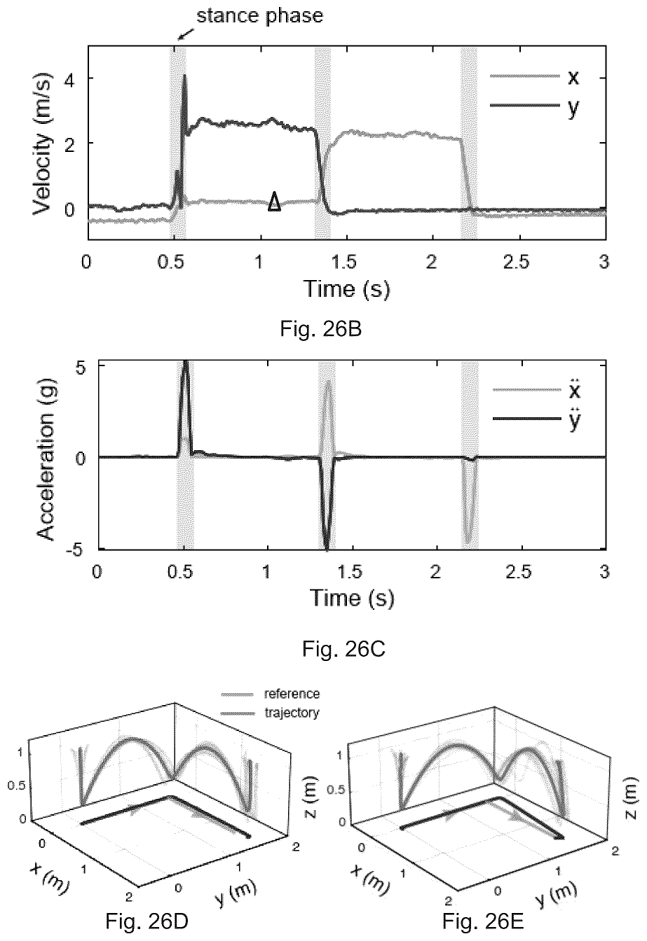

To further demonstrate the ability to hop with large steps while carrying a heavy payload, a turning maneuver is examined with a 0.62 kg payload (FIG. 26A-26E). FIGS. 26D and 26E are realized by controllers based on the NN-based and linear models, respectively. The dark lines represent the trajectory averaged over 10 repeated experiments (light lines show individual trajectories). The solid lines in the bottom planes are the projection of the average. Using the ground reaction force for hopping, the robot is able to impulsively generate large horizontal acceleration for turning, exceeding what it could achieve when flying. This permits the robot to perform a 90-degree turn between two large jumps as demonstrated in FIG. 26A.

Here, the robot started the maneuver by jumping forward with a step size of 2 m and a height of 0.75 m. The robot's landing attitude setpoint was computed such that the next landing position is 2 m away with a 90-degree turn. After that, the previous setpoint was repeated, requiring the robot to rapidly decelerate and suddenly come to a stop by hopping in place. In the experiment, the entire trajectory took 1.76 s, counting from the first to the third hop, resulting in an average horizontal speed of 2.27 m/s as illustrated by FIG. 26B. The sharp turn was realized by the acceleration created by the second hop, leveraging the interaction between the elastic leg and the ground. The acceleration of 6.4 g during this 0.07 s stance duration (FIG. 26C) dramatically exceeds what the robot could produce during flight, given its limited thrust-to-weight ratio of only 0.53 (considering the total weight of 0.84 kg), markedly lower than unity. To further assess the hopping performance with a sharp turn, a similar test is conducted, but with a step size of 1.5 m instead of 2 m. The test was repeated 10 times, with the two control methods (based on NN model and linear model). The realized trajectories, with their average, are plotted in FIG. 26D for the controller with the complete stance phase model and FIG. 10E for the controller with the linear model. It can be seen that for the NN-based controller, the robot landed accurately at the setpoints, with the RMS position errors of 0.21 m, 0.10 m, and 0.15 m for the three sequential setpoints. In contrast, when the linear model was used in the controller, the RMSEs amplified to 0.20 m, 0.17 m, and 0.13 m. In particular, the robot noticeably overshot the second landing point as illustrated in FIG. 26E. The outcomes are consistent with the previous observations from FIG. 25, in which the simplification of the stance phase model undesirably brought about landing position errors when the step size is large and the payload mass is substantial.

### 3D Mapping for Wild Environment

With the ability to carry a payload several times heavier than itself, the robot is able to carry a sensing and computing module to autonomously operate outside the laboratory, eliminating the need for feedback from the motion capture system. This was previously infeasible for the 35-g hopper in FIGS. 1A-1B due to its limited payload. Here, the robot was equipped with a 360-degree LiDAR (Livox Mid-360, 256 grams), an onboard computer (NUC with CPU i3-N305, weighs 220 grams), and an auxiliary power module (a 4S 850 mAh Li-ion battery and a voltage regulator, 115 g) as payload as shown in FIG. 18A. This allows the robot to perform onboard LiDAR-inertial odometry for state estimation, eliminating the need for feedback from the motion capture system for stabilization. In addition, an IMU (Bosch Sensortec, BMI088) is integrated with an extended acceleration sensing range (up to ±24 g) to substitute the built-in IMU of Livox Mid-360. This resolves the IMU saturation issue caused by the large ground impact (acceleration over 15 g) brought by hopping. The extrinsic parameters between LiDAR and IMU were calibrated [128], and the homogeneous transformation matrix was derived for the LiDAR-inertial odometry [129], [130]. The total weight of the robot became 0.95 kg, implying a payload weight of 730 g (payload ratio of mₚ/mᵣ=3.3), including supporting structures and extracables.

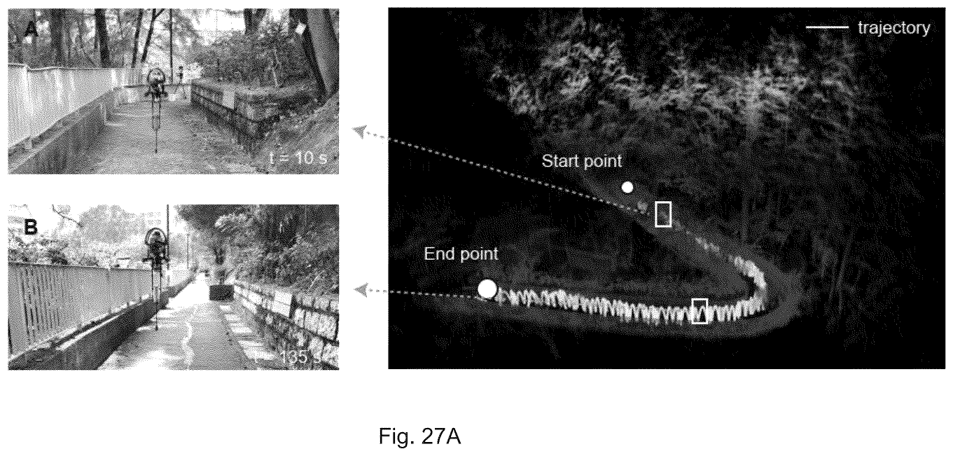

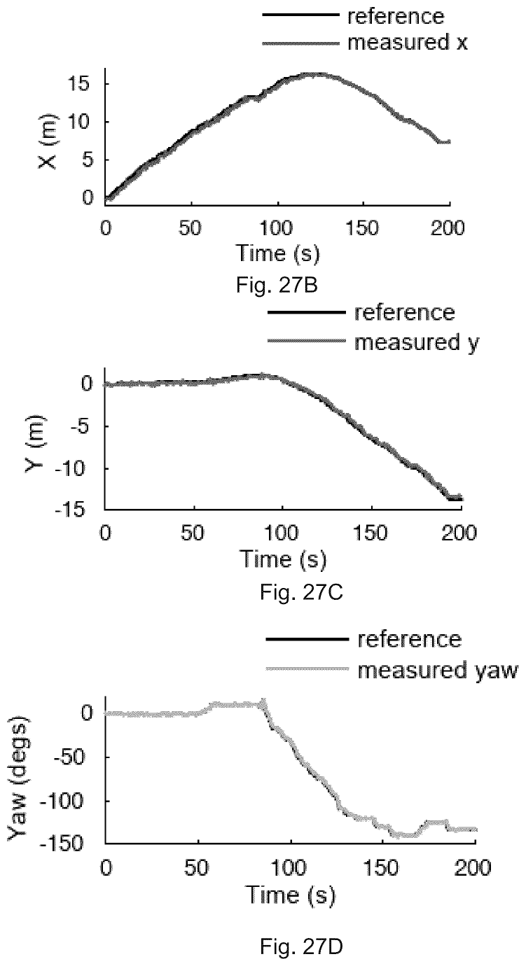

With the estimates of apex position p(t_{AP}) and velocity \dot{p}(t_{AP}) required for the landing state prediction in (50)-(51), the robot is able to hop stably outside the laboratory. To validate the effectiveness of the onboard LiDAR odometry, the outdoor hopping experiments are conducted along a hill-side trail (FIG. 27A). During the experiment, the desired position and heading of the hopping robot were manually given by a human pilot through a joystick as plotted in FIG. 27B-27D. The reference hopping height was set to 0.7 m. While generating the point cloud map in FIG. 27A, the robot traveled 30 m, completing over 248 steps in 200 s. This averages to a speed of 0.15 m/s at a frequency of 1.25 Hz. Throughout, the robot closely followed the reference trajectory with the landing position RMSE of 0.40 m, demonstrating similar performance to the indoor trajectory tracking with a payload. The integration of the LiDAR system to enable outdoor operations here substitutes the use of stabilizing aerodynamic dampers used in the robot of FIGS. 1A-1B. This offers a solution for heavier hopping quadcopters as the stabilizing effect of air dampers becomes insufficient for larger robots due to the scaling issue nature of surface area-to-mass ratio.

In addition to providing the position and velocity feedback for stabilization, the LiDAR also generated a 3D point cloud map in FIG. 27A. The map details the surroundings and the trajectory of the robot. This shows the potential use of the hopping robot for mapping applications in less structured environments.

### Autonomous Operation in Outdoor Environment

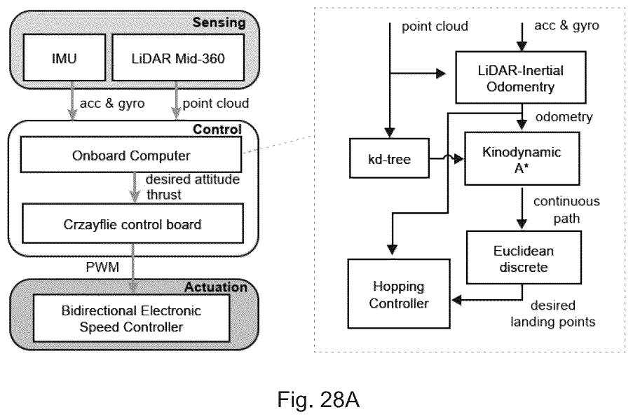

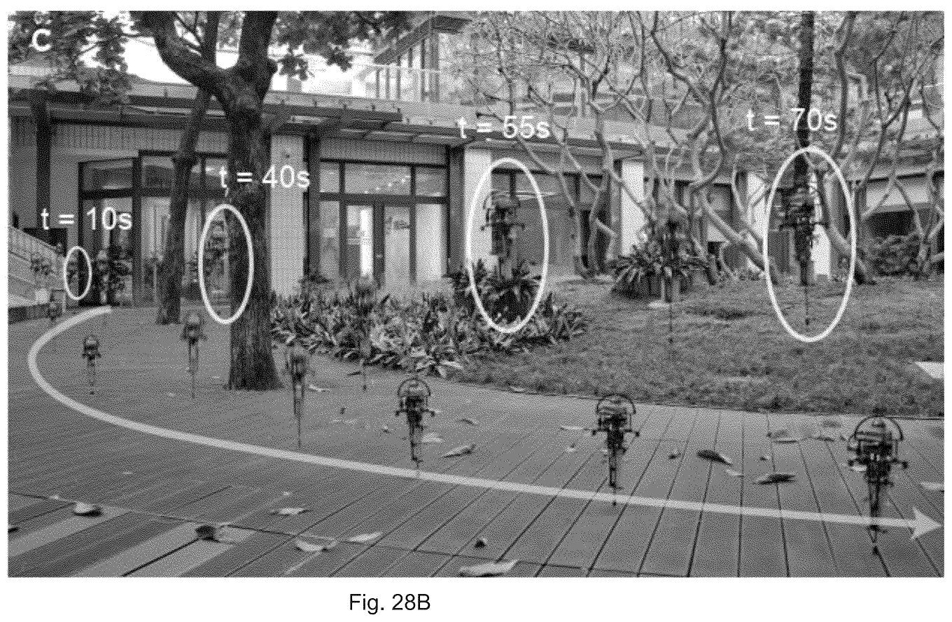

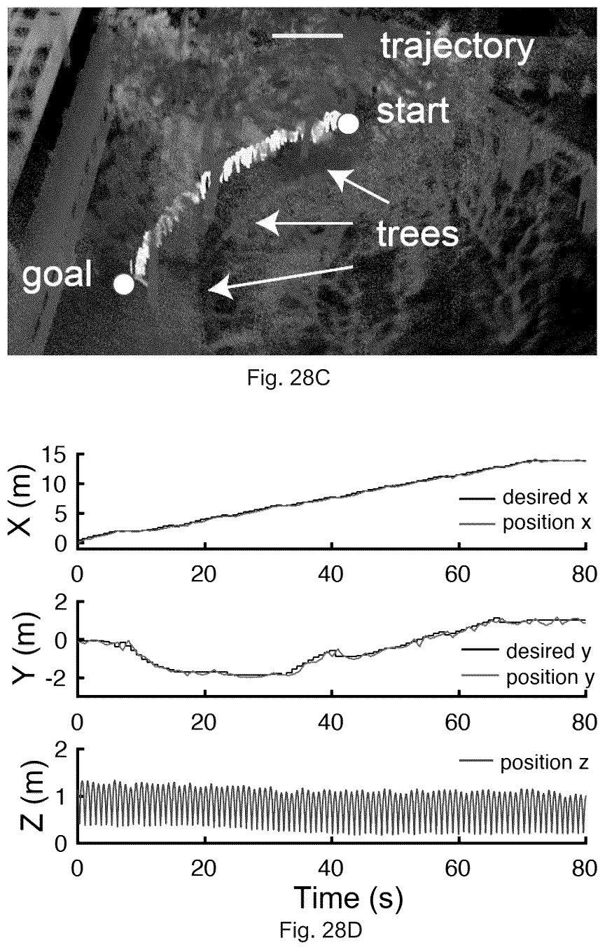

Thanks to the point cloud map generated by the LiDAR system, the robot could leverage this sensing capability to hop and navigate autonomously, avoiding collisions, without directly relying on a human operator. To enable autonomous navigation, the sensing and control structure in FIG. 28A is adopted. The implementation involves three subsystems: sensing, control, and actuation.

As part of the control subsystem, the autonomous navigation is enabled by the planning algorithm, implemented on the onboard computer as outlined in FIG. 28A. The point cloud data from the 3D LiDAR is split into two streams for processing. One stream is input to the LiDAR-inertial odometry for estimating the robot's attitude and position, incorporating measurements of acceleration and angular velocity data from the IMU as carried out previously. The second stream provides input for trajectory planning and collision avoidance.

For trajectory planning, a modified version of the kinodynamic A* algorithm is employed, adapted from methods used in aerial robotics [84], [131]. This modified algorithm plans a safe, dynamically feasible path in 3D space while accommodating the planar characteristics of our high-level position controller. Specifically, the start and goal positions used for path searching are at the desired hopping height h_{d}. In between, the algorithm searches for an obstacle-free path at an altitude near h_{d}. This is by limiting the vertical acceleration of the generated path to a narrow range (±0.1 m/s²). However, only the horizontal component of the generated trajectory is used by the hopper as p_{d}|ₖ₊₁, whereas h_{d} is kept constant. This ensures the planner considers obstacles in three dimensions along the trajectory.

To enhance the efficiency of safety checks, the point cloud data are organized into a k-d tree structure [84], [132]. The planned path is then projected onto the ground and discretized into several landing points, maintaining a constant Euclidean distance between each point. These discrete landing points serve as the desired values p_{d}(t_{LD})|ₖ for each hopping cycle, which are input into the onboard hopping position controller. The hopping altitude setpoint is separately set to h_{d}, regardless of the generated trajectory. To account for dynamic obstacles and changes in the environment during exploration, the trajectory is re-planned every five hopping steps by rerunning the planning algorithm. This adaptive approach ensures the robot can navigate safely through changing environments while maintaining its efficient hopping gait.

To validate the autonomous navigation ability and the effectiveness of the method, the experiment is conducted along a pedestrian path surrounded by trees as seen in FIG. 28B. The robot had no prior knowledge of the environment, except for the goal, located 15 m ahead and 1 m to the left of the starting point. Between them, there were several trees between the direct line of sight. The hopping height was set to a constant value of 0.7 m. The trajectory was computed in real-time by the onboard planner and updated every 5 hopping steps. The reference landing position was continuously updated such that the step size was 0.2 m.

The robot traveled over 15 m in 73 s (average speed: 0.2 m/s) without colliding with any obstacles. During this period, the robot localized itself with the LiDAR-generated map shown in FIG. 28C. The generated trajectory was closely followed thanks to the high-level position controller. The landing position RMSE was only 0.25 m, with the tracking results plotted in FIG. 28D. The outcome verifies the feasibility of LiDAR-based autonomous navigation for the hopping robot, thanks to its substantial payload capacity.

In summary, one can see in the embodiment of FIGS. 18A-18D, a robot is built upon the concept of a thrust-based hopper and its payload capacity is significantly enhanced. This improvement is achieved through the integration of bidirectional thrusters and a refined stance phase model that accounts for gravitational effects during the stance phase. The bidirectional thrusters enable the robot to handle increased energy losses from ground impacts and the leg mechanism, accommodating heavier payloads. By considering gravitational forces, the robot achieves greater accuracy in hopping, especially during larger jumps with substantial payloads. Theoretical and experimental analyses demonstrate a remarkable increase in payload capacity. The proposed robot exhibits the ability to carry loads up to 9.1 times (2.0 kg) its own mass (220 g) while maintaining stable hopping behavior. For instance, the 220 g prototype successfully hopped while bearing a 2.0 kg payload. This load-carrying capability surpasses other mobile robots across size scales.

The enhanced dynamic model, coupled with a neural network-based control strategy, enables robust hopping performance across various tasks. Exploiting the increased payload capacity, a LiDAR sensor and onboard computer are integrated, demonstrating the robot's potential for autonomous navigation in GPS-denied environments. This capability to hop with a thrust-to-weight ratio below one suggests promising applications for insect-scale aerial robots [133]-[135], which often face challenges in carrying sensors and batteries for untethered operations [86], [136].

Presently, the high-payload hopper displays impressive power loading compared to aerial robots at similar scales [88], indicating that hopping in place is an efficient strategy for loitering at low altitudes. The cost of transport of the robot remains high (over 30) as the demonstrated maneuvers are relatively slow. To enhance transport efficiency, realizing high-speed hopping remains a promising avenue for future research.

Another prospective direction involves developing a footpad to enable the robot to navigate or hold on to rough terrain[137], which could be invaluable in search and rescue missions. While a footpad might introduce additional energy losses, it represents a strategic trade-off between efficiency and versatility.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

What is claimed is:

1. A robot, comprising:
an aerial unit having a thruster module;
a passive leg mechanism operably coupled with the aerial unit; and
a controller module configured to control operation of the aerial unit such that the robot is operable in at least a hopping mode;
wherein the thruster module is adapted to provide bidirectional thrusts.

2. The robot of claim 1, wherein the aerial unit comprises a quadrotor; the quadrotor comprising the thruster module that further comprises a plurality of rotors, each of the rotors adapted to provide independently the bidirectional thrusts.

3. The robot of claim 2, wherein the quadrotor comprising a plurality of bidirectional motor controllers each connected to and adapted to control a corresponding one of the rotors.

4. The robot of claim 2, wherein each of the rotors has a ratio of thrust coefficients in a reverse direction to a forward direction respectively, which is in the range of −0.36 to −0.56.

5. The robot of claim 1, wherein the hopping mode comprises a descending phase, a stance phase, and an ascending phase of the robot; the thruster module adapted to provide a substantially downward thrust during at least part of the descending phase, and a substantially upward thrust during at least part of the ascending phase.

6. The robot of claim 5, wherein during a hopping cycle, the thruster module is adapted to change its thrust direction twice.

7. The robot of claim 5, wherein the descending phase comprises an unpowered descending sub-phase and a powered descending sub-phase; the ascending phase comprising an unpowered ascending sub-phase and a powered ascending sub-phase; the thruster module adapted to provide the substantially downward thrust during the powered descending sub-phase, and the substantially upward thrust during the powered ascending phase.

8. The robot of claim 1, wherein the passive leg mechanism comprises a telescopic leg arrangement which is spring-loaded with an elastomer module.

9. The robot of claim 8, wherein the telescopic leg arrangement comprises:
an upper leg section fixed to the aerial unit;
a lower leg section movably connected with the upper leg section via a connection module; and
an elastomer module operably coupled between the upper leg section and the lower leg section.

10. The robot of claim 9, wherein the upper leg section comprises two upper legs that are separated apart and extending in parallel; wherein the lower leg section comprise a single lower leg located substantially equidistantly to the two upper legs and adapted to move relative to the upper legs.

11. The robot of claim 10, wherein the connection module comprises an upper bearing module and a lower bearing module which are fixed to the upper legs; the upper bearing module and the lower bearing module coupled to the lower leg such that the lower leg is adapted to move relative to the upper legs in a single direction.

12. The robot of claim 11, wherein the elastomer module comprises a lower mounting hook, an upper mounting hook, and one or more elastomers connected between the lower mounting hook and the upper mounting hook; the lower mounting hook fixedly connected to the lower bearing module; the upper mounting hook fixedly connected to the lower leg.

13. The robot of claim 1, wherein the controller module is configured to predict a landing location of the robot in the hopping mode.

14. The robot of claim 13, wherein the controller module is configured to determine a landing location of the robot for a next hopping cycle based on a landing attitude of the robot for a current hopping cycle.

15. The robot of claim 14, wherein the controller module is adapted to use a trained neural network to calculate the landing attitude based on a predicted landing location and a desired landing location.

16. The robot of claim 1, wherein the controller module comprises a height controller, a high-level position controller, thrust and attitude management, and a low-level attitude controller.
